(19) United States
(12) Patent Application Publication
(10) Pub. No.: US 2025/0093697 A1
(43) Pub. Date: Mar. 20, 2025

(54) OPTICAL LAMINATE AND PRODUCTION METHOD THEREFOR, FRONT PANEL, AND IMAGE DISPLAY DEVICE

(71) Applicant: DAI NIPPON PRINTING CO., LTD., Tokyo (JP)

(72) Inventors: Kana YAMAMOTO, Okayama-shi (JP); Masayuki TSUNEKAWA, Okayama-shi (JP); Toshiki IWASAKI, Okayama-shi (JP); Takahisa NOMURA, Okayama-shi (JP); Hiroki NAKAGAWA, Okayama-shi (JP); Takanori HAMADA, Koka-shi (JP); Eiji OOISHI, Okayama-shi (JP); Kuniaki YOSHIKATA, Nishinomiya-shi (JP); Masataka NAKASHIMA, Higashihiroshima-shi (JP)

(21) Appl. No.: 18/901,843

(22) Filed: Sep. 30, 2024

Related U.S. Application Data
(62) Division of application No. 16/076,566, filed on Dec. 20, 2018, now abandoned.

(30) Foreign Application Priority Data
Feb. 9, 2016 (JP) 2016-022484
Feb. 9, 2016 (JP) 2016-022486
Feb. 9, 2016 (JP) 2016-022487
Feb. 9, 2016 (JP) 2016-022488

(51) Int. Cl. G02F 1/1335; B29C 65/48; B29D 11/00; B29L 11/00; B32B 7/023; B32B 23/08; B32B 27/08; B32B 27/18; B32B 27/32; C08J 7/04; G02F 1/1333; G02F 1/13363; G06F 3/041

(52) U.S. Cl. CPC G02F 1/1335; B29C 65/4825; B29D 11/00644; B32B 7/023; B32B 23/08; B32B 27/08; B32B 27/18; B32B 27/325; C08J 7/042; G02F 1/1333; G02F 1/13338; G02F 1/133528; G02F 1/13363; G06F 3/0412; B29L 2011/0066; B32B 2307/202; B32B 2307/42; B32B 2457/208; G02F 1/133638; G02F 2201/50; G02F 2202/28; G02F 2413/01; G02F 2413/05

(57) ABSTRACT

Provided are [1] an optical laminate comprising a substrate film, a transparent conductive layer and a surface protection layer in this order, wherein an average value of a surface resistivity measured according to JIS K6911 is in the range of 1.0×10⁷Ω/ [symbol] or more and 1.0×10¹⁰Ω/ [symbol] or less, and a standard deviation σ of the surface resistivity is 5.0×10⁸Ω/ [symbol] or less, [2] an optical laminate comprising a substrate film, a transparent conductive layer and a surface protection layer in this order, wherein the substrate film is a cycloolefin polymer film, a ratio of a thickness of the substrate film to a thickness of the entire optical laminate is 80% or more and 95% or less, and a rate of elongation of the optical laminate at a temperature of 150° C., as measured using a dynamic viscoelasticity measuring apparatus under conditions of a frequency of 10 Hz, a tensile load of 50 N and a rate of temperature increase of 2° C./min, is 5.0% or more and 20% or less, and [3] an optical laminate comprising a cellulose-based substrate film, a stabilization layer and a conductive layer in this order, wherein an average value of a surface resistivity measured according to JIS K6911 is in the range of 1.0×10⁷Ω/ [symbol] or more and 1.0×10¹²Ω/ [symbol] or less, and a value obtained by dividing a standard deviation σ of the surface resistivity by the average value is 0.20 or less; as well as a method for producing the optical laminate, a front panel and an image display device.

### TECHNICAL FIELD

The present invention relates to an optical laminate and a method for producing the same, a front panel, and an image display device.

### BACKGROUND ART

In recent years, a touch panel function has been mounted in a portable liquid crystal terminal typified by a smartphone or a tablet terminal. Examples of known touch panel systems include capacitive, optical, ultrasonic, electromagnetic induction, and resistance film touch panel systems. Among them, a capacitive touch panel where inputting is made by acquiring the change in capacitance between a fingertip and a conductive layer is a currently main touch panel along with a resistance film touch panel.

A liquid crystal display device on which such a touch panel function is mounted has been conventionally mainly an external type liquid crystal display device on which a touch panel is attached. Such an external type liquid crystal display device is excellent in yield because a liquid crystal display device and a touch panel are separately produced and then integrated and therefore, even if any one thereof is defective, the other can be utilized, but the external type liquid crystal display device has the problem of increases in thickness and weight.

In order to solve such a problem, there has appeared a so-called on-cell type touch panel-mounted liquid crystal display device where a touch panel is embedded between a liquid crystal display component and a polarization plate of the liquid crystal display device. Furthermore, in more recent years, there has been started to develop, as a liquid crystal display device with more reduced in thickness and weight than such an on-cell type liquid crystal display device, a liquid crystal display device on which a so-called in-cell type touch panel is mounted (in-cell touch panel-mounted liquid crystal display device), where a touch function is incorporated in a liquid crystal display component.

An in-cell touch panel-mounted liquid crystal display device has a configuration where an optical laminate of films and the like having various functions, bonded with an adhesion layer being interposed therebetween, is disposed on a liquid crystal display component embedded with a touch function. Examples of such films and the like having various functions include a phase difference film, a polarizer, a polarizer protection film, and cover glass.

For the purposes of reductions in weight and thickness of an in-cell touch panel-mounted liquid crystal display device, there has been made an attempt to devise an optical laminate to be provided on a display component. Examples of a solution to such an attempt include a solution for allowing an optical laminate to have a specific layer configuration, resulting in a reduction of members constituting the optical laminate, and a solution for reducing the thickness of each film constituting the optical laminate.

It is also particularly important for a capacitive touch panel, among respective touch panel systems, that the potential of a touch panel sensor section be stable from the viewpoint of exhibition of stable operability. An equipotential surface is needed in order to ensure stable operability of a capacitive touch panel, and also the equipotential surface more preferably has stability over time without being affected by any environmental change. Therefore, the optical laminate to be provided on a display component having a specific layer configuration is studied.

For example, PTLs 1 and 2 disclose an optical laminate for a front surface of an in-cell touch panel liquid crystal display component, the optical laminate having a specific layer configuration and thickness. Two conductive layers different from a touch panel sensor can be each provided at any location of the optical laminate, the location being positioned closer to an operator than the liquid crystal display component, thereby allowing a touch panel surface to be low in conductivity and to be less changed in conductive property over time.

In a liquid crystal display device on which a touch panel is mounted, while a touch panel positioned closer to an operator than a liquid crystal display component has served as a conductive member in conventional external type and on-cell type liquid crystal display devices, no conductive member is present closer to an operator than a liquid crystal display component due to switching to an in-cell type liquid crystal display device. Thus, a liquid crystal display device on which an in-cell type touch panel is mounted has the problem of partial clouding of a liquid crystal screen in touching of the touch panel with a finger. The clouding occurs because static electricity generated on the touch panel surface cannot be allowed to escape. It, however, has been found in PTLs 1 and 2 that a conductive layer can be provided at any location of the optical laminate, the location being positioned closer to an operator than the liquid crystal display component, thereby allowing static electricity generated on the surface to escape and also preventing the clouding.

A touch panel-mounted liquid crystal display device has also been further studied for an improvement in visibility through polarized sunglasses. The improvement in visibility means an improvement of unevenness with different colors (hereinafter, also referred to as “rainbow interference pattern”) which may be sometimes observed on a display screen viewed through polarized sunglasses when an optical laminate is disposed on the front surface of a display component. As the method for the improvement in visibility, a method is known where a layer having optical anisotropy which disturbs linear polarization is provided at a position closer to a viewer than a polarizer.

For example, above-mentioned PTL 1 discloses an optical laminate for the front surface of an in-cell touch panel liquid crystal display component, having a specific layer configuration and thickness, wherein the optical laminate comprises a phase difference film, a polarizer and a transparent substrate in this order, and further comprises a conductive layer, and one having optical anisotropy which disturbs linear polarization emitted from the polarizer is used as the transparent substrate. PTL 2 discloses an optical laminate for the front surface of an in-cell touch panel liquid crystal display component, having a specific thickness, wherein the optical laminate comprises a phase difference film, a polarizer and a surface protection film in this order, and further comprises a conductive layer, and one having optical anisotropy which disturbs linear polarization emitted from the polarizer is used as the surface protection film.

Examples of the transparent substrate or the surface protection film having optical anisotropy which disturbs linear polarization include a ¼ wavelength phase difference plastic film. The plastic film is usually an oriented film. The direction of the optical axis of an oriented film subjected to a common orientation treatment, however, is in parallel with or perpendicular to the width direction thereof, the film is thus needed to be cut obliquely into a single sheet for bonding so that the transmission axis of the linear polarizer is aligned with the optical axis of the ¼ wavelength phase difference plastic film. Therefore, a problem is that not only is a production process complicated, but oblique cutting also considerably causes a wasted film. Another problem is that roll-to-roll production cannot be made in touch panel production and continuous production is difficult.

PTL 3 discloses, as an optically suitable capacitive touch panel sensor that can be continuously produced by roll-to-roll or the like, a capacitive touch panel sensor directly or indirectly comprising a conductive layer on at least one surface of an obliquely oriented film. The obliquely oriented film can be used to thereby allow for continuous production by roll-to-roll. Examples of a material for use in the obliquely oriented film particularly preferably include a cycloolefin polymer.

PTL 4 discloses, as an optical film comprising an antistatic layer, an optical film comprising an antistatic layer, a protective layer, and a light scattering layer made of a resin layer where fine particles are dispersed, in this order, on a transparent film, wherein the antistatic layer contains specific needle-shaped metal oxide particles, and PTL 4 also exemplifies, as a transparent film (support), a polymer resin film having an alicyclic structure (see paragraph 0207).

### CITATION LIST

### Patent Literatures

PTL 1: WO 2014/069377
PTL 2: WO 2014/069378
PTL 3: JP 2013-242692 A
PTL 4: JP 2007-102208 A

### SUMMARY OF INVENTION

### Technical Problem

If the thickness of each film constituting an optical laminate is reduced for reductions in weight and thickness of a touch panel-mounted liquid crystal display device, a film thin in thickness has no stiffness and therefore, for example, film flatness may be difficult to ensure in direct formation of a conductive layer on the film, thereby causing waving of the resulting film provided with a conductive layer. Such waving of the film causes variation in thickness of the conductive layer, thereby causing variability in surface resistivity in the film plane. Use of such a film for the front panel of a capacitive touch panel is not preferable because operability of the touch panel is deteriorated. For example, while a ¼ wavelength phase difference plastic film, such as a cycloolefin polymer film, is preferably used as a substrate film for conductive layer formation in terms of optical properties, a cycloolefin polymer film has no stiffness and is low in strength, and therefore the above-mentioned problems are remarkably caused.

In addition, a cycloolefin polymer film is generally known to be low in polarity and therefore low in close contact property with a layer made of a resin component. Accordingly, when a layer made of a resin component is to be directly provided on the film, it is very difficult to impart a close contact property unless a surface treatment such as a corona treatment is performed. PTLs 1 to 4, however, do not suggest such any object.

PTL 4 exemplifies a polymer resin film having an alicyclic structure, as a support for use in an optical film, but describes neither an antistatic layer excellent in close contact property with the resin film, nor an optical film comprising such a layer.

Moreover, the conductive layer disclosed in PTL 3 serves as a touch panel sensor, and is fully different in function from the conductive layer disclosed in PTLs 1 and 2 and provided in order to ensure operational stability of a touch panel and allow static electricity generated on a touch panel surface to escape. The conductive layer serving as a touch panel sensor is needed to have a higher conductive property, and the surface resistivity thereof is preferably 100 to 1000Ω/□ (see paragraph 0027 of PTL 3). In general, use of a resin composition comprising a large amount of a resin component high in insulation property is not common for formation of the conductive layer serving as a touch panel sensor, and for example, a method for forming indium tin oxide (ITO) into a film by sputtering, as described in Examples of PTL 3, is used.

Another object is also importantly to allow an optical laminate positioned closer to a viewer than an image display component to be high in light transmission property in the visible region in terms of image visibility. If the thickness of a conductive layer in the optical laminate is too large, however, a light transmission property in the visible region may be reduced. On the other hand, if the thickness of the conductive layer is smaller, it may be difficult to ensure a conductive property.

Furthermore, when the optical laminate is applied to an image display device on which a capacitive touch panel is mounted, the optical laminate is preferably favorable in in-plane uniformity of surface resistivity from the viewpoint that operability of a touch panel is stabilized.

It is effectual for improving the above-mentioned rainbow interference pattern to use a ¼ wavelength phase difference plastic film for an optical laminate. When the ¼ wavelength phase difference plastic film, however, is used for an optical laminate, the film is excellent in the effect of eliminating polarization, but interference fringe derived from interface reflection between the film and other layer laminated thereon may occur to result in a reduction in image visibility. Another problem is that the film is low in adhesiveness to such other layer and is inferior in processing property. Furthermore, the film is expensive.

There is then studied development of an optical laminate where a cellulose-based film including triacetyl cellulose is used. The cellulose-based film is high in light transmission property and small in retardation value, and therefore is excellent in optical properties. The cellulose-based film also allows a solvent and other low molecular weight component having a molecular weight of less than 1,000 to easily penetrate thereinto due to nature thereof. Therefore, during formation of other layer by use of a material comprising the low molecular weight component and a solvent, on the cellulose-based film, the solvent and the low molecular weight component penetrate into the cellulose-based film. Such an effect makes the interface between the cellulose-based film and such other layer unclear, thereby causing no occurrence of the interference fringe and also making adhesiveness between layers favorable. Furthermore, the cellulose-based film has the advantage of being relatively inexpensive.

The cellulose-based film, however, has the above penetrability, and therefore the following problem occurs: when a conductive layer is to be formed thereon by use of a solvent and a material comprising the low molecular weight component, the thickness of the conductive layer is not stable or the material for conductive layer formation penetrates into the cellulose-based film, allowing no necessary conductive property or in-plane uniformity thereof to be achieved. Furthermore, the cellulose-based film may be easily changed in water content depending on the weather and may also be distorted due to moisture absorption to such an extent that such distortion can be visually identified. If the film is distorted, variation in thickness of a conductive layer formed thereon also occurs to thereby cause variability in surface resistivity in the film plane. Use of such a film for the front surface of a capacitive touch panel is not preferable because of resulting in a reduction in operability of a touch panel. In particular, it is important for an in-cell type touch panel that variability in surface resistivity be small.

A first object of the present invention is to provide an optical laminate that can stably exhibit operability of a touch panel when applied to a capacitance-type touch panel-mounted image display device or the like, as well as a front panel and an image display device comprising the optical laminate.

A second object of the present invention is to provide an optical laminate that can stably exhibit operability of a touch panel when applied particularly to a capacitance-type touch panel-mounted image display device, the optical laminate comprising a substrate film being a cycloolefin polymer film, a transparent conductive layer and a surface protection layer in this order, wherein the transparent conductive layer is excellent in close contact property to the cycloolefin polymer film, high in light transmission property in the visible region and favorable in in-plane uniformity of surface resistivity, as well as a front panel and an image display device comprising the optical laminate.

A third object of the present invention is to provide an optical laminate that can stably exhibit operability of a touch panel when applied to a capacitance-type touch panel-mounted image display device or the like, even in use of a cellulose-based substrate film as a substrate film, as well as a front panel and an image display device comprising the optical laminate.

A fourth object of the present invention is to provide a method for producing an optical laminate favorable in in-plane uniformity of surface resistivity even by use of a substrate film having no stiffness and having a low strength in production of an optical laminate comprising a substrate film, a transparent conductive layer and a surface protection layer.

### Solution to Problem

The present inventors have found that the first object can be solved by an optical laminate having a specific layer configuration and a conductive property.

That is, the present invention according to the first mode (hereinafter, also referred to as “first invention”) relates to the following.
[1] An optical laminate comprising a substrate film, a transparent conductive layer and a surface protection layer in this order, wherein an average value of a surface resistivity measured according to JIS K6911 is in the range of 1.0×10⁷Ω/ [symbol] or more and 1.0×10¹⁰Ω/ [symbol] or less, and a standard deviation σ of the surface resistivity is 5.0×10⁸Ω/ [symbol] or less.
[2] A front panel comprising the optical laminate according to [1], a polarizer, and a phase difference film in this order.
[3] An image display device where the optical laminate according to [1] or the front panel according to [2] is provided on a side of a display component, the side facing a viewer.

The present inventors have found that the second object can be solved by an optical laminate having a specific layer configuration and having a predetermined elongation property.

That is, the present invention according to the second mode (hereinafter, also referred to as “second invention”) relates to the following.
[1] An optical laminate comprising a substrate film, a transparent conductive layer and a surface protection layer in this order, wherein the substrate film is a cycloolefin polymer film, a ratio of a thickness of the substrate film to a thickness of the entire optical laminate is 80% or more and 95% or less, and a rate of elongation of the optical laminate at a temperature of 150° C. is 5.0% or more and 20% or less, as measured using a dynamic viscoelasticity measuring apparatus under conditions of a frequency of 10 Hz, a tensile load of 50 N and a rate of temperature increase of 2° C./min.
[2] A front panel comprising the optical laminate according to [1], a polarizer, and a phase difference film in this order.
[3] An image display device where the optical laminate according to [1] or the front panel according to [2] is provided on a side of a display component, the side facing a viewer.

The present inventors have found that the third object can be solved by an optical laminate having a specific layer configuration and a conductive property.

That is, the present invention according to the third mode (hereinafter, also referred to as “third invention”) relates to the following.
[1] An optical laminate comprising a cellulose-based substrate film, a stabilization layer and a conductive layer, in this order, wherein an average value of a surface resistivity measured according to JIS K6911 is in the range of 1.0×10⁷Ω/ [symbol] or more and 1.0×10¹²Ω/ [symbol] or less, and a value obtained by dividing a standard deviation σ of the surface resistivity by the average value is 0.20 or less.
[2] A front panel comprising the optical laminate according to [1], a polarizer, and a phase difference film in this order.
[3] An image display device where the optical laminate according to [1] or the front panel according to [2] is provided on a side of a display component, the side facing a viewer.

The present inventors have also found that the fourth object can be solved by a method for producing an optical laminate, comprising a specific step.

That is, the present invention according to the fourth mode (hereinafter, also referred to as “fourth invention”) relates to the following.
[1] A method for producing an optical laminate comprising a substrate film, a transparent conductive layer and a surface protection layer in this order, wherein the method comprises a step of laminating a rear surface film on one surface of the substrate film with a pressure-sensitive adhesion layer being interposed therebetween, and then forming the transparent conductive layer and the surface protection layer in this order on other surface of the substrate film, and the following condition (1) is satisfied:
   Condition (1): when the laminate comprising the substrate film, the pressure-sensitive adhesion layer and the rear surface film has a width of 25 mm and a length of 100 mm, and a portion of the laminate corresponding to 25 mm from one end in the length direction is horizontally secured and the remaining portion thereof corresponding to a length of 75 mm is deformed by its own weight, a vertical distance from the secured portion to other end of the laminate in the length direction is 45 mm or less.
[2] A method for producing an optical laminate comprising a substrate film, a transparent conductive layer and a surface protection layer in this order, wherein the method comprises a step of laminating a rear surface film on one surface of the substrate film with a pressure-sensitive adhesion layer being interposed therebetween, and then forming the transparent conductive layer and the surface protection layer in this order on other surface of the substrate film, a total thickness of the pressure-sensitive adhesion layer and the rear surface film is 20 to 200 μm, and a laminated article comprising the pressure-sensitive adhesion layer and the rear surface film has a tensile elastic modulus of 800 N/mm² or more and 10,000 N/mm² or less as measured at a tensile speed of 5 mm/min according to JIS K7161-1:2014.
[3] A transparent laminate comprising a pressure-sensitive adhesion layer and a rear surface film on one surface of a substrate film in the listed order from the substrate film, comprising a transparent conductive layer and a surface protection layer on other surface of the substrate film in the listed order from the substrate film, and satisfying the following condition (1):
   Condition (1): when the laminate comprising the substrate film, the pressure-sensitive adhesion layer and the rear surface film has a width of 25 mm and a length of 100 mm, and a portion of the laminate corresponding to 25 mm from one end in the length direction is horizontally secured and the remaining portion thereof corresponding to a length of 75 mm is deformed by its own weight, a vertical distance from the secured portion to other end of the laminate in the length direction is 45 mm or less.
[4] A transparent laminate comprising a pressure-sensitive adhesion layer and a rear surface film on one surface of a substrate film in the listed order from the substrate film, and comprising a transparent conductive layer and a surface protection layer on other surface of the substrate film in the listed order from the substrate film, wherein a total thickness of the pressure-sensitive adhesion layer and the rear surface film is 20 to 200 μm, and a laminated article comprising the pressure-sensitive adhesion layer and the rear surface film has a tensile elastic modulus of 800 N/mm² or more and 10,000 N/mm² or less as measured at a tensile speed of 5 mm/min according to JIS K7161-1:2014.

### Advantageous Effects of Invention

The optical laminate according to the first invention is favorable in in-plane uniformity of surface resistivity, and therefore is suitably used particularly in a member constituting an image display device on which a capacitive touch panel is mounted. The touch panel comprising the optical laminate thus exhibits stable operability.

The optical laminate according to the second invention has an elongation property in a predetermined range, therefore is excellent in close contact property between a cycloolefin polymer film serving as the substrate film and the transparent conductive layer and also favorable in in-plane uniformity of surface resistivity, and thus is suitably used particularly in a member constituting the front panel of an image display device on which a capacitive touch panel is mounted. The touch panel comprising the optical laminate thus exhibits stable operability. When a ¼ wavelength phase difference film obliquely oriented is used as the cycloolefin polymer film in the optical laminate, visibility through polarized sunglasses is also favorable and continuous production by a roll-to-roll method can also be made.

Furthermore, the optical laminate according to the second invention is also favorable in visible light transmission property because the ratio of the thickness of the substrate film to the total thickness is 80% or more.

The optical laminate according to the third invention is favorable in in-plane uniformity of surface resistivity even in use of a cellulose-based substrate film as the substrate film, and therefore is suitably used particularly in a member constituting an image display device on which a capacitive touch panel is mounted. A touch panel comprising the optical laminate thus exhibits stable operability.

According to the method for producing an optical laminate according to the fourth invention, even when a substrate film having no stiffness and having a low strength is used in production of an optical laminate comprising a substrate film, a transparent conductive layer and a surface protection layer, an optical laminate favorable in in-plane uniformity of surface resistivity can be produced. The optical laminate is suitably used particularly in a member constituting an image display device on which a capacitive touch panel is mounted.

### BRIEF DESCRIPTION OF DRAWINGS

FIG. 1 is a plane schematic view describing one example of a method for measuring the surface resistivity in the optical laminate of the present invention.

FIG. 2 is a cross-sectional schematic view illustrating one embodiment of the optical laminate (I) according to the first invention and the optical laminate (II) according to the second invention.

FIG. 3 is a cross-sectional schematic view illustrating one embodiment of the optical laminate (III) according to the third invention.

FIG. 4 is a cross-sectional schematic view illustrating one embodiment of the optical laminate (III) according to the third invention.

FIG. 5 is a cross-sectional schematic view illustrating one embodiment of the front panel of the present invention.

FIG. 6 is a cross-sectional schematic view illustrating one embodiment of the front panel of the present invention.

FIG. 7 is a cross-sectional schematic view illustrating one embodiment of the image display device of the present invention.

FIG. 8 is a cross-sectional schematic view illustrating one embodiment of the image display device of the present invention.

FIG. 9 is a schematic view illustrating a method for measuring the vertical distance defined in condition (1) in the method for producing an optical laminate according to the fourth invention.

FIG. 10 is a cross-sectional schematic view illustrating one embodiment of the optical laminate and the transparent laminate in the fourth invention.

FIG. 11 is a cross-sectional schematic view illustrating one embodiment of the front panel in the fourth invention.

FIG. 12 is a cross-sectional schematic view illustrating one embodiment of the in-cell touch panel-mounted image display device in the fourth invention.

FIG. 13 is an infrared spectroscopy (IR) spectrum obtained by collecting a transparent conductive layer formed on a cycloolefin polymer and subjecting it to measurement according to a transmission method in Example 2-1.

FIG. 14 is an IR spectrum of a cured product of only an ionizing radiation curable resin (A) used in Example 2-1.

FIG. 15 is an IR spectrum of a cured product of only an ionizing radiation curable resin (B) used in Example 2-1.

### DESCRIPTION OF EMBODIMENTS

Hereinafter, the first invention to the fourth invention will be described. Herein, the optical laminate according to the first invention is appropriately referred to as “optical laminate (I)”, the optical laminate according to the second invention is appropriately referred to as “optical laminate (II)”, and the optical laminate according to the third invention is appropriately referred to as “optical laminate (III)”. In addition, the method for producing an optical laminate according to the fourth invention is appropriately referred to as “the production method of the present invention”.

### [First Invention: Optical Laminate (I)]

The optical laminate (I) of the present invention according to the first invention comprises a substrate film, a transparent conductive layer and a surface protection layer in this order, wherein the average value of a surface resistivity measured according to JIS K6911 is in the range of 1.0×10⁷Ω/ [symbol] or more and 1.0×10¹⁰Ω/ [symbol] or less, and the standard deviation σ of the surface resistivity is 5.0×10⁸Ω/ [symbol] or less.

When the average value of the surface resistivity is 1.0×10⁷Ω/ [symbol] or more, operability of a capacitive touch panel is stabilized. When the average value of the surface resistivity is 1.0×10¹⁰Ω/ [symbol] or less, the above-mentioned clouding of a liquid crystal screen can also be effectively prevented. The average value of the surface resistivity is preferably in the range of 1.0×10⁸Ω/ [symbol] or more, preferably in the range of 2.0×10⁹Ω/ [symbol] or less, more preferably in the range of 1.5×10⁹Ω/ [symbol] or less, further preferably in the range of 1.0×10⁹Ω/ [symbol] or less from the above viewpoints.

If the standard deviation σ of the surface resistivity is more than 5.0×10⁸Ω/ [symbol] , variability in surface resistivity in the plane is large to result in a reduction in operability in use of the optical laminate for a capacitive touch panel. From such a viewpoint, the standard deviation σ of the surface resistivity is preferably 1.0×10⁸Ω/ [symbol] or less, more preferably 8.0×10⁷Ω/ [symbol] or less.

The surface resistivity is measured according to JIS K6911:1995, and the average value and the standard deviation thereof can be measured by, for example, the following method A.

Method A: straight lines (b) for equally longitudinally and laterally dividing a region (a) located 1.5 cm inward from the outer circumference of the optical laminate, by n, are drawn on the surface protection layer of the optical laminate, and the surface resistivity is measured at each of the vertexes of the region (a), the intersections of the straight lines (b), and the intersections of four sides defining the region (a) with the straight lines (b), provided that n is an integer of 1 to 4, and n=1 when the area of the optical laminate is less than 10 inches, n=2 when the area is 10 inches or more and less than 25 inches, n=3 when the area is 25 inches or more and less than 40 inches, and n=4 when the area is 40 inches or more.

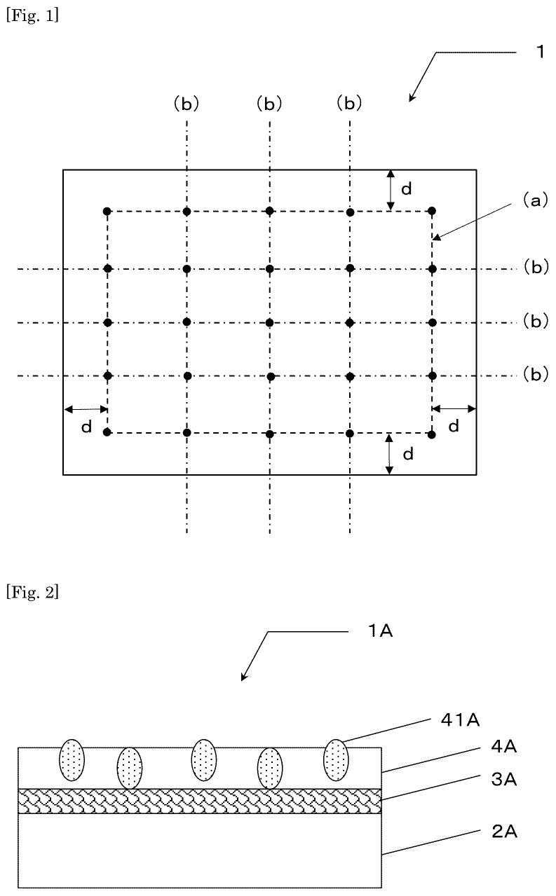

The region (a) located 1.5 cm inward from the outer circumference of the optical laminate here means a region surrounded by straight lines parallel transferred 1.5 cm inward from respective four sides of the optical laminate to the inward of the optical laminate, and is specifically a region surrounded by a dashed line (a) in FIG. 1. In FIG. 1, reference 1 indicates the optical laminate, and reference d indicates the distance (1.5 cm) from the outer circumference of the optical laminate. The straight lines (b) are straight lines for equally longitudinally and laterally dividing the region (a) by n, and represented by dashed-dotted lines (b) in FIG. 1. The surface resistivity is then measured at each of the vertexes of the region (a), the intersections of the straight lines (b), and the intersections of four sides defining the region (a) and the straight lines (b) which are represented by black points in FIG. 1, and the average value and the standard deviation thereof are calculated. FIG. 1 illustrates a case where n=4.

When n=1, no straight lines (b) are drawn, and the surface resistivity is measured at each of the vertexes of the region (a).

“n” can be varied depending on the area of the optical laminate to be measured. The surface resistivity may be measured after the optical laminate is appropriately cut, from the viewpoint of operation properties in measurement.

The surface resistivity is measured by using a resistivity meter, and a URS probe as a probe under an environment of a temperature of 25±4° C. and a humidity of 50±10% at an application voltage of 500 V. Since the URS probe is small in ground contact area with the optical laminate and thus is high in measurement accuracy of the variability in surface resistivity in the plane, it is necessary to use the URS probe for measurement of the surface resistivity. The surface resistivity can be specifically measured by a method described in Examples.

It is preferable from the viewpoint of the stability over time of the surface resistivity that the ratio of the surface resistivity measured after retention of the optical laminate (I) at 80° C. for 250 hours to the surface resistivity before the retention, (surface resistivity after retention of optical laminate (I) at 80° C. for 250 hours/surface resistivity before retention of optical laminate (I) at 80° C. for 250 hours), be in the range of 0.40 to 2.5 at every measurement point. The ratio is more preferably in the range of 0.50 to 2.0. The surface resistivity ratio can be specifically measured by a method described in Examples.

When the surface resistivity ratio is in the above range, the optical laminate (I) can be less changed in the surface resistivity due to the environmental change, thereby maintaining stable operability for a long period of time when used for a capacitive touch panel.

Examples of the method for adjusting the average value and the standard deviation of the surface resistivity of the optical laminate (I) within the above ranges include: (1) selection of a material for use in transparent conductive layer formation and the thickness, (2) selection of a material for use in surface protection layer formation and the thickness, and (3) application of a layer configuration where a specific transparent conductive layer and a surface protection layer are combined. These will be described below.

It is herein assumed that the optical laminate (I) of the present invention is disposed inward relative to not the outermost surface of an image display device, but a surface protection member provided on an image display device, such as cover glass (see FIG. 7 described below). The same is true on other optical laminates described below.

Hereinafter, each layer constituting the optical laminate (I) of the present invention will be described.

### (Substrate Film)

The substrate film for use in the optical laminate (I) of the present invention is preferably a film having a light transmission property (hereinafter, also referred to as “light transmissive substrate film”.). Examples of the light transmissive substrate film include a resin substrate for use in a conventionally known optical film. The total light transmittance of the light transmissive substrate film is usually 70% or more, preferably 85% or more. The total light transmittance can be herein measured by using an ultraviolet and visible spectrophotometer at room temperature in the air.

Examples of the material composing the light transmissive substrate film include an acetyl cellulose-based resin, a polyester-based resin, a polyolefin-based resin, a (meth)acrylic-based resin, a polyurethane-based resin, a polyethersulfone-based resin, a polycarbonate-based resin, a polysulfone-based resin, a polyether-based resin, a polyether ketone-based resin, a (meth)acrylonitrile-based resin, and a cycloolefin polymer.

Among them, the substrate film more preferably has optical anisotropy (hereinafter, also referred to the substrate film having optical anisotropy as “optically anisotropic substrate”). The optically anisotropic substrate has the nature of disturbing linear polarization emitted from a polarizer.

In the case of an image display device having a configuration where linear polarization is emitted from a polarizer (for example, a liquid crystal display device), unevenness with different colors (rainbow interference pattern) may be observed on a display screen viewed through polarized sunglasses when the optical laminate is disposed closer to a viewer than a display component. Such unevenness, however, can be prevented by providing a layer having optical anisotropy which disturbs linear polarization, at a position closer to a viewer than a polarizer.

Examples of the optically anisotropic substrate include a plastic film having a retardation value of 3000 to 30000 nm (hereinafter, also referred to as “high retardation film”) or a ¼ wavelength phase difference plastic film (hereinafter, also referred to as “¼ wavelength phase difference film”). When light emitted from a polarizer is incident to the high retardation film, light penetrating through the film is extremely increased in phase difference variation due to the wavelength, and therefore the effect of making visual contact of a rainbow interference pattern difficult in viewing of a display screen through polarized sunglasses is exerted. The ¼ wavelength phase difference film has the nature of converting linear polarization emitted from a polarizer to circular polarization, and therefore can prevent a rainbow interference pattern. The ¼ wavelength phase difference film is more preferably used from the viewpoint of the effect of preventing a rainbow interference pattern.

A high retardation film having a retardation value of 3000 to 30000 nm can prevent a rainbow interference pattern from occurring on a display screen in observation of the display screen through polarized sunglasses because of having a retardation value of 3000 nm or more. A too high retardation value cannot here enhance the effect of improving a rainbow interference pattern, and therefore a retardation value of 30000 nm or less can prevent an excessive thickness. The retardation value of the high retardation film is preferably 6000 to 30000 nm.

The retardation value described above is preferably satisfied at a wavelength of about 589.3 nm.

The retardation value (nm) is represented by the refractive index (nx) in a direction (slow phase axis direction) where the maximum refractive index is obtained in the plastic film plane, the refractive index (ny) in a direction (fast phase axis direction) perpendicular to the slow phase axis direction, and the thickness (d) (nm) of the plastic film, according to the following expression.

$$Retardation value ( Re ) = ( nx - ny ) \times d$$

The retardation value can also be measured by, for example, KOBRA-WR manufactured by Oji Scientific Instruments (measurement angle: 0°, measurement wavelength: 589.3 nm).

Alternatively, the retardation value is obtained by determining an orientation axis direction (main axis direction) of a substrate by use of two polarization plates, determining the refractive indexes (nx, ny) in two axes perpendicular to the orientation axis direction by an Abbe refractometer (NAR-AT, manufactured by Atago Co., Ltd.), to define an axis in which a larger refractive index is exhibited, as a slow phase axis, and multiplying the thus determined refractive index difference (nx−ny) by the thickness measured with an electric micrometer (manufactured by Anritsu).

In the first invention, the nx−ny (hereinafter, also sometimes referred to as “Δn”) is preferably 0.05 or more, more preferably 0.07 or more, further preferably 0.10 or more. When the Δn is 0.05 or more, a high retardation value can be obtained even if the thickness of the substrate film is thin, and therefore the above-mentioned suppression of a rainbow interference pattern and a decrease in thickness can be simultaneously satisfied.

Any material exemplified for the light transmissive substrate film can be used as the material composing the high retardation film. In particular, a polyester-based resin is preferable, and in particular, a polyethylene terephthalate (PET) and a polyethylene naphthalate (PEN) are more preferable.

The high retardation film, when made of, for example, the polyester-based resin such as the above PET, can be obtained by melting polyester as a material, transversely orienting an unoriented polyester extruded into a sheet, by use of a tenter or the like at a temperature equal to or more than the glass transition temperature, and thereafter subjecting the sheet to a heat treatment. The transverse orientation temperature is preferably 80 to 130° C., more preferably 90 to 120° C. The transverse orientation ratio is preferably 2.5 to 6.0 times, more preferably 3.0 to 5.5 times. An orientation ratio of 2.5 times or more can increase orientation tension and increase birefringence of the resulting film, thereby allowing the retardation value to be 3000 nm or more. A transverse orientation ratio of 6.0 times or less can prevent a reduction in film transparency.

Examples of the method for controlling the retardation value of the high retardation film fabricated by the above method, to 3000 nm or more, include a method for appropriately setting the orientation ratio and the orientation temperature, as well as the thickness of the high retardation film fabricated. Specifically, for example, a higher retardation value is easily obtained as the orientation ratio is higher, the orientation temperature is lower, and the thickness is thicker.

Among the optically anisotropic substrates, as the ¼ wavelength phase difference plastic film, a positive ¼ wavelength phase difference film in which the phase difference at 550 nm is 137.5 nm can be used, and a substantially ¼ wavelength phase difference film in which the phase difference at 550 nm is 80 to 170 nm can also be used. Such positive ¼ wavelength phase difference film and substantially ¼ wavelength phase difference film are suitable in that such films can prevent a rainbow interference pattern from occurring on a display image of a liquid crystal display device in observation by polarized sunglasses, and can be decreased in thickness as compared with the high retardation film.

The ¼ wavelength phase difference film can be formed by uniaxially or biaxially orienting a plastic film, or regularly aligning a liquid crystal material in a plastic film or in a layer provided on a plastic film. As the plastic film, for example, a film made of polycarbonate, polyester, polyvinyl alcohol, polystyrene, polysulfone, polymethyl methacrylate, polypropylene, a cellulose acetate-based polymer, polyamide, a cycloolefin polymer, or the like can be used. Among them, one where a plastic film is oriented and one where a liquid crystal layer comprising a liquid crystal material is provided on a plastic film are preferable, and one where a plastic film is oriented is more preferable and one where a polycarbonate, cycloolefin polymer or polyester film is oriented is particularly preferable from the viewpoint of easiness of a production process for imparting a ¼ wavelength phase difference in an orientation step.

A cycloolefin polymer film is more preferably used as the substrate film in the optical laminate (I). The cycloolefin polymer film is excellent in transparency, low moisture absorption property, and heat resistance. In particular, the cycloolefin polymer film is preferably a ¼ wavelength phase difference film obliquely oriented. When the cycloolefin polymer film is a ¼ wavelength phase difference film, the effect of being capable of preventing a rainbow interference pattern from occurring in observation of a display screen such as a liquid crystal screen by polarized sunglasses, as described above, is highly exerted, and therefore visibility is favorable. When the cycloolefin polymer film is an obliquely oriented film, the optical laminate (I) is not needed to be cut obliquely into a single sheet even when the optical laminate (I) and a polarizer constituting the front panel of an image display device are bonded so that the optical axes of both are aligned. Therefore, not only can continuous production by roll-to-roll be made, but the effect of lessening the waste by oblique cutting into a single sheet is also exerted.

The direction of the optical axis of an oriented film obtained by a common orientation treatment is a direction parallel or perpendicular to the width direction thereof. Therefore, for bonding so that the transmission axis of a linear polarizer and the optical axis of the ¼ wavelength phase difference film are aligned, the film is needed to be cut obliquely into a single sheet. Thus, not only is a production process complicated, but the film is also largely wasted because of being obliquely cut. In addition, production by roll-to-roll cannot be conducted and continuous production is difficult to conduct. The obliquely oriented film, however, can be used as the substrate film, thereby solving such problems.

Examples of the cycloolefin polymer can include a norbornene-based resin, a monocyclic olefin-based resin, a cyclic conjugated diene-based resin, a vinyl alicyclic hydrocarbon-based resin, and hydrogenated products thereof. Among them, a norbornene-based resin is preferable from the viewpoint of transparency and moldability.

Examples of the norbornene-based resin can include a ring-opening polymer of a monomer having a norbornene structure or a ring-opening copolymer of a monomer having a norbornene structure with other monomer, or a hydrogenated product thereof; and an addition polymer of a monomer having a norbornene structure or an addition copolymer of a monomer having a norbornene structure with other monomer, or a hydrogenated product thereof.

The orientation angle of the obliquely oriented film with respect to the width direction of the film is preferably 20 to 70°, more preferably 30 to 60°, further preferably 40 to 50°, particularly preferably 45°. The reason is because the orientation angle of the obliquely oriented film is 45° to thereby obtain complete circular polarization. In addition, the optical laminate (I) is not needed to be cut obliquely into a single sheet even when bonded so as to be aligned with the optical axis of a polarizer, and thus continuous production by roll-to-roll can be conducted.

The cycloolefin polymer film can be obtained by appropriately adjusting the orientation ratio, the orientation temperature, and the thickness in formation of a cycloolefin polymer into a film and orientation of the film. Examples of a commercially available cycloolefin polymer include “Topas” (trade name, manufactured by Ticona), “ARTON” (trade name, manufactured by JSR Corporation), “ZEONOR” and “ZEONEX” (all are trade names, manufactured by ZEON CORPORATION)), and “APEL” (manufactured by Mitsui Chemicals, Inc.).

A commercially available cycloolefin polymer film can also be used. Examples of the film include “ZEONOR film” (trade name, manufactured by ZEON CORPORATION) and “ARTON film” (trade name, manufactured by JSR Corporation).

The substrate film for use in the optical laminate (I) can contain additives such as an antioxidant, a heat stabilizer, a light stabilizer, an ultraviolet absorber, a lubricant, a plasticizer, and a colorant as long as the effect of the present invention is not impaired. Among them, the substrate film preferably contains an ultraviolet absorber. The reason is because the substrate film contains an ultraviolet absorber to thereby exert the effect of preventing degradation due to ultraviolet light as light from outside.

The ultraviolet absorber is not particularly limited, and a known ultraviolet absorber can be used. Examples include a benzophenone-based compound, a benzotriazole-based compound, a triazine-based compound, a benzoxazine-based compound, a salicylic acid ester-based compound, and a cyanoacrylate-based compound. Among them, a benzotriazole-based compound is preferable from the viewpoint of weather resistance and color tone. The ultraviolet absorber can be used singly or in combinations of two or more kinds thereof.

The content of the ultraviolet absorber in the substrate film is preferably 0.1 to 10% by mass, more preferably 0.5 to 5% by mass, further preferably 1 to 5% by mass. When the content of the ultraviolet absorber is in the above range, the transmittance at a wavelength of 380 nm, of the optical laminate (I), can be suppressed to 30% or less, and yellow tinge due to inclusion of the ultraviolet absorber can be suppressed.

The thickness of the substrate film is preferably in the range of 4 to 200 μm, more preferably 4 to 170 μm, further preferably 20 to 135 μm, still further preferably 20 to 120 μm from the viewpoint of strength, processing suitability, and decreases in thicknesses of a front panel and an image display device using the optical laminate (I).

### (Transparent Conductive Layer)

The transparent conductive layer comprised in the optical laminate (I) of the present invention, when applied to a capacitive touch panel, exerts the effect of evening out the in-plane potential of the touch panel for stabilization of operability. The transparent conductive layer is particularly preferably combined with a conducting surface protection layer described below from the viewpoint of providing the above effect. The transparent conductive layer also has an alternative role for a touch panel which has served as a conductive member in a conventional external type or on cell type touch panel, in an in-cell touch panel. When an optical laminate having the transparent conductive layer is used for the front surface of a liquid crystal display component on which an in-cell touch panel is mounted, the transparent conductive layer is positioned closer to an operator than the liquid crystal display component, and therefore can allow static electricity generated on a touch panel surface to escape and can prevent a liquid crystal screen from being partially clouded by the static electricity. From such a viewpoint, the transparent conductive layer, even if being decreased in thickness, can preferably impart a sufficient conductive property, and is preferably less colored, favorable in transparency, excellent in weather resistance and small in the change over time in conductive property.

The material composing the transparent conductive layer is not particularly limited, and is preferably a cured product of an ionizing radiation curable resin composition comprising an ionizing radiation curable resin and conductive particles. Among them, the transparent conductive layer is more preferably a cured product of an ionizing radiation curable resin composition comprising an ionizing radiation curable resin (A) having an alicyclic structure in the molecule and conductive particles in terms of being excellent in in-plane uniformity and stability over time of surface resistivity, and close contact property in the case of use of the cycloolefin polymer film as the substrate film.

The ionizing radiation curable resin composition herein means a resin composition that is curable by irradiation with ionizing radiation. The ionizing radiation that can be used, among electromagnetic waves or charged particle beam, is one having an energy quantum being capable of polymerizing or crosslinking a molecule, for example, not only ultraviolet light (UV) or electron beam (EB), but also electromagnetic waves such as X-ray and γ-ray, and charged particle beam such as α-ray and ion beam.

It is generally known that the cycloolefin polymer film has a low polarity and thus be low in close contact property with a layer made of a resin component. Accordingly, when a conductive layer made of a resin component is directly provided on the film, it is very difficult to impart a close contact property unless a surface treatment such as a corona treatment or primer layer formation is performed. A transparent conductive layer formed using the ionizing radiation curable resin composition comprising an ionizing radiation curable resin (A) having an alicyclic structure in the molecule and conductive particles, however, is excellent in close contact property with the cycloolefin polymer film even if a complicated surface treatment such as a corona treatment or primer layer formation is not performed on the film.

While the reason why the effect is achieved by the resin composition is not clear, it is considered that a close contact property with the cycloolefin polymer film is excellent because the ionizing radiation curable resin (A) has a low polarity structure in the molecule as in a cycloolefin polymer and is less in the occurrence of cure shrinkage. While the optical laminate (I) has a configuration where a surface protection layer is provided on the transparent conductive layer, the surface protection layer is assumed to be positioned inward relative to a surface protection member provided in an image display device. Accordingly, the surface protection layer and the transparent conductive layer positioned thereunder are not needed to have the same hardness as that of a hard coating which is for preventing scratching of an image display device on the outermost surface of the display device, and may have a hardness to such an extent that there is no scratching during a production process of a front panel or an image display device. While an ionizing radiation curable resin composition to be used for forming a hard coating high in hardness is usually high in crosslinking rate, the resin composition is also increased in cure shrinkage. No resin composition high in crosslinking rate, however, is needed to be used for formation of the transparent conductive layer in the present invention, and therefore the influence of cure shrinkage can be further decreased and the close contact property with the cycloolefin polymer film is also enhanced.

The transparent conductive layer formed using the ionizing radiation curable resin composition is also excellent in in-plane uniformity and stability over time of surface resistivity. The reason is considered because the resin composition including the ionizing radiation curable resin (A) is less in the occurrence of cure shrinkage and thus causes less deformation due to the occurrence of contraction stress or the like, and furthermore has a low polarity and thus is low in moisture absorption property and favorable in stability over time.

### [Ionizing Radiation Curable Resin (A) Having Alicyclic Hydrocarbon Structure in Molecule]

An ionizing radiation curable resin composition for transparent conductive layer formation preferably comprises an ionizing radiation curable resin (A) having an alicyclic hydrocarbon structure in the molecule (hereinafter, also referred to as simply “ionizing radiation curable resin (A)”) from the above viewpoints. The alicyclic hydrocarbon structure here means a ring derived from an alicyclic hydrocarbon compound. The alicyclic hydrocarbon compound may be saturated or unsaturated, and may have a monocyclic ring or a polycyclic ring formed from two or more monocyclic rings. The alicyclic hydrocarbon structure may have a substituent.

Examples of the alicyclic hydrocarbon structure include cycloalkane rings such as a cyclopropane ring, a cyclobutane ring, a cyclopentane ring, a cyclohexane ring, a cycloheptane ring and a cyclooctane ring; cycloalkene rings such as a cyclopentene ring, a cyclohexene ring, a cycloheptene ring and a cyclooctene ring; bicyclo rings such as a dicyclopentane ring, a norbornane ring, a decahydronaphthalene ring, a dicyclopentene ring and a norbornene ring; and tricyclo rings such as a tetrahydrodicyclopentadiene ring, a dihydrodicyclopentadiene ring and an adamantane ring; but are not limited thereto.

In particular, the alicyclic hydrocarbon structure preferably has a polycyclic structure made up of two or more monocyclic rings, more preferably comprises a bicyclo ring or a tricyclo ring, from the viewpoint of suppressing cure shrinkage of the ionizing radiation curable resin composition to enhance a close contact property with the substrate film. The number of ring members in each of the monocyclic rings is preferably 4 to 7, more preferably 5 to 6. The ring structure is more preferably a structure having a constituent unit made up of two or more monocyclic rings having the same number of ring members as each other. The reason is because, even if contraction stress occurs during or after curing of the ionizing radiation curable resin composition, a strain direction is not deflected and thus a transparent conductive layer formed is favorable in close contact property with the cycloolefin polymer film, in-plane uniformity and stability over time of surface resistivity.

Examples of a particularly preferable alicyclic hydrocarbon structure can include at least one selected from the group consisting of a tetrahydrodicyclopentadiene ring represented by the following formula (1) and a dihydrodicyclopentadiene ring represented by the following formula (2).

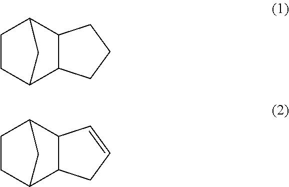

The ionizing radiation curable resin (A) has at least one ionizing radiation curable functional group in the molecule. The ionizing radiation curable functional group is not particularly limited, and is preferably a radical polymerizable functional group from the viewpoint of curability and the hardness of a cured product. Examples of the radical polymerizable functional group include ethylenically unsaturated bond-containing groups such as a (meth)acryloyl group, a vinyl group and an allyl group. Among them, a (meth)acryloyl group is preferable from the viewpoint of curability.

Specific examples of the ionizing radiation curable resin (A) include monofunctional (meth)acrylates such as cyclohexyl (meth)acrylate, isobornyl (meth)acrylate, 1-adamantyl (meth)acrylate, dicyclopentenyl (meth)acrylate, dicyclopentenyloxyethyl (meth)acrylate and dicyclopentanyl (meth)acrylate; and polyfunctional (meth)acrylates such as dimethylol-tricyclodecane di(meth)acrylate, pentacyclopentadecanedimethanol di(meth)acrylate, cyclohexanedimethanol di(meth)acrylate, norbornanedimethanol di(meth)acrylate, p-menthane-1,8-diol di(meth)acrylate, p-menthane-2,8-diol di(meth)acrylate, p-menthane-3,8-diol di(meth)acrylate and bicyclo[2.2.2]-octane-1-methyl-4-isopropyl-5,6-dimethylol di(meth)acrylate, and these can be used singly or in combinations of two or more kinds thereof. Among them, monofunctional or bifunctional (meth)acrylate is preferable, at least one selected from the group consisting of dicyclopentenyl (meth)acrylate, dicyclopentenyloxyethyl (meth)acrylate, dicyclopentanyl (meth)acrylate and dimethylol-tricyclodecane di(meth)acrylate is more preferable, and at least one selected from the group consisting of dicyclopentenyl (meth)acrylate, dicyclopentenyloxyethyl (meth)acrylate and dicyclopentanyl (meth)acrylate is further preferable, from the viewpoint of preventing a close contact property with the substrate film from being reduced due to excessive occurrence of cure shrinkage and a reduction in flexibility of a cured product.

Examples of a commercially available ionizing radiation curable resin (A) include FA-511AS, FA-512AS, FA-513AS, FA-512M, FA-513M and FA-512MT (all are trade names, manufactured by Hitachi Chemical Co., Ltd.), LIGHT ESTER DCP-A and DCP-M (all are trade names, manufactured by Kyoeisha Chemical Co., Ltd.), and A-DCP and DCP (all are trade names, manufactured by Shin-Nakamura Chemical Co., Ltd.). These are each an ionizing radiation curable resin having the tetrahydrodicyclopentadiene ring represented by the formula (1) or having the dihydrodicyclopentadiene ring represented by the formula (2).

The molecular weight of the ionizing radiation curable resin (A) is not particularly limited, and the molecular weight is preferably 350 or less, more preferably 150 to 350, further preferably 150 to 300, still further preferably 150 to 230 from the viewpoint of a close contact property in the case of use of the cycloolefin polymer film as the substrate film. When the molecular weight of the ionizing radiation curable resin (A) is 350 or less, the ionizing radiation curable resin (A) is more easily wetted into the cycloolefin polymer film than a resin high in molecular weight. Therefore, it is considered that, when the film is coated with the ionizing radiation curable resin composition, the ionizing radiation curable resin (A) is selectively transferred to and wetted into the film, and cured by ionizing radiation as it is, thereby resulting in a further enhancement in close contact property of a transparent conductive layer formed, with the film. Additionally, when the molecular weight of the ionizing radiation curable resin (A) is 350 or less, the volume ratio of the alicyclic hydrocarbon structure portion to the ionizing radiation curable functional group is high, and therefore it is considered that cure shrinkage can be more suppressed to result in an enhancement in close contact property with the cycloolefin polymer film.

### [Ionizing Radiation Curable Resin (B)]

The ionizing radiation curable resin composition for transparent conductive layer formation may include an ionizing radiation curable resin (B) other than the ionizing radiation curable resin (A). The ionizing radiation curable resin (B) is preferably used in combination with the ionizing radiation curable resin (A) in that curability and applicability of the resin composition, as well as hardness, weather resistance and the like of a transparent conductive layer formed can be enhanced.

The ionizing radiation curable resin (B) that can be used is appropriately selected from the group consisting of a polymerizable monomer and a polymerizable oligomer or prepolymer which are commonly used, other than the ionizing radiation curable resin (A).

The polymerizable monomer is suitably a (meth)acrylate monomer having a (meth)acryloyl group in the molecule, and in particular, is preferably a polyfunctional (meth)acrylate monomer.

The polyfunctional (meth)acrylate monomer may be a (meth)acrylate monomer having two or more (meth)acryloyl groups in the molecule, and is not particularly limited. Specific examples preferably include di(meth)acrylates such as ethylene glycol di(meth)acrylate, propylene glycol di(meth)acrylate, pentaerythritol di(meth)acrylate monostearate, dicyclopentanyl di(meth)acrylate and isocyanurate di(meth)acrylate; tri(meth)acrylates such as trimethylolpropane tri(meth)acrylate, pentaerythritol tri(meth)acrylate and tris(acryloxyethyl) isocyanurate; tetra- or higher functional (meth)acrylates such as pentaerythritol tetra(meth)acrylate, dipentaerythritol tetra(meth)acrylate, dipentaerythritol penta(meth)acrylate and dipentaerythritol hexa(meth)acrylate; and ethylene oxide-modified products, propylene oxide-modified products, caprolactone-modified products and propionic acid-modified products of the above-mentioned polyfunctional (meth)acrylate monomers. Among them, polyfunctional (meth)acrylate as compared with tri(meth)acrylate, namely, tri- or higher functional (meth)acrylate is preferable from the viewpoint that an excellent hardness is achieved. Such polyfunctional (meth)acrylate monomers may be used singly or in combinations of two or more kinds thereof.

Examples of the polymerizable oligomer preferably include an oligomer bearing a radical polymerizable functional group in the molecule, for example, epoxy (meth)acrylate-based, urethane (meth)acrylate-based, polyester (meth)acrylate-based, and polyether (meth)acrylate-based oligomers. Furthermore, examples of the polymerizable oligomer preferably also include a polybutadiene (meth)acrylate-based oligomer bearing a (meth)acrylate group in a side chain of a polybutadiene oligomer and having high hydrophobicity, and a silicone (meth)acrylate-based oligomer bearing a polysiloxane bond in the main chain. Such oligomers may be used singly or in combinations of two or more kinds thereof.

The weight average molecular weight (weight average molecular weight in terms of standard polystyrene, as measured by the GPC method) of the polymerizable oligomer is preferably 1,000 to 20,000, more preferably 1,000 to 15,000.

The polymerizable oligomer is preferably bi- or higher functional, more preferably tri- to dodecafunctional, further preferably tri- to decafunctional. When the number of functional groups is in the above range, a transparent conductive layer excellent in hardness is obtained.

Among the ionizing radiation curable resin (B), a polymerizable oligomer having a weight average molecular weight of 1,000 or more is preferably used, and the weight average molecular weight is more preferably 1,000 to 20,000, further preferably 2,000 to 15,000. The reason is because an increase in cure shrinkage due to a too high crosslinking rate can be suppressed and a close contact property with the substrate film can be maintained while hardness can be imparted to a transparent conductive layer formed. In addition, not only the initial close contact property, but also the close contact property over time (hereinafter, also referred to as “permanent close contact property”.) in consideration of an environmental factor such as ultraviolet light can become favorable. In particular, when the substrate film, for example, the cycloolefin polymer film is coated with an ionizing radiation curable resin (A) having a molecular weight of 350 or less, phase separation between the component (A) low in molecular weight and the component (B) high in molecular weight easily occurs and the component (A) is selectively transferred to the film and wetted into the film, thereby resulting in a further enhancement in close contact property of a transparent conductive layer formed. In addition, use of the ionizing radiation curable resin (A) having a molecular weight of 350 or less may reduce the viscosity of the resin composition, and therefore a polymerizable oligomer having a weight average molecular weight of 1,000 or more is preferably used as the component (B) to enhance applicability.

It can be confirmed by an infrared spectroscopy (IR) spectrum or the like that the ionizing radiation curable resin (A) is selectively transferred to the cycloolefin polymer film and wetted into the film as described above, with respect to the transparent conductive layer. For example, the transparent conductive layer is formed on the cycloolefin polymer film, and thereafter an IR spectrum obtained by subjecting the transparent conductive layer collected, to measurement according to a transmission method, is compared with an IR spectrum obtained by singly subjecting each of the ionizing radiation curable resins (A) and (B) to such measurement. In such a case, when the rate of absorption derived from the ionizing radiation curable resin (A) is lower than the rate of the component (A) actually compounded, in the IR spectrum obtained by measurement of the transparent conductive layer collected, the ionizing radiation curable resin (A) can be expected to be selectively transferred to the cycloolefin polymer film and wetted into the film.

The content of the ionizing radiation curable resin (A) in the ionizing radiation curable resin composition for transparent conductive layer formation is preferably 20% by mass or more, more preferably 20 to 90% by mass, further preferably 25 to 80% by mass, still further preferably 30 to 70% by mass relative to the total amount of the resin components composing the resin composition. When the content of the ionizing radiation curable resin (A) is 20% by mass or more relative to the total amount of the resin components composing the resin composition, a transparent conductive layer excellent in close contact property and also excellent in in-plane uniformity and stability over time of surface resistivity even in the case of use of the cycloolefin polymer film as the substrate film can be formed.

The content of the ionizing radiation curable resin (B) in the ionizing radiation curable resin composition for transparent conductive layer formation is preferably 80% by mass or less, more preferably 10 to 80% by mass, further preferably 20 to 75% by mass, still further preferably 30 to 70% by mass relative to the total amount of the resin components composing the resin composition.

### [Conductive Particle]

The conductive particle is used to impart a conductive property to the transparent conductive layer formed using the ionizing radiation curable resin composition, without any transparency lost. Accordingly, the conductive particle is preferably one that can impart a sufficient conductive property and that is less colored, is favorable in transparency, is excellent in weather resistance and is less changed over time in conductive property, even if the thickness of the transparent conductive layer is decreased. A particle high in hardness is also preferable from the viewpoint of avoiding a reduction in surface protection performance of the surface protection layer as an upper layer due to a too high flexibility of the transparent conductive layer.

As such a conductive particle, a metal particle, a metal oxide particle, a coating particle where a conductive covering layer is formed on the surface of a core particle, and the like are suitably used.

Examples of the metal composing the metal particle include Au, Ag, Cu, Al, Fe, Ni, Pd, and Pt. Examples of the metal oxide composing the metal oxide particle include tin oxide (SnO₂), antimony oxide (Sb₂O₅), antimony tin oxide (ATO), indium tin oxide (ITO), aluminum zinc oxide (AZO), fluorinated tin oxide (FTO) and ZnO.

Examples of the coating particle include a particle where a conductive covering layer is formed on the surface of a core particle. The core particle is not particularly limited, and examples include inorganic particles such as a colloidal silica particle and a silicon oxide particle, polymer particles such as a fluororesin particle, an acrylic resin particle and a silicone resin particle, and organic-inorganic composite particles. Examples of the material composing the conductive covering layer include metals described above or alloys thereof, and metal oxides described above. These can be used singly or in combinations of two or more kinds thereof.

Among them, the conductive particle is preferably at least one selected from the group consisting of a metal fine particle and a metal oxide fine particle, and an antimony tin oxide (ATO) particle is more preferable, from the viewpoint that long-term storage, heat resistance, moist heat resistance, and weather resistance are favorable.

The average primary particle size of the conductive particle is preferably 5 to 40 nm. When the average primary particle size is 5 nm or more, the conductive particle can be easily in contact with each other in the transparent conductive layer, thereby allowing for a decrease in the amount of the conductive particle added for imparting a sufficient conductive property. In addition, when the average primary particle size is 40 nm or less, transparency, and a close contact property with other layer can be prevented from being impaired. A more preferable lower limit of the average primary particle size of the conductive particle is 6 nm, and a more preferable upper limit thereof is 20 nm.

The average primary particle size of the conductive particle can be calculated by the following operations (1) to (3).
(1) An image of a cross section of the optical laminate is taken by a transmission electron microscope (TEM) or a scanning transmission electron microscope (STEM). In TEM or STEM, the acceleration voltage is preferably 10 kV to 30 kV and the magnification is preferably 50000 to 300000 times.
(2) Any 10 particles are extracted from the observation image, and the particle size of each of the particles is calculated. The particle size is measured as the distance between any parallel two straight lines which are combined so that the distance between such two straight lines is maximum when a cross section of each of the particles is sandwiched between such two straight lines.
(3) The same operation is performed five times with respect to an observation image on another screen of the same sample, and the value obtained from the number average of 50 particle sizes in total is defined as the average primary particle size of the conductive particle.

A transparent conductive layer obtained by using the ionizing radiation curable resin composition, even if being decreased in thickness, preferably, can impart a sufficient conductive property, and is less colored, is favorable in transparency, is excellent in weather resistance and is less changed over time in conductive property. Accordingly, the content of the conductive particles in the resin composition is not particularly limited as long as the performances can be imparted.

The content of the conductive particles in the ionizing radiation curable resin composition is preferably 100 to 400 parts by mass, more preferably 150 to 350 parts by mass, further preferably 200 to 300 parts by mass relative to 100 parts by mass of the ionizing radiation curable resin, from the viewpoint that the average value of the surface resistivity is set to 1.0×10⁷Ω/ [symbol] or more and 1.0×10¹⁰Ω/ [symbol] or less. The reason is because when the content of the conductive particles is set to 100 parts by mass or more relative to 100 parts by mass of the ionizing radiation curable resin, the average value of the surface resistivity of the optical laminate is easily set to 1.0×10¹⁰Ω/ [symbol] or less, and when the content is set to 400 parts by mass or less, not only is the average value of the surface resistivity of the optical laminate easily set to 1.0×10⁷Ω/ [symbol] or more, but also the transparent conductive layer is not brittle and hardness can be maintained.

When the ionizing radiation curable resin is an ultraviolet light curable resin, the ionizing radiation curable resin composition for transparent conductive layer formation preferably comprises a photopolymerization initiator and/or a photopolymerization accelerator.

Examples of the photopolymerization initiator include acetophenone, α-hydroxyalkylphenone, acylphosphine oxide, benzophenone, Michler's ketone, benzoin, benzyl dimethyl ketal, benzoyl benzoate, α-acyloxime ester and thioxanthones. The photopolymerization accelerator can reduce a polymerization obstacle due to air in curing and increase the curing rate, and examples include p-dimethylaminobenzoic acid isoamyl ester and p-dimethylaminobenzoic acid ethyl ester.

The photopolymerization initiator and the photopolymerization accelerator can be each used singly or in combinations of two or more kinds thereof.

When the ionizing radiation curable resin composition for transparent conductive layer formation comprises the photopolymerization initiator, the content of the photopolymerization initiator is preferably 0.1 to 10 parts by mass, more preferably 1 to 10 parts by mass, further preferably 1 to 8 parts by mass relative to 100 parts by mass of the ionizing radiation curable resin.

The ionizing radiation curable resin composition for transparent conductive layer formation can further contain, if necessary, other components, for example, additives such as a refractive index adjusting agent, an anti-glare agent, an antifouling agent, an ultraviolet absorber, an antioxidant, a leveling agent and a lubricant.

Furthermore, the resin composition can contain a solvent. Any solvent can be used as such a solvent without any particular limitation as long as it dissolves each component contained in the resin composition, and is preferably ketones, ethers, alcohols or esters. The solvent can be used singly or in combinations of two or more kinds thereof.

The content of the solvent in the resin composition is usually 20 to 99% by mass, preferably 30 to 99% by mass, more preferably 70 to 99% by mass. When the content of the solvent is in the above range, coatability of the substrate film is excellent.

The method for producing the ionizing radiation curable resin composition for transparent conductive layer formation is not particularly limited, and can be produced by using conventionally known method and device. For example, the ionizing radiation curable resin composition can be produced by adding and mixing the ionizing radiation curable resin, the conductive particles, and, if necessary, various additives and the solvent. The conductive particles may be used in the form of a dispersion liquid prepared by dispersing the conductive particles in the solvent in advance.

The thickness of the transparent conductive layer is preferably 0.1 to 10 μm, more preferably 0.3 to 5 μm, further preferably 0.3 to 3 μm in terms of imparting a desired conductive property without any transparency lost.

The thickness of the transparent conductive layer can be calculated by, for example, measuring the thickness at 20 points in an image of a cross section, taken by using a scanning transmission electron microscope (STEM), and calculating the average value of the values at such 20 points. The acceleration voltage in STEM is preferably 10 kV to 30 kV, and the observation magnification in STEM is preferably 1000 to 7000 times.

### (Surface Protection Layer)

The optical laminate (I) of the present invention comprises a surface protection layer from the viewpoint that scratching of a front panel or an image display device in a production process is prevented.

As exemplified in the image display device of the present invention (FIG. 7) described below, the surface protection layer is assumed to be positioned inward relative to a surface protection member provided on the outermost surface of an image display device. Accordingly, the surface protection layer may have hardness to such an extent that no scratching is made in a production process of a front panel or an image display device, unlike a hard coating for preventing scratching of the outermost surface of an image display device.

The surface protection layer is preferably a cured product of the ionizing radiation curable resin composition comprising the ionizing radiation curable resin, from the viewpoint that scratching of a front panel or an image display device in a production process is prevented.

The ionizing radiation curable resin contained in the ionizing radiation curable resin composition that can be used is appropriately selected from the group consisting of a polymerizable monomer and a polymerizable oligomer or prepolymer which are commonly used, and is preferably a polymerizable monomer from the viewpoint that curability and the hardness of the surface protection layer are enhanced.

The polymerizable monomer is suitably a (meth)acrylate-based monomer having a radical polymerizable functional group in the molecule, and in particular, a polyfunctional (meth)acrylate-based monomer is preferable. Examples of the polyfunctional (meth)acrylate-based monomer include the same as those exemplified in the above-mentioned ionizing radiation curable resin composition for transparent conductive layer formation. The molecular weight of the polyfunctional (meth)acrylate-based monomer is preferably less than 1,000, more preferably 200 to 800 from the viewpoint that the hardness of the surface protection layer is enhanced.

The polyfunctional (meth)acrylate-based monomer may be used singly or in combinations of two or more kinds thereof.

The number of functional groups in the polyfunctional (meth)acrylate-based monomer is not particularly limited as long as it is 2 or more, and the number is preferably 2 to 8, more preferably 2 to 6, further preferably 3 to 6 from the viewpoint that the curability of the ionizing radiation curable resin composition and the hardness of the surface protection layer are enhanced.

The content of the polyfunctional (meth)acrylate-based monomer in the ionizing radiation curable resin is preferably 40% by mass or more, more preferably 50% by mass or more, further preferably 60 to 100% by mass from the viewpoint that the curability of the ionizing radiation curable resin composition and the hardness of the surface protection layer are enhanced.

The ionizing radiation curable resin is preferably composed of only the polymerizable monomer from the viewpoint that the curability of the ionizing radiation curable resin composition and the hardness of the surface protection layer are enhanced, and may be used in combination with a polymerizable oligomer. Examples of the polymerizable oligomer include the same as those exemplified in the above-mentioned ionizing radiation curable resin composition for transparent conductive layer formation.

The ionizing radiation curable resin composition can also further comprise a thermoplastic resin. The thermoplastic resin can be used in combination, thereby enhancing adhesiveness to the transparent conductive layer and effectually preventing defects on a coating film.

Examples of the thermoplastic resin preferably include simple thermoplastic resins such as a styrene resin, a (meth)acrylic resin, a polyolefin resin, a vinyl acetate resin, a vinyl ether resin, a halogen-containing resin, a polycarbonate resin, a polyester resin, a polyamide resin, nylon, a cellulose resin, a silicone resin and a polyurethane resin, and copolymers thereof, or mixed resins thereof. These resins are preferably non-crystalline and soluble in the solvent. In particular, a styrene resin, a (meth)acrylic resin, a polyolefin resin, a polyester resin, a cellulose resin, and the like are preferable, a (meth)acrylic resin is more preferable, and polymethyl methacrylate is further preferable from the viewpoint of film formability, transparency, weather resistance, and the like.

These thermoplastic resins preferably have no reactive functional group in the molecule. The reason is because an increase in the amount of cure shrinkage and a reduction in adhesiveness of the surface protection layer to the transparent conductive layer caused by having a reactive functional group in the molecule can be avoided. In addition, if the thermoplastic resin has no reactive functional group in the molecule, control of the surface resistivity of the resulting optical laminate is facilitated. Herein, examples of the reactive group include functional groups having an unsaturated double bond, such as an acryloyl group and a vinyl group, cyclic ether groups such as an epoxy ring and an oxetane ring, ring-opening polymerization groups such as a lactone ring, and isocyanate groups for forming urethane. Herein, such a reactive functional group may be contained as long as it does not have any effect on adhesiveness of the surface protection layer to the transparent conductive layer and the surface resistivity.

When the ionizing radiation curable resin composition comprises the thermoplastic resin, the content is preferably 10% by mass or more in the resin component in the ionizing radiation curable resin composition. The content is preferably 80% by mass or less, more preferably 50% by mass or less from the viewpoint of scratch resistance of the resulting surface protection layer. “The resin component in the ionizing radiation curable resin composition” herein used encompasses the ionizing radiation curable resin, the thermoplastic resin, and other resin.

When the ionizing radiation curable resin is an ultraviolet light curable resin, the ionizing radiation curable resin composition for surface protection layer formation preferably comprises a photopolymerization initiator and/or a photopolymerization accelerator. Examples of the photopolymerization initiator and the photopolymerization accelerator include the same as those exemplified in the above-mentioned ionizing radiation curable resin composition for transparent conductive layer formation, and the photopolymerization initiator and the photopolymerization accelerator can be each used singly or in combinations of two or more kinds thereof.

When the photopolymerization initiator is used, the content of the photopolymerization initiator in the ionizing radiation curable resin composition is preferably 0.1 to 10 parts by mass, more preferably 1 to 10 parts by mass, further preferably 1 to 8 parts by mass relative to 100 parts by mass of the ionizing radiation curable resin.

The surface protection layer preferably comprises an ultraviolet absorber. The reason is because when the optical laminate (I) is applied to an image display device, members, for example, the transparent conductive layer and the substrate film positioned inward relative to the surface protection layer (closer to a display component), and a polarizer, a phase difference film and a display component positioned inward relative to the optical laminate (closer to a display component) are prevented from being degraded due to ultraviolet light as light from outside.

The ultraviolet absorber for use in the surface protection layer is not particularly limited, and examples include a benzophenone-based compound, a benzotriazole-based compound, a triazine-based compound, a benzoxazine-based compound, a salicylic acid ester-based compound, a cyanoacrylate-based compound, and polymers thereof. Among them, one or more selected from the group consisting of a benzophenone-based compound, a benzotriazole-based compound, a triazine-based compound, and polymers thereof is preferable from the viewpoint of ultraviolet absorbability, and one or more selected from the group consisting of a benzotriazole-based compound, a triazine-based compound, and polymers thereof is more preferable from the viewpoint of ultraviolet absorbability and the solubility in the ionizing radiation curable resin composition.

These can be used singly or in combinations of two or more kinds thereof.

The content of the ultraviolet absorber in the surface protection layer is preferably 0.2 to 60 parts by mass, more preferably 0.2 to 30 parts by mass, further preferably 0.2 to 20 parts by mass relative to 100 parts by mass of the ionizing radiation curable resin contained in the ionizing radiation curable resin composition composing the surface protection layer. When the content of the ultraviolet absorber is 0.2 parts by mass or more relative to 100 parts by mass of the ionizing radiation curable resin, the effect of preventing degradation due to ultraviolet light as light from outside is sufficient, and when the content is 60 parts by mass or less, a surface protection layer less in coloration derived from the ultraviolet absorber can be obtained while a hardness sufficient for preventing scratching of a front panel or an image display device in a production process is kept.

The surface protection layer preferably further comprises current carrying particles. The current carrying particle refers to a particle that has a role to make a conduction between a surface protection layer comprising the current carrying particles, and the transparent conductive layer. That is, the surface protection layer comprising the current carrying particles (hereinafter, also referred to as “conducting surface protection layer”) is preferably provided when the transparent conductive layer is located between the substrate film and the surface protection layer.

When the surface protection layer is the conducting surface protection layer, the conducting surface protection layer and the transparent conductive layer are positioned on the outermost surface in a front panel obtained by laminating the optical laminate (I) of the present invention, a polarizer and a phase difference film in this order, and therefore a grounding treatment onto the surface of the conducting surface protection layer or the transparent conductive layer can be easily performed. In addition, the optical laminate (I) of the present invention comprises the transparent conductive layer and the conducting surface protection layer, thereby allowing in plane uniformity of surface resistivity to be favorable and also stabilizing the surface resistivity over time even if the conductive property of the transparent conductive layer is low.

The optical laminate (I) of the present invention has an average value of the surface resistivity, of 1.0×10⁷Ω/ [symbol] or more and 1.0×10¹⁰Ω/ [symbol] or less, as described above, and is very low in conductive property as compared with a transparent conductive layer for a touch panel sensor (electrode). Such in-plane uniformity is difficult to realize in such a low conductive property range. The transparent conductive layer and the conducting surface protection layer, however, are combined to thereby allow the surface resistivity to easily achieve a high in-plane uniformity.

The current carrying particle is not particularly limited, and examples include a metal particle, a metal oxide particle, and a coating particle where a conductive covering layer is formed on the surface of a core particle, as in the above-mentioned conductive particle. The current carrying particle is preferably a gold-plated particle from the viewpoint of making conduction from the transparent conductive layer favorable.

The average primary particle size of the current carrying particle can be appropriately selected depending on the thickness of the surface protection layer. Specifically, the average primary particle size of the current carrying particle is preferably more than 50% and 150% or less, more preferably more than 70% and 120% or less, further preferably more than 85% and 115% or less relative to the thickness of the surface protection layer. The average primary particle size of the current carrying particle relative to the thickness of the surface protection layer can be as described above, thereby making conduction from the transparent conductive layer favorable and preventing the current carrying particle from being dropped from the surface protection layer.

The average primary particle size of the current carrying particle in the surface protection layer can be calculated by the following operations (1) to (3).
(1) A transmission observation image of the optical laminate is taken by an optical microscope. The magnification is preferably 500 to 2000 times.
(2) Any 10 particles are extracted from the observation image, and the particle size of each of the particles is calculated. The particle size is measured as the distance between any parallel two straight lines which are combined so that the distance between such two straight lines is maximum when a cross section of each of the particles is sandwiched between such two straight lines.
(3) The same operation is performed five times with respect to an observation image on another screen of the same sample, and the value obtained from the number average of 50 particle sizes in total is defined as the average primary particle size of the current carrying particle.

The content of the current carrying particles in the surface protection layer is preferably 0.5 to 4.0 parts by mass, more preferably 0.5 to 3.0 parts by mass relative to 100 parts by mass of the ionizing radiation curable resin in the ionizing radiation curable resin composition composing the surface protection layer. When the content of the current carrying particles is 0.5 parts by mass or more, conduction from the transparent conductive layer can become favorable. When the content is 4.0 parts by mass or less, reductions in formability and hardness of the surface protection layer can be prevented.

The ionizing radiation curable resin composition for surface protection layer formation can contain, as other various additive components, a filler such as a wear resistant agent, a delustering agent or a scratch-resistant filler, a release agent, a dispersant, a leveling agent, a hindered amine-based light stabilizer (HALS), and the like.

The ionizing radiation curable resin composition for surface protection layer formation can further contain a solvent. Any solvent can be used as the solvent without any particular limitation as long as such any solvent dissolves each component contained in the resin composition, and ketones or esters are preferable and at least one selected from the group consisting of methyl ethyl ketone and methyl isobutyl ketone is more preferable. The solvent can be used singly or in combinations of two or more kinds thereof.

The content of the solvent in the ionizing radiation curable resin composition is usually 20 to 90% by mass, preferably 30 to 85% by mass, more preferably 40 to 80% by mass.

The thickness of the surface protection layer can be appropriately selected depending on the application and required properties of the optical laminate, and is preferably 1 to 30 μm, more preferably 2 to 20 μm, further preferably 2 to 10 μm from the viewpoint of hardness, processing suitability, and a decrease in thickness of a display device using the optical laminate of the present invention. The thickness of the surface protection layer can be measured by the same method as that with respect to the transparent conductive layer.

The optical laminate (I) of the present invention may comprise the above-mentioned substrate film, transparent conductive layer and surface protection layer in this order, and may also comprise, if necessary, other layer.

For example, the optical laminate (I) may further comprise a functional layer on a surface opposite to the substrate film. Examples of the functional layer include an antireflection layer, a refractive index adjustment layer, an anti-glare layer, a fingerprint-resistant layer, an antifouling layer, a scratch-resistant layer, and an antimicrobial layer. Such a functional layer is preferably formed from the thermosetting resin composition or the ionizing radiation curable resin composition, more preferably formed from the ionizing radiation curable resin composition.

A layer containing additive(s) such as an antioxidant, a heat stabilizer, a light stabilizer, an ultraviolet absorber, a lubricant, a plasticizer, and a colorant can also be provided, other than the above layers, as the functional layer to the extent that the effect of the present invention is not impaired. Furthermore, when the optical laminate is applied to a liquid crystal display device, a high retardation layer can also be provided for the purpose of preventing difficulty in vision and coloration unevenness caused in viewing of a liquid crystal display screen with polarized sunglasses being worn. If a layer having a ¼ wavelength phase difference function is present, however, the high retardation layer is not needed.

The thickness of the functional layer can be appropriately selected depending on the application and required properties of the optical laminate, and is preferably 0.05 to 30 μm, more preferably 0.1 to 20 μm, further preferably 0.5 to 10 μm from the viewpoint of hardness, processing suitability, and a decrease in thickness of a display device using the optical laminate. The thickness, however, is not limited thereto when the functional layer is the above-mentioned high retardation layer, and the thickness may be such that a preferable retardation is achieved. The thickness of the functional layer can be measured by the same method as that with respect to the transparent conductive layer.

The optical laminate (I) of the present invention may comprise a rear surface film as a film for a production process, on a surface thereof, the surface closer to the substrate film. Thus, flatness can be maintained and in-plane uniformity of surface resistivity can be kept in production and processing of the optical laminate, even when a film thin in thickness or a cycloolefin polymer film having no stiffness is used as the substrate film. The rear surface film is not particularly limited, and a polyester-based resin film, a polyolefin-based resin film, or the like can be used. A film high in elastic modulus is preferable, and a polyester-based resin film is more preferable in terms of protection performance.

The thickness of the rear surface film is preferably 10 μm or more, more preferably 20 to 200 μm from the viewpoint that flatness is maintained in production and processing of the optical laminate.

The rear surface film is laminated on, for example, a surface of the optical laminate, the surface being closer to the substrate film, with a pressure-sensitive adhesion layer being interposed therebetween. The rear surface film is here a film for a production process, and therefore is peeled in, for example, bonding of the optical laminate to a polarizer described below.

### [Second Invention: Optical Laminate (II)]

The optical laminate (II) of the present invention according to the second invention comprises a substrate film, a transparent conductive layer and a surface protection layer in this order, wherein the substrate film is a cycloolefin polymer film, the ratio of the thickness of the substrate film to the thickness of the entire optical laminate is 80% or more and 95% or less, and the rate of elongation of the optical laminate at a temperature of 150° C., as measured using a dynamic viscoelasticity measuring apparatus under conditions of a frequency of 10 Hz, a tensile load of 50 N and a rate of temperature increase of 2° C./min, is 5.0% or more and 20% or less. The optical laminate (II) of the present invention satisfies the above conditions, thereby resulting in a favorable close contact property of the transparent conductive layer to a cycloolefin polymer film serving as the substrate film, a high light transmission property in the visible region, and favorable in-plane uniformity of surface resistivity.

If the ratio of the thickness of the substrate film to the thickness of the entire optical laminate is less than 80%, the strength of the optical laminate is reduced. In addition, a light transmission property in the visible region and a predetermined elongation property are not obtained in some cases. On the other hand, if the ratio of the thickness of the substrate film to the thickness of the entire optical laminate is more than 95%, the thickness ratio of each of the transparent conductive layer and the surface protection layer in the optical laminate is decreased, thereby not resulting in desired surface resistivity and its in-plane uniformity, and scratching resistance.

The ratio of the thickness of the substrate film to the thickness of the entire optical laminate (II) is preferably 82% or more, more preferably 85% or more, and preferably 94% or less, more preferably 93% or less, from the above viewpoints.

Furthermore, the rate of elongation of the optical laminate (II) of the present invention at a temperature of 150° C., as measured using a dynamic viscoelasticity measuring apparatus under conditions of a frequency of 10 Hz, a tensile load of 50 N and a rate of temperature increase of 2° C./min, is 5.0% or more and 20% or less. If the rate of elongation is less than 5.0%, the close contact property of the cycloolefin polymer film with the transparent conductive layer is reduced. On the other hand, if the rate of elongation of the optical laminate (II) of the present invention is more than 20%, variability in the thickness of the transparent conductive layer is easily caused by deformation, making it difficult to ensure in-plane uniformity of surface resistivity. As a result, operability may be unstable in use of the optical laminate for a capacitive touch panel.

The rate of elongation of the optical laminate (II) of the present invention is preferably 6.0% or more, more preferably 7.0% or more, and preferably 18% or less, more preferably 15% or less, from the above viewpoints.

The rate of elongation of the optical laminate (II) can be measured using a dynamic viscoelasticity measuring apparatus, and can be specifically measured by a method described in Examples.

The reason why the rate of elongation of the optical laminate (II) of the present invention is in the above range to thereby allow the close contact property of the cycloolefin polymer film with the transparent conductive layer to be achieved is presumed as follows. When the rate of elongation of the optical laminate (II) is 5.0% or more, a low molecular weight component contained in a material for forming the transparent conductive layer, described below, is easily wetted into the cycloolefin polymer film serving as the substrate film. Therefore, the close contact property of a transparent conductive layer formed is enhanced. On the other hand, when the rate of elongation of the optical laminate (II) is 20% or less, the entire optical laminate comprising the transparent conductive layer and the surface protection layer, even if a cycloolefin polymer film low in elastic modulus and being easily deformed is used as the substrate film, can follow such deformation to thereby allow the close contact property to be maintained.

Examples of the method for adjusting the rate of elongation of the optical laminate (II) within the above range include (1) selection of the cycloolefin polymer film serving as the substrate film, (2) selection of the material for use in transparent conductive layer formation, (3) selection of the material for use in surface protection layer formation, and (4) adjustment of the thickness of each of the substrate film, the transparent conductive layer and the surface protection layer, and/or the thickness ratio. Two or more of such methods may be combined. A preferable aspect of each method will be described below.

### (Substrate Film)

A cycloolefin polymer film is used as the substrate film in the optical laminate (II) of the present invention. The cycloolefin polymer film is excellent in transparency, low moisture absorption property, and heat resistance. In particular, the cycloolefin polymer film is preferably a ¼ wavelength phase difference film obliquely oriented. When the cycloolefin polymer film is a ¼ wavelength phase difference film, unevenness with different colors (rainbow interference pattern) can be prevented from occurring on a display screen such as a liquid crystal screen in observation of the display screen by polarized sunglasses, and therefore visibility is favorable. When the cycloolefin polymer film is an obliquely oriented film, the optical laminate (II) of the present invention is not needed to be cut obliquely into a single sheet even when the optical laminate (II) of the present invention and a polarizer constituting a front panel are bonded so that the optical axes of both are aligned. Therefore, not only can continuous production by roll-to-roll be made, but the effect of lessening the waste by oblique cutting into a single sheet is also exerted.

The rate of elongation at a temperature of 150° C., of only the cycloolefin polymer film, as measured using a dynamic viscoelasticity measuring apparatus under conditions of a frequency of 10 Hz, a tensile load of 50 N and a rate of temperature increase of 2° C./min is preferably 5.0% or more, more preferably 6.0% or more, further preferably 7.0% or more, from the viewpoint that the rate of elongation of the entire optical laminate (II) is easily adjusted to 5.0% or more and the close contact property with the transparent conductive layer is enhanced. The rate is preferably 25% or less, more preferably 18% or less, further preferably 15% or less from the viewpoint that in-plane uniformity of surface resistivity of the optical laminate (II) is maintained. The method for measuring the rate of elongation is the same as in the case of the above-mentioned optical laminate.

The glass transition temperature (Tg) of the cycloolefin polymer film is preferably 150° C. or less, more preferably 140° C. or less, further preferably 130° C. or less from the viewpoint that the close contact property with the transparent conductive layer is enhanced. When the cycloolefin polymer film has a Tg of 150° C. or less, it is easily wetted into a low molecular weight component contained in a material for forming the transparent conductive layer, thereby allowing the effect of enhancing the close contact property of a cycloolefin polymer serving as the substrate film with the transparent conductive layer to be achieved.

The Tg of the cycloolefin polymer film can be measured by, for example, a differential scanning calorimeter.

Examples of the cycloolefin polymer can include a norbornene-based resin, a monocyclic olefin-based resin, a cyclic conjugated diene-based resin, a vinyl alicyclic hydrocarbon-based resin, and hydrogenated products thereof. Among them, a norbornene-based resin is preferable from the viewpoint of transparency and moldability. Examples of the norbornene-based resin can include a ring-opening polymer of a monomer having a norbornene structure or a ring-opening copolymer of a monomer having a norbornene structure with other monomer, or a hydrogenated product thereof; and an addition polymer of a monomer having a norbornene structure or an addition copolymer of a monomer having a norbornene structure with other monomer, or a hydrogenated product thereof.

The cycloolefin polymer film for use in the optical laminate (II) can contain additives such as an antioxidant, a heat stabilizer, a light stabilizer, an ultraviolet absorber, a lubricant, a plasticizer, and a colorant to the extent that the effect of the present invention is not impaired. A preferable additive and the content thereof are the same as the additive and the content thereof described with respect to the substrate film of the optical laminate (I).

The orientation angle of the obliquely oriented film with respect to the width direction of the film is preferably 20 to 70°, more preferably 30 to 60°, further preferably 40 to 50°, particularly preferably 45°. The reason is because the orientation angle of the obliquely oriented film is 45° to thereby obtain complete circular polarization. In addition, the optical laminate of the present invention is not needed to be cut obliquely into a single sheet even when bonded so as to be aligned with the optical axis of a polarizer, and thus continuous production by roll-to-roll can be made.

The cycloolefin polymer film can be obtained by appropriately adjusting the orientation ratio, the orientation temperature, and the thickness in formation of a cycloolefin polymer into a film and orientation of the film. Examples of a commercially available cycloolefin polymer include “Topas” (trade name, manufactured by Ticona), “ARTON” (trade name, manufactured by JSR Corporation), “ZEONOR” and “ZEONEX” (all are trade names, manufactured by ZEON CORPORATION), and “APEL” (manufactured by Mitsui Chemicals, Inc.).

A commercially available cycloolefin polymer film can also be used. Examples of the film include “ZEONOR film” (trade name, manufactured by ZEON CORPORATION) and “ARTON film” (trade name, manufactured by JSR Corporation).

The total light transmittance of the cycloolefin polymer film for use in the optical laminate (II) is usually 70% or more, preferably 85% or more. The total light transmittance can be here measured using an ultraviolet and visible spectrophotometer.

The thickness of the cycloolefin polymer film is preferably in the range of 4 to 200 μm, more preferably 4 to 170 μm, further preferably 20 to 135 μm, still further preferably 20 to 120 μm from the viewpoint of strength, processing suitability, and decreases in thicknesses of a front panel and an image display device using the optical laminate (II).

### (Transparent Conductive Layer)

The transparent conductive layer comprised in the optical laminate (II) of the present invention, when applied to a capacitive touch panel, exerts the effect of making the in-plane potential of the touch panel constant for stabilization of operability. The transparent conductive layer is particularly preferably combined with a conducting surface protection layer described below from the viewpoint of providing the above effect. The transparent conductive layer also has an alternative role for a touch panel which has served as a conductive member in a conventional external type or on-cell type touch panel, in an in-cell touch panel. When an optical laminate having the transparent conductive layer is used for the front surface of a liquid crystal display component on which an in-cell touch panel is mounted, the transparent conductive layer is positioned closer to an operator than the liquid crystal display component, and therefore can allow static electricity generated on a touch panel surface to escape and can prevent a liquid crystal screen from being partially clouded by the static electricity. From such a viewpoint, the transparent conductive layer, even if being decreased in thickness, preferably, can impart a sufficient conductive property, and is less colored, is favorable in transparency, is excellent in weather resistance and is less changed over time in conductive property.

Furthermore, the transparent conductive layer preferably has flexibility from the viewpoint that the tensile elongation rate of the optical laminate (II) is adjusted so as to be within a predetermined range, thereby allowing the close contact property with the cycloolefin polymer film serving as the substrate film to be exhibited. From such a viewpoint, the strain value at the upper yield point in the stress-strain curve obtained by subjecting a laminated article comprising a substrate film and a transparent conductive layer to measurement under conditions of a temperature of 23±2° C. and a tensile speed of 0.5 mm/min with the tensile test method according to JIS K7161-1:2014 is preferably 1.0% or more, more preferably 1.5% or more, further preferably 2.0% or more. The strain value at the upper yield point is preferably 8.0% or less, more preferably 6.0% or less, further preferably 5.0% or less from the viewpoint that in-plane uniformity of surface resistivity of the optical laminate (II) is maintained and from the viewpoint that a reduction in surface protection performance of the surface protection layer serving as an upper layer, due to a too high flexibility, is avoided. The strain value at the upper yield point of the laminated article is here preferably higher than the strain value at the upper yield point of only the cycloolefin polymer film serving as the substrate film. In other words, the strain value at the upper yield point of the transparent conductive layer is preferably higher than the strain value at the upper yield point of the cycloolefin polymer film.

The strain value can be measured using a tensile tester by the method according to JIS K7161-1:2014, and can be specifically measured by a method described in Examples.

The material composing the transparent conductive layer is not particularly limited, and the transparent conductive layer is preferably a cured product of an ionizing radiation curable resin composition comprising an ionizing radiation curable resin and conductive particles. In particular, a cured product of the ionizing radiation curable resin composition comprising an ionizing radiation curable resin (A) having an alicyclic structure in the molecule and conductive particles is more preferable from the viewpoint that the tensile elongation rate of the optical laminate (II) is adjusted within a predetermined range and from the viewpoint that in-plane uniformity and stability over time of surface resistivity, and the close contact property with the cycloolefin polymer film serving as the substrate film are excellent.

The ionizing radiation curable resin composition for transparent conductive layer formation may include an ionizing radiation curable resin (B) other than the ionizing radiation curable resin (A). The ionizing radiation curable resin (B) is preferably used in combination with the ionizing radiation curable resin (A) in that curability and applicability of the resin composition, as well as hardness, weather resistance and the like of a transparent conductive layer formed can be enhanced.

Each component composing the ionizing radiation curable resin composition for transparent conductive layer formation, and a preferable aspect thereof are the same as those described with respect to the transparent conductive layer of the optical laminate (I).

A transparent conductive layer obtained by using the ionizing radiation curable resin composition, even if being decreased in thickness, preferably, can impart a sufficient conductive property, and is less colored, is favorable in transparency, is excellent in weather resistance and is less changed over time in conductive property.

For example, the average value of the surface resistivity of the optical laminate (II) is preferably 1.0×10⁷Ω/ [symbol] or more and 1.0×10¹⁰Ω/ [symbol] or less in an optical laminate for use in a capacitive in-cell touch panel-mounted liquid crystal display device from the viewpoint that a touch panel is stably operated and from the viewpoint that clouding of a liquid crystal screen due to static electricity generated on a touch panel surface in touch with a finger is prevented. The average value of the surface resistivity is preferably in the range of 1.0×10⁸Ω/ [symbol] or more, preferably in the range of 2.0×10⁹Ω/ [symbol] or less, more preferably in the range of 1.5×10⁹Ω/ [symbol] or less, further preferably in the range of 1.0×10⁹Ω/ [symbol] or less from the above viewpoints.

The surface resistivity can be measured by the same method as the method described with respect to the above-mentioned optical laminate (I).

The thickness of the transparent conductive layer is preferably 0.1 to 10 μm, more preferably 0.3 to 5 μm, further preferably 0.3 to 3 μm from the viewpoint that the rate of elongation of the optical laminate is adjusted within a predetermined range and in terms of imparting a desired conductive property without any transparency lost. The thickness of the transparent conductive layer can be measured by the same method as the method described with respect to the above-mentioned optical laminate (I).

### (Surface Protection Layer)

The surface protection layer is preferably a cured product of an ionizing radiation curable resin composition comprising an ionizing radiation curable resin from the viewpoint that the rate of elongation of the optical laminate is adjusted within a predetermined range and from the viewpoint that scratching in a production process of an image display device is prevented.

Each component composing the ionizing radiation curable resin composition and a preferable aspect thereof are the same as those described with respect to the surface protection layer of the optical laminate (I).

The thickness of the surface protection layer can be appropriately selected depending on the application and required properties of the optical laminate (II), and is preferably 0.9 to 40 μm, more preferably 2 to 20 μm, further preferably 2 to 10 μm from the viewpoint that the tensile elongation rate of the optical laminate (II) is adjusted within a predetermined range and from the viewpoint of hardness, processing suitability, and a decrease in thickness of a display device using the optical laminate (II) of the present invention. The thickness of the surface protection layer can be measured by the same method as that with respect to the transparent conductive layer.

The optical laminate (II) may comprise the above-mentioned substrate film, transparent conductive layer and surface protection layer in this order, as in the optical laminate (I), and may also comprise, if necessary, other layer. The optical laminate (II) of the present invention may comprise a rear surface film as a film for a production process, on a surface thereof, the surface closer to the substrate film, as in the optical laminate (I).

### (Method for Producing Optical Laminates (I) and (II))

The method for producing the optical laminates (I) and (II) of the present invention is not particularly limited, and a known method can be used. For example, if an optical laminate of a three-layer configuration comprising the substrate film, the transparent conductive layer and the surface protection layer in this order is intended, the optical laminates (I) and (II) can be each produced by forming the transparent conductive layer on the substrate film by use of the above-mentioned ionizing radiation curable resin composition for transparent conductive layer formation, and forming the surface protection layer thereon. A rear surface film may also be laminated in advance on a surface of the substrate film, the surface being opposite to a surface on which the transparent conductive layer is to be formed.

First, the ionizing radiation curable resin composition for transparent conductive layer formation is prepared by the above-mentioned method, and thereafter the substrate film is coated therewith so that a desired thickness is achieved after curing. The coating method is not particularly limited, and examples include die coating, bar coating, roll coating, slit coating, slit reverse coating, reverse roll coating, and gravure coating. Furthermore, an uncured resin layer is formed on the substrate film by, if necessary, drying.

Next, the uncured resin layer is irradiated with ionizing radiation such as electron beam or ultraviolet light to cure the uncured resin layer, thereby forming the transparent conductive layer. When electron beam is used as the ionizing radiation, the acceleration voltage can be appropriately selected depending on a resin used and the thickness of the layer, and the uncured resin layer is preferably cured usually at an acceleration voltage of about 70 to 300 kV.

When ultraviolet light is used as the ionizing radiation, one including ultraviolet light at a wavelength of 190 to 380 nm is usually radiated. The ultraviolet light source is not particularly limited, and for example, a high pressure mercury lamp, a low pressure mercury lamp, a metal halide lamp, or a carbon arc lamp is used.

The surface protection layer is preferably formed using the above-mentioned ionizing radiation curable resin composition for surface protection layer formation. For example, the ionizing radiation curable resin, and an ultraviolet absorber, current carrying particles and other various additives, if necessary used, are homogeneously mixed at each predetermined proportion, thereby preparing a coating liquid made of the ionizing radiation curable resin composition. The transparent conductive layer can be coated with the coating liquid thus prepared, and the resultant can be, if necessary, dried, and thereafter cured to form a surface protection layer made of the ionizing radiation curable resin composition. The coating method and the curing method of the resin composition are the same as the forming method of the above-mentioned transparent conductive layer.

The optical laminates (I) and (II) can also be produced using the production method according to the fourth invention, described below.

### (Configurations of Optical Laminates (I) and (II))

The optical laminates (I) and (II) of the present invention are here described with reference to FIG. 2. FIG. 2 is a cross-sectional schematic view illustrating one example of embodiments of the optical laminates (I) and (II) of the present invention. An optical laminate 1A illustrated in FIG. 2 comprises a substrate film 2A, a transparent conductive layer 3A and a surface protection layer 4A in this order. The transparent conductive layer 3A is preferably a cured product of the above-mentioned ionizing radiation curable resin composition. The surface protection layer 4A illustrated in FIG. 2 is a conducting surface protection layer comprising current carrying particles 41A.

The optical laminate having the configuration in FIG. 2 is favorable in in-plane uniformity of surface resistivity, and therefore, when used for a capacitive touch panel, can impart stable operability to the touch panel, and is particularly suitably used in an image display device on which an in-cell type touch panel is mounted. As described above, a phenomenon occurs where a liquid crystal screen is clouded due to static electricity generated on a touch panel surface in an in-cell touch panel-mounted liquid crystal display device. The optical laminate of FIG. 2 can be then used for the front surface of an in-cell touch panel-mounted liquid crystal display component, thereby imparting an antistatic function to thereby allow static electricity to escape, thereby preventing the clouding.

In particular, the surface protection layer 4A is preferably a conducting surface protection layer. The current carrying particles 41A in the conducting surface protection layer can make a conduction between the surface of the conducting surface protection layer and the transparent conductive layer 3A, to allow static electricity reaching the transparent conductive layer to further flow in the thickness direction, thereby imparting a desired surface resistivity to the surface (closer to an operator) of the surface protection layer. Furthermore, in-plane uniformity and stability over time of surface resistivity become favorable, and operability of a capacitive touch panel is stably exhibited.

While the transparent conductive layer has the conductive property in the plane direction (X direction, Y direction) and in the thickness direction (z direction), the conducting surface protection layer may have the conductive property only in the thickness direction. Accordingly, the conducting surface protection layer differs in role in that the conductive property in the plane direction is not necessarily needed.

### [Third Invention: Optical Laminate (III)]

The optical laminate (III) of the present invention according to the third invention comprises a cellulose-based substrate film, a stabilization layer and a conductive layer in this order, wherein the average value of a surface resistivity measured according to JIS K6911 is in the range of 1.0×10⁷Ω/ [symbol] or more and 1.0×10¹²Ω/ [symbol] or less, and the value obtained by dividing the standard deviation σ of the surface resistivity by the average value is 0.20 or less.

The “stabilization layer” in the third invention means a layer having a function of stabilizing in-plane uniformity of surface resistivity of the optical laminate (III), and the detail thereof will be described below. When comprising the stabilization layer, the optical laminate (III) of the present invention can be high in in-plane uniformity of surface resistivity even in use of a cellulose-based substrate film as the substrate film, and can exhibit stable operability when used for a capacitive touch panel.

The average value of the surface resistivity is 1.0×10⁷Ω/ [symbol] or more, and is preferably 5.0×10¹¹Ω/ [symbol] or less, more preferably 1.0×10¹¹Ω/ [symbol] or less, further preferably 5.0×10¹⁰Ω/ [symbol] or less from the viewpoint of operability and operating accuracy in use of the optical laminate (III) for a capacitive touch panel.

If the value obtained by dividing the standard deviation σ of the surface resistivity of the optical laminate (III) by the average value ([standard deviation σ of surface resistivity]/[average value of surface resistivity]) is more than 0.20, the variability in surface resistivity in the plane is large to cause a reduction in operability in use of the optical laminate (III) for a capacitive touch panel. From such a viewpoint, the [standard deviation σ of surface resistivity]/[average value of surface resistivity] is preferably 0.18 or less, more preferably 0.15 or less.

The average value of the surface resistivity of the optical laminate (III) is 1.0×10⁷Ω/ [symbol] or more and 1.0×10¹²Ω/ [symbol] or less, and such a range allows operability in use of the optical laminate (III) for a capacitive touch panel to be favorable. When the average value of the surface resistivity is 1.0×10⁷Ω/ [symbol] or more and 1.0×10¹⁰Ω/ [symbol] or less, operating accuracy in a touch panel operation is favorable, and when the average value is more than 1.0×10¹⁰Ω/ [symbol] and 1.0×10¹²Ω/ [symbol] or less, sensitivity in a touch panel operation becomes favorable.

The surface resistivity is measured according to JIS K6911:1995, and the average value and the standard deviation thereof can be measure by, for example, the method A described in the optical laminate (I).

It is preferable from the viewpoint of the stability over time of the surface resistivity that the ratio of the surface resistivity measured after retention of the optical laminate (III) at 80° C. for 250 hours to the surface resistivity before the retention, (surface resistivity after retention of optical laminate (III) at 80° C. for 250 hours/surface resistivity before retention of optical laminate (III) at 80° C. for 250 hours), be in the range of 0.40 to 2.5 at every measurement point. The ratio is more preferably in the range of 0.50 to 2.0. The surface resistivity ratio can be specifically measured by a method described in Examples.

When the surface resistivity ratio is in the above range, the optical laminate (III) can be less changed in the surface resistivity due to the environmental change, thereby maintaining stable operability for a long period of time when used for a capacitive touch panel.

Examples of the method for adjusting the average value and the variability in the surface resistivity of the optical laminate (III) within the above ranges include (1) selection of the material for use in stabilization layer formation and the thickness, (2) selection of the material for use in conductive layer formation and the thickness, and (3) application of a specific layer configuration. These will be described below.

### (Cellulose-Based Substrate Film)

The substrate film for use in the optical laminate (III) is a cellulose-based substrate film. The total light transmittance of the cellulose-based substrate film is usually 70% or more, preferably 85% or more. The total light transmittance can be herein measured using an ultraviolet and visible spectrophotometer at room temperature in the air.

The cellulose-based substrate film is preferably a cellulose ester film in that a light transmission property is excellent, and examples include a triacetyl cellulose film (TAC film) and a diacetyl cellulose film. Among them, a triacetyl cellulose film is preferable in that it is excellent in light transmission property and low in refractive index anisotropy.

The triacetyl cellulose film may not only be a pure triacetyl cellulose film, but also a film of cellulose acetate propionate, cellulose acetate butyrate or the like, where cellulose and a component other than acetic acid as a fatty acid for forming an ester are used in combination.

The cellulose-based substrate film may also be uniaxially or biaxially oriented.

The cellulose-based substrate film is preferable in that it is excellent in optical properties and has the above penetrability.

If the substrate film for use in the optical laminate and a layer adjacent thereto are different in refractive index, the interface reflection derived from the interface therebetween, or the interference fringe may usually occur. If an optical laminate having such difference is applied to an image display device, image visibility may be reduced. In the case where a stabilization layer is formed on a penetrable substrate such as a cellulose-based substrate film, however, the cellulose-based substrate film is impregnated with a solvent and a low molecular weight component in a resin composition for stabilization layer formation when coated with the composition. The composition is cured in such a state to thereby form a penetration layer in the vicinity of the interface between the substrate film and the stabilization layer, thereby making the interface unclear. As a result, the effect of being capable of decreasing the interface reflection and the interference fringe derived therefrom is exerted even when the substrate film and the stabilization layer are made of respective materials different in refractive index.

The cellulose-based substrate film for use in the optical laminate (III) can contain additives such as an antioxidant, a heat stabilizer, a light stabilizer, an ultraviolet absorber, a lubricant, a plasticizer, and a colorant to the extent that the effect of the present invention is not impaired. Among them, a cellulose-based substrate film preferably contains an ultraviolet absorber. The reason is because the substrate film contains an ultraviolet absorber to thereby exert the effect of preventing degradation due to ultraviolet light as light from outside.

The ultraviolet absorber is not particularly limited, and a known ultraviolet absorber can be used. Examples include a benzophenone-based compound, a benzotriazole-based compound, a triazine-based compound, a benzoxazine-based compound, a salicylic acid ester-based compound, and a cyanoacrylate-based compound. Among them, a benzotriazole-based compound is preferable from the viewpoint of weather resistance and color tone. The ultraviolet absorber can be used singly or in combinations of two or more kinds thereof.

The content of the ultraviolet absorber in the cellulose-based substrate film is preferably 0.1 to 10% by mass, more preferably 0.5 to 5% by mass, further preferably 1 to 5% by mass. When the content of the ultraviolet absorber is in the above range, the transmittance at a wavelength of 380 nm, of the optical laminate (III), can be suppressed to 30% or less, and yellow tinge due to inclusion of the ultraviolet absorber can be suppressed.

The thickness of the cellulose-based substrate film is preferably in the range of 4 to 200 μm, more preferably 4 to 170 μm, further preferably 20 to 135 μm, still further preferably 20 to 100 μm from the viewpoint of strength, processing suitability, and decreases in thicknesses of a front panel and an image display device using the optical laminate (III).

### (Stabilization Layer)

The stabilization layer comprised in the optical laminate (III) means a layer having a function of stabilizing in-plane uniformity of surface resistivity of the optical laminate (III). When comprising the stabilization layer, the optical laminate (III) can be high in in-plane uniformity of surface resistivity even in use of the cellulose-based substrate film, and can exhibit stable operability when used for a capacitive touch panel.

The reason why the stabilization layer exerts the above effect is considered as follows. The cellulose-based substrate film has penetrability, and therefore, if a conductive layer is to be formed thereon by using a material comprising a solvent, other low molecular weight component having a molecular weight of less than 1,000, and a conductive agent (conductive particles or the like described below), the following problem occurs: the thickness of the conductive layer is not stable, or the respective components in the material for conductive layer formation penetrate into the substrate film, not to impart the required conductive property and its in-plane uniformity is caused. If the stabilization layer is formed on the cellulose-based substrate film, however, the respective components in the material for conductive layer formation are inhibited from penetrating into the substrate film in coating with the material. As a result, the conductive particles in the conductive layer formed on the stabilization layer is not scattered and can be localized, and thus it is considered that an objective conductive property can be achieved and the variability in surface resistivity can also be suppressed. Moreover, stability of the surface resistivity after storage of the resulting optical laminate under a high-temperature environment also becomes favorable.

The stabilization layer is preferably a cured product of an ionizing radiation curable resin composition comprising an ionizing radiation curable resin from the viewpoint of imparting the above properties. When the stabilization layer is a cured product of the ionizing radiation curable resin composition, penetration of the material for conductive layer formation into the cellulose-based substrate film can be effectively suppressed. Therefore, an optical laminate (III) comprising the stabilization layer can achieve an objective conductive property even in use of the cellulose-based substrate film, and can also be higher in in-plane uniformity of surface resistivity. Furthermore, when the cellulose-based substrate film is coated with an ionizing radiation curable resin composition for stabilization layer formation, a low molecular weight component in the resin composition penetrates into the substrate film. The resin composition is cured in such a state to form the stabilization layer, thereby also making the close contact property of the cellulose-based substrate film with the stabilization layer favorable.

### <Ionizing Radiation Curable Resin>

The ionizing radiation curable resin contained in the ionizing radiation curable resin composition for stabilization layer formation, which can be used, is appropriately selected from the group consisting of a polymerizable monomer and a polymerizable oligomer or prepolymer which are commonly used. Among them, a polymerizable monomer and/or a polymerizable oligomer are/is preferable as the ionizing radiation curable resin, and a polymerizable monomer having a molecular weight of less than 1,000 is more preferable from the viewpoint that penetration of the material for conductive layer formation into the cellulose-based substrate film is suppressed and the close contact property of the stabilization layer with the cellulose-based substrate film is enhanced.

The polymerizable monomer is suitably a (meth)acrylate monomer having a (meth)acryloyl group in the molecule, and in particular, is preferably a polyfunctional (meth)acrylate monomer.

The polyfunctional (meth)acrylate monomer may be a (meth)acrylate monomer having two or more (meth)acryloyl groups in the molecule, and is not particularly limited. Specific examples preferably include di(meth)acrylates such as ethylene glycol di(meth)acrylate, propylene glycol di(meth)acrylate, pentaerythritol di(meth)acrylate monostearate, dicyclopentanyl di(meth)acrylate and isocyanurate di(meth)acrylate; tri(meth)acrylates such as trimethylolpropane tri(meth)acrylate, pentaerythritol tri(meth)acrylate and tris(acryloxyethyl) isocyanurate; tetra- or higher functional (meth)acrylates such as pentaerythritol tetra(meth)acrylate, dipentaerythritol tetra(meth)acrylate, dipentaerythritol penta(meth)acrylate and dipentaerythritol hexa(meth)acrylate; and ethylene oxide-modified products, propylene oxide modified products, caprolactone-modified products, and propionic acid-modified products of the above-mentioned polyfunctional (meth)acrylate monomers. Among them, polyfunctional one as compared with tri(meth)acrylate, namely, tri- or higher functional (meth)acrylate is preferable from the viewpoint that an excellent hardness is achieved, and at least one selected from the group consisting of trimethylolpropane tri(meth)acrylate and pentaerythritol tri(meth)acrylate is more preferable from the viewpoint of suppression of penetration of the material for conductive layer formation into the cellulose-based substrate film and an enhancement in the close contact property of the stabilization layer with the cellulose-based substrate film. Such polyfunctional (meth)acrylate monomers may be used singly or in combinations of two or more kinds thereof.

Examples of the polymerizable oligomer preferably include an oligomer bearing a radical polymerizable functional group in the molecule, for example, epoxy (meth)acrylate-based, urethane (meth)acrylate-based, polyester (meth)acrylate-based, and polyether (meth)acrylate-based oligomers. Furthermore, examples of the polymerizable oligomer preferably also include a polybutadiene (meth)acrylate-based oligomer bearing a (meth)acrylate group in a side chain of a polybutadiene oligomer and having high hydrophobicity, and a silicone (meth)acrylate-based oligomer bearing a polysiloxane bond in the main chain. Such oligomers may be used singly or in combinations of two or more kinds thereof.

The weight average molecular weight (weight average molecular weight in terms of standard polystyrene, as measured by the GPC method) of the polymerizable oligomer is preferably 1,000 to 20,000, more preferably 1,000 to 15,000.

The polymerizable oligomer is preferably bi- or higher functional, more preferably tri- to dodecafunctional, further preferably tri- to decafunctional. When the number of functional groups is in the above range, the resulting stabilization layer can effectively suppress penetration of the material for conductive layer formation into the cellulose-based substrate film.

The ionizing radiation curable resin composition can also further comprise a thermoplastic resin. The thermoplastic resin can be used in combination to thereby enhance adhesiveness to the substrate film and effectually prevent defects on a coating film.

Examples of the thermoplastic resin preferably include simple thermoplastic resins such as a styrene resin, a (meth)acrylic resin, a polyolefin resin, a vinyl acetate resin, a vinyl ether resin, a halogen containing resin, a polycarbonate resin, a polyester resin, a polyamide resin, nylon, a cellulose resin, a silicone resin and a polyurethane resin, and copolymers thereof, or mixed resins thereof. These resins are preferably non-crystalline and soluble in the solvent. In particular, a styrene resin, a (meth)acrylic resin, a polyolefin resin, a polyester resin, a cellulose resin, and the like are preferable, a (meth)acrylic resin is more preferable, and polymethyl methacrylate is further preferable from the viewpoint of film formability, transparency, weather resistance, and the like.

These thermoplastic resins preferably have no reactive functional group in the molecule. The reason is because an increase in the amount of cure shrinkage and a reduction in adhesiveness of the stabilization layer caused by having a reactive functional group in the molecule can be avoided. In addition, if the thermoplastic resin has no reactive functional group in the molecule, control of the surface resistivity of the resulting optical laminate is facilitated. Herein, examples of the reactive group include functional groups having an unsaturated double bond, such as an acryloyl group and a vinyl group, cyclic ether groups such as an epoxy ring and an oxetane ring, ring-opening polymerization groups such as a lactone ring, and isocyanate groups for forming urethane. Herein, such a reactive functional group may be contained as long as it does not have any effect on adhesiveness of the stabilization layer and the surface resistivity.

The content of the ionizing radiation curable resin in the ionizing radiation curable resin composition for stabilization layer formation is preferably 20% by mass or more, more preferably 20 to 95% by mass, further preferably 25 to 85% by mass, still further preferably 30 to 80% by mass relative to the total amount of the resin components composing the resin composition. When the content of the ionizing radiation curable resin is 20% by mass or more relative to the total amount of the resin components composing the resin composition, a stabilization layer excellent in close contact property and less in penetration of the low molecular weight component can be formed. “The resin components in the ionizing radiation curable resin composition” herein used encompass the ionizing radiation curable resin, the thermoplastic resin, and other resin.

When the ionizing radiation curable resin composition comprises the thermoplastic resin, the content is preferably 10% by mass or more in the resin components in the ionizing radiation curable resin composition. The content is preferably 80% by mass or less, more preferably 50% by mass or less from the viewpoint of the close contact property of the resulting stabilization layer with the substrate film. The ionizing radiation curable resin composition for stabilization layer formation preferably comprises no thermoplastic resin from the viewpoint that penetration of the material for conductive layer formation into the cellulose-based substrate film is effectively suppressed.

When the ionizing radiation curable resin for use in formation of the stabilization layer is an ultraviolet light curable resin, the ionizing radiation curable resin composition for stabilization layer formation preferably comprises a photopolymerization initiator and/or a photopolymerization accelerator.

Examples of the photopolymerization initiator include acetophenone, α-hydroxyalkylphenone, acylphosphine oxide, benzophenone, Michler's ketone, benzoin, benzyl dimethyl ketal, benzoyl benzoate, α-acyloxime ester, and thioxanthones. The photopolymerization accelerator can reduce a polymerization obstacle due to air in curing and increase the curing rate, and examples include p-dimethylaminobenzoic acid isoamyl ester and p-dimethylaminobenzoic acid ethyl ester.

The photopolymerization initiator and the photopolymerization accelerator can be each used singly or in combinations of two or more kinds thereof.

When the ionizing radiation curable resin composition for stabilization layer formation comprises the photopolymerization initiator, the content is preferably 0.1 to 10 parts by mass, more preferably 1 to 10 parts by mass, further preferably 5 to 10 parts by mass relative to 100 parts by mass of the ionizing radiation curable resin.

The ionizing radiation curable resin composition for stabilization layer formation can further contain, if necessary, other components, for example, additives such as a refractive index adjusting agent, an anti-glare agent, an antifouling agent, an ultraviolet absorber, an antioxidant, a leveling agent, and a lubricant.

Furthermore, the resin composition can contain a solvent. Any solvent can be used as such a solvent without any particular limitation as long as it dissolves each component contained in the resin composition, and is preferably ketones, ethers, alcohols or esters. The solvent can be used singly or in combinations of two or more kinds thereof.

The content of the solvent in the resin composition is usually 20 to 99% by mass, preferably 30 to 99% by mass, more preferably 70 to 99% by mass. When the content of the solvent is in the above range, applicability is excellent.

The method for producing the ionizing radiation curable resin composition for stabilization layer formation is not particularly limited, and can be produced by using conventionally known method and device. For example, the ionizing radiation curable resin composition can be produced by adding and mixing the ionizing radiation curable resin, and, if necessary, various additives and a solvent.

The thickness of the stabilization layer is preferably 50 nm or more, more preferably 70 nm or more, further preferably 90 nm or more, still further preferably 200 nm or more in that the above-mentioned effect is exerted to thereby obtain the in-plane uniformity of surface resistivity of the optical laminate (III). The thickness is preferably less than 10 μm, more preferably 8.0 μm or less, further preferably 5.0 μm or less from the viewpoint that warpage of the optical laminate (III) is suppressed.

The thickness of the stabilization layer can be calculated by, for example, measuring the thickness at 20 points in an image of a cross section, taken by using a scanning transmission electron microscope (STEM), and calculating the average value of the values at such 20 points. The acceleration voltage in STEM is preferably 10 kV to 30 kV, and the observation magnification in STEM is preferably 1000 to 7000 times.

### (Conductive Layer)

The conductive layer comprised in the optical laminate (III), when applied to a capacitive touch panel, exerts the effect of making the in-plane potential of the touch panel constant for stabilization of operability. The conductive layer also has an alternative role for a touch panel which has served as a conductive member in a conventional external type or on-cell type touch panel, in an in-cell touch panel. When an optical laminate having the conductive layer is used for the front surface of a liquid crystal display component on which an in-cell touch panel is mounted, the conductive layer is positioned closer to an operator than the liquid crystal display component, and therefore can allow static electricity generated on a touch panel surface to escape and can prevent a liquid crystal screen from being partially clouded by the static electricity. From such a viewpoint, the conductive layer, even if being decreased in thickness, preferably, can impart a sufficient conductive property, and is less colored, is favorable in transparency, is excellent in weather resistance and is less changed over time in conductive property.

The material composing the conductive layer is not particularly limited, and is preferably a cured product of an ionizing radiation curable resin composition comprising an ionizing radiation curable resin and conductive particles from the viewpoint that the properties are imparted. The reason is also because, when a functional layer described below is not laminated on the conductive layer, it is desirable to impart a hardness to such an extent that scratching of a front panel or an image display device in a production process can be prevented.

### <Ionizing Radiation Curable Resin>

The Ionizing Radiation Curable Resin Contained in the Ionizing Radiation curable resin composition for conductive layer formation, which can be used, is appropriately selected from the group consisting of a polymerizable monomer and a polymerizable oligomer or prepolymer which are commonly used.

The polymerizable monomer is suitably a (meth)acrylate monomer having a (meth)acryloyl group in the molecule, and in particular, is preferably a polyfunctional (meth)acrylate monomer.

The polyfunctional (meth)acrylate monomer and a preferable aspect thereof are the same as those exemplified in the above-mentioned ionizing radiation curable resin composition for stabilization layer formation. The polyfunctional (meth)acrylate monomer may be used singly or in combinations of two or more kinds thereof.

The polymerizable oligomer and a preferable aspect thereof are the same as those exemplified in the above-mentioned ionizing radiation curable resin composition for stabilization layer formation.

The polymerizable oligomer preferably has a weight average molecular weight of 1,000 to 20,000, more preferably 1,000 to 15,000.

The polymerizable oligomer is preferably bi- or higher functional, more preferably tri- to dodecafunctional, further preferably tri- to decafunctional. When the number of functional groups is in the above range, a conductive layer excellent in hardness is obtained.

The ionizing radiation curable resin contained in the ionizing radiation curable resin composition for conductive layer formation is more preferably small in the refractive index difference from that of the ionizing radiation curable resin contained in the ionizing radiation curable resin composition for stabilization layer formation, and both the ionizing radiation curable resins are preferably of the same type from the above viewpoint. The occurrence of the interference fringe derived from the interface reflection between the stabilization layer and the conductive layer can be reduced in this case, thereby resulting in an enhancement in image visibility. The reason is because, if the refractive index of a stabilization layer formed is close to that of the conductive layer, the interference fringe derived from a clear interface between the stabilization layer and the conductive layer hardly occurs even when such an interface is present. The reason is also considered because, when the respective ionizing radiation curable resins for use in the stabilization layer and the conductive layer are of the same type, the ionizing radiation curable resin composition for conductive layer formation is easily wetted into the stabilization layer surface in formation of the conductive layer on the stabilization layer and slight roughness is generated on the interface between the stabilization layer and the conductive layer while not having any effect on the layer thickness and not causing any interference fringe. Furthermore, when the respective ionizing radiation curable resins for use in the stabilization layer and the conductive layer are of the same type, the effect of making the close contact property of the stabilization layer with the conductive layer favorable is also exerted.

Respective ionizing radiation curable resins being of the same type here used means that these resins are the same resins when one ionizing radiation curable resin is used, and that these resins are each a combination of the same resins when two or more ionizing radiation curable resins are used.

The ionizing radiation curable resin composition can also further comprise a thermoplastic resin. The thermoplastic resin can be used in combination, thereby suppressing shrinkage of the conductive layer to thereby enhance adhesiveness to the stabilization layer, the permanent close contact property, and in-plane uniformity of surface resistivity, suppress the change over time in surface resistivity, and effectually prevent defects on a coating film.

The thermoplastic resin and a preferable aspect thereof are the same as those exemplified in the above-mentioned ionizing radiation curable resin composition for stabilization layer formation.

The content of the ionizing radiation curable resin in the ionizing radiation curable resin composition for conductive layer formation is preferably 20% by mass or more, more preferably 30 to 100% by mass, further preferably 40 to 100% by mass, still further preferably 50 to 100% by mass relative to the total amount of the resin components composing the resin composition. When the content of the ionizing radiation curable resin is 20% by mass or more relative to the total amount of the resin components composing the resin composition, a conductive layer excellent in close contact property and also excellent in in-plane uniformity and stability over time of surface resistivity can be formed.

When the ionizing radiation curable resin composition comprises the thermoplastic resin, the content is preferably 10% by mass or more in the resin components in the ionizing radiation curable resin composition. The content is preferably 80% by mass or less, more preferably 50% by mass or less from the viewpoint of scratch resistance of the resulting conductive layer.

### <Conductive Particle>

The conductive particle is used to impart a conductive property to the conductive layer formed using the ionizing radiation curable resin composition, without any transparency lost. Accordingly, the conductive particle is preferably one that can impart a sufficient conductive property even if the thickness of the transparent conductive layer is decreased, and that is less colored, is favorable in transparency, is excellent in weather resistance and is less changed over time in conductive property. A particle high in hardness is also preferable from the viewpoint of avoiding a reduction in surface protection performance due to a too high flexibility of the conductive layer.

As such a conductive particle, a metal particle, a metal oxide particle, a coating particle where a conductive covering layer is formed on the surface of a core particle, and the like are suitably used.

Examples of the metal composing the metal particle include Au, Ag, Cu, Al, Fe, Ni, Pd, and Pt. Examples of the metal oxide composing the metal oxide particle include tin oxide (SnO₂), antimony oxide (Sb₂O₅), antimony tin oxide (ATO), indium tin oxide (ITO), aluminum zinc oxide (AZO), fluorinated tin oxide (FTO) and ZnO.

Examples of the coating particle include a particle where a conductive covering layer is formed on the surface of a core particle. The core particle is not particularly limited, and examples include inorganic particles such as a colloidal silica particle and a silicon oxide particle, polymer particles such as a fluororesin particle, an acrylic resin particle and a silicone resin particle, and organic-inorganic composite particles. Examples of the material composing the conductive covering layer include metals described above or alloys thereof, and metal oxides described above. These can be used singly or in combinations of two or more kinds thereof.

Among them, the conductive particle is preferably at least one selected from the group consisting of a metal fine particle and a metal oxide fine particle, and an antimony tin oxide (ATO) particle is more preferable, from the viewpoint that long-term storage, heat resistance, moist heat resistance, and weather resistance are favorable.

The average primary particle size of the conductive particle is preferably 5 to 40 nm. When the average primary particle size is 5 nm or more, the conductive particle can be easily in contact with each other in the conductive layer, thereby allowing for a decrease in the amount of the conductive particles added for imparting a sufficient conductive property. Furthermore, when the average primary particle size of the conductive particle is 5 nm or more, excessive penetration of the conductive particles into the cellulose-based substrate film can be avoided. In addition, when the average primary particle size is 40 nm or less, transparency, and the close contact property with other layer can be prevented from being impaired. A more preferable lower limit of the average primary particle size of the conductive particle is 6 nm, and a more preferable upper limit thereof is 20 nm.

The average primary particle size of the conductive particle can be measured by the same method as the method for measuring the average primary particle size of the conductive particle described with respect to the optical laminate (I).

A conductive layer obtained by using the ionizing radiation curable resin composition, even if being decreased in thickness, preferably can impart a sufficient conductive property, and is less colored, is favorable in transparency, is excellent in weather resistance and is less changed over time in conductive property. Accordingly, the content of the conductive particles in the resin composition is not particularly limited as long as the above performances can be imparted.

The content of the conductive particles in the ionizing radiation curable resin composition is preferably 5 to 400 parts by mass, more preferably 20 to 300 parts by mass, further preferably 25 to 200 parts by mass relative to 100 parts by mass of the ionizing radiation curable resin, from the viewpoint that the average value of the surface resistivity is set to 1.0×10⁷Ω/ [symbol] or more and 1.0×10¹²Ω/ [symbol] or less. The reason is because when the content of the conductive particles is set to 5 parts by mass or more relative to 100 parts by mass of the ionizing radiation curable resin, the average value of the surface resistivity of the optical laminate is easily set to 1.0×10¹²Ω/ [symbol] or less, and when the content is set to 400 parts by mass or less, not only is the average value of the surface resistivity easily set to 1.0×10⁷Ω/ [symbol] or more, but also the conductive layer is not brittle and hardness can be maintained.

The conductive layer may further comprise the current carrying particles from the viewpoint of enhancing in in-plane uniformity of surface resistivity.

When the conductive layer is a layer comprising current carrying particles, the conductive layer or a conductive layer adjacent thereto is positioned on the outermost surface in a front panel where the optical laminate (III) of the present invention, a polarizer and a phase difference film are laminated in this order, and therefore a grounding treatment from the surface of such a layer can be easily performed. Even in the case of a low surface resistivity, in-plane uniformity of surface resistivity is favorable and surface resistivity is also easily stabilized over time.

The optical laminate (III) has an average value of the surface resistivity, of 1.0×10⁷Ω/ [symbol] or more and 1.0×10¹²Ω/ [symbol] or less, as described above, and is very low in conductive property as compared with a transparent conductive layer for a touch panel sensor (electrode). Such in-plane uniformity is difficult to realize in such a low conductive property range. The above configuration, however, allows the surface resistivity to easily achieve a high in plane uniformity.

The current carrying particle is not particularly limited, and examples include a metal particle, a metal oxide particle, and a coating particle where a conductive covering layer is formed on the surface of a core particle, as in the above-mentioned conductive particle. The current carrying particle is preferably a gold-plated particle from the viewpoint of making conduction favorable.

The average primary particle size of the current carrying particle can be appropriately selected depending on the thickness of the conductive layer. Specifically, the average primary particle size of the current carrying particle is preferably more than 50% and 150% or less, more preferably more than 70% and 120% or less, further preferably more than 85% and 115% or less relative to the thickness of the conductive layer. The average primary particle size of the current carrying particle relative to the thickness of the conductive layer can be as described above, thereby making conduction favorable and preventing the current carrying particle from being dropped from the conductive layer.

The average primary particle size of the current carrying particle in the conductive layer can be measured by the same method as the method for measuring the average primary particle size of the current carrying particle, described with respect to the optical laminate (I).

When the conductive layer comprises the current carrying particles, the content is preferably 0.5 to 4.0 parts by mass, more preferably 0.5 to 2.5 parts by mass relative to 100 parts by mass of the ionizing radiation curable resin in the ionizing radiation curable resin composition composing the conductive layer. When the content of the current carrying particles is 0.5 parts by mass or more, conduction can be favorable. When the content is 4.0 parts by mass or less, reductions in formability and hardness of the conductive layer can be prevented.

When the ionizing radiation curable resin for use in formation of the conductive layer is an ultraviolet light curable resin, the ionizing radiation curable resin composition for conductive layer formation preferably comprises a photopolymerization initiator and/or a photopolymerization accelerator. The photopolymerization initiator, the photopolymerization accelerator, and preferable aspects thereof are the same as those exemplified in the above-mentioned ionizing radiation curable resin composition for stabilization layer formation.

The photopolymerization initiator and the photopolymerization accelerator can be each used singly or in combinations of two or more kinds thereof.

When the ionizing radiation curable resin composition for conductive layer formation comprises the photopolymerization initiator, the content is preferably 0.1 to 10 parts by mass, more preferably 1 to 10 parts by mass, further preferably 1 to 8 parts by mass relative to 100 parts by mass of the ionizing radiation curable resin.

The ionizing radiation curable resin composition for conductive layer formation can further contain, if necessary, other components, for example, additives such as a refractive index adjusting agent, an anti-glare agent, an antifouling agent, an ultraviolet absorber, an antioxidant, a leveling agent, and a lubricant.

Furthermore, the resin composition can contain a solvent. Any solvent can be used as such a solvent without any particular limitation as long as it dissolves each component contained in the resin composition, and is preferably ketones, ethers, alcohols or esters. The solvent can be used singly or in combinations of two or more kinds thereof.

The solvent contained in the ionizing radiation curable resin composition for conductive layer formation and the solvent contained in the ionizing radiation curable resin composition for stabilization layer formation are preferably of the same type. The occurrence of the interference fringe derived from the interface reflection between the stabilization layer and the conductive layer can be reduced in this case, thereby resulting in an enhancement in image visibility. The reason is considered because the solvent in the ionizing radiation curable resin composition for conductive layer formation is easily wetted into the stabilization layer surface in lamination of the conductive layer on the stabilization layer and slight roughness is generated on the interface between the stabilization layer and the conductive layer while not having any effect on the layer thickness and not causing any interference fringe.

Solvents being of the same type here used means that these solvents are the same solvents when one solvent is used, and that these solvents are each a combination of the same solvents when two or more solvents are used.

The content of the solvent in the resin composition is usually 20 to 99% by mass, preferably 30 to 99% by mass, more preferably 70 to 99% by mass. When the content of the solvent is in the above range, applicability is excellent.

The method for producing the ionizing radiation curable resin composition for conductive layer formation is not particularly limited, and can be produced by using conventionally known method and device. For example, the ionizing radiation curable resin composition can be produced by adding and mixing the ionizing radiation curable resin, the conductive particles, and, if necessary, various additives and the solvent. The conductive particles may be used in the form of a dispersion prepared by dispersing the conductive particles in the solvent in advance.

The thickness of the conductive layer is preferably 0.5 to 20 μm, more preferably 1.0 to 10 μm, further preferably 1.0 to 5.0 μm in terms of imparting a desired conductive property without any transparency lost and from the viewpoint that scratching of a front panel or an image display device in a production process is prevented in the case of not providing any functional layer described below.

The thickness of the conductive layer can be measured by the same method as that of the thickness of the stabilization layer.

### (Functional Layer)

The optical laminate (III) may comprise a functional layer on or under the conductive layer. Examples of the functional layer include a surface protection layer, an antireflection layer, a refractive index adjustment layer, an anti-glare layer, a fingerprint-resistant layer, an antifouling layer, a scratch-resistant layer, and an antimicrobial layer. Such a functional layer, when provided on the outermost surface of the optical laminate (III), is preferably a cured product of a thermosetting resin composition or an ionizing radiation curable resin composition, more preferably a cured product of an ionizing radiation curable resin composition from the viewpoint that scratching of a front panel or an image display device in a production process is prevented.

The ionizing radiation curable resin composition that can be used is the same as the above-mentioned ionizing radiation curable resin composition for stabilization layer formation.

A layer containing additive(s) such as an antioxidant, a heat stabilizer, a light stabilizer, an ultraviolet absorber, a lubricant, a plasticizer, and a colorant, other than the above layers, can also be provided as the functional layer to the extent that the effect of the present invention is not impaired. Furthermore, when the optical laminate is applied to a liquid crystal display device, a high retardation layer can also be provided for the purpose of preventing difficulty in vision and coloration unevenness caused in viewing of a liquid crystal display screen with polarized sunglasses being worn. If a layer having a ¼ wavelength phase difference function is present, however, the high retardation layer is not needed.

When the functional layer is provided on the conductive layer, the conductive layer may further comprise current carrying particles. When the functional layer is a functional layer comprising current carrying particles (hereinafter, also referred to as “conducting functional layer”), the conducting functional layer and the conductive layer are positioned on the outermost surface in a front panel where the optical laminate (III) of the present invention, a polarizer and a phase difference film are laminated in this order, and therefore a grounding treatment to the surface of the conducting functional layer or the conductive layer can be easily performed. The optical laminate (III) comprises the conductive layer and the conducting functional layer, thereby allowing in-plane uniformity of surface resistivity to be favorable and also stabilizing the surface resistivity over time even if the conductive property of the conductive layer is low.

Examples of the current carrying particle for use in the functional layer include the same as described above. The average primary particle size of the current carrying particle can be appropriately selected depending on the thickness of the functional layer. Specifically, the average primary particle size of the current carrying particle is preferably more than 50% and 150% or less, more preferably more than 70% and 120% or less, further preferably more than 85% and 115% or less relative to the thickness of the functional layer. The average primary particle size of the current carrying particle relative to the thickness of the functional layer can be as described above, thereby making conduction from the conductive layer favorable and preventing the current carrying particles from being dropped from the functional layer.

The content of the current carrying particles in the functional layer is preferably 0.5 to 4.0 parts by mass, more preferably 0.5 to 3.0 parts by mass relative to 100 parts by mass of the ionizing radiation curable resin in the ionizing radiation curable resin composition composing the functional layer. When the content of the current carrying particles is 0.5 parts by mass or more, conduction from the conductive layer can be favorable. When the content is 4.0 parts by mass or less, reductions in formability and hardness of the functional layer can be prevented.

The thickness of the functional layer can be appropriately selected depending on the application and required properties of the optical laminate, and is preferably 0.05 to 30 μm, more preferably 0.1 to 20 μm, further preferably 0.5 to 10 μm from the viewpoint of hardness, processing suitability, and a decrease in thickness of a display device using the optical laminate (III) of the present invention. The thickness is not limited thereto when the functional layer is the above-mentioned high retardation layer, and the thickness may be any thickness such that a preferable retardation is achieved. The thickness of the functional layer can be measured by the same method as that with respect to the conductive layer.

The optical laminate (III) may comprise a rear surface film as a film for a production process, on a surface thereof, the surface closer to the substrate film. Thus, flatness can be maintained and in-plane uniformity of surface resistivity can be kept in production and processing of the optical laminate (III). The rear surface film is not particularly limited, and a polyester-based resin film, a polyolefin-based resin film, or the like can be used. A film high in elastic modulus is preferable and a polyester-based resin film is more preferable in terms of protection performance.

The thickness of the rear surface film is preferably 10 μm or more, more preferably 20 to 200 μm from the viewpoint that flatness is maintained in production and processing of the optical laminate (III).

The rear surface film is laminated on, for example, a surface of the optical laminate (III), the surface being closer to the substrate film, with a pressure-sensitive adhesion layer being interposed therebetween. The rear surface film is here a film for a production process, and therefore is peeled in, for example, bonding of the optical laminate (III) to a polarizer described below.

### (Method for Producing Optical Laminate (III))

The method for producing the optical laminate (III) is not particularly limited, and a known method can be used. For example, if an optical laminate of a three-layer configuration comprising the cellulose-based substrate film, the stabilization layer and the conductive layer in this order is intended, the optical laminate (III) can be produced by forming the above-mentioned stabilization layer on the substrate film, and forming the conductive layer thereon by use of the above-mentioned ionizing radiation curable resin composition for conductive layer formation. A rear surface film may also be laminated in advance on a surface of the cellulose-based substrate film, the surface being opposite to a surface on which the conductive layer is to be formed.

First, the ionizing radiation curable resin composition for stabilization layer formation is prepared by the above-mentioned method, and thereafter coating therewith is made so that a desired thickness is achieved after curing, thereby forming an uncured resin layer by, if necessary, drying. The coating method is not particularly limited, and examples include die coating, bar coating, roll coating, slit coating, slit reverse coating, reverse roll coating, and gravure coating. The uncured resin layer is irradiated with ionizing radiation such as electron beam or ultraviolet light to cure the uncured resin layer, thereby forming the stabilization layer on the substrate film. When electron beam is used as the ionizing radiation, the acceleration voltage can be appropriately selected depending on the kind of a resin used and the thickness of the layer, and the uncured resin layer is preferably cured usually at an acceleration voltage of about 70 to 300 kV.

When ultraviolet light is used as the ionizing radiation, one including ultraviolet light at a wavelength of 190 to 380 nm is usually radiated. The ultraviolet light source is not particularly limited, and for example, a high pressure mercury lamp, a low pressure mercury lamp, a metal halide lamp, or a carbon arc lamp is used.

Next, the conductive layer is preferably formed on the stabilization layer by use of the above-mentioned ionizing radiation curable resin composition for conductive layer formation. The coating method and the curing method of the ionizing radiation curable resin composition are the same as in the case of the above-mentioned stabilization layer.

The functional layer is preferably formed using the above-mentioned ionizing radiation curable resin composition. For example, the ionizing radiation curable resin, and an ultraviolet absorber, current carrying particles and other various additives, used if necessary, are homogeneously mixed at each predetermined proportion, thereby preparing a coating liquid made of the ionizing radiation curable resin composition. The stabilization layer or the conductive layer can be coated with the coating liquid thus prepared, and the resultant can be, if necessary, dried, and thereafter cured to form a functional layer made of the ionizing radiation curable resin composition. The coating method and the curing method of the resin composition are the same as in the case of the above-mentioned stabilization layer.

### (Configuration of Optical Laminate (III))

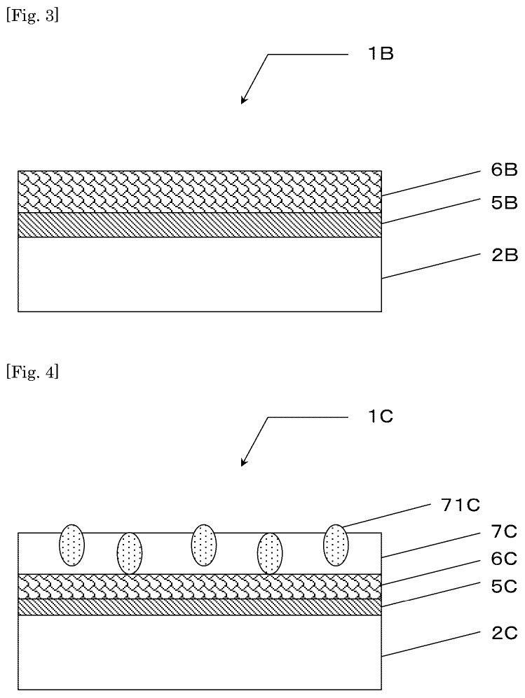

The optical laminate (III) of the present invention is here described with reference to FIG. 3 and FIG. 4. FIG. 3 and FIG. 4 are each a cross-sectional schematic view illustrating one example of embodiments of the optical laminate (III). An optical laminate 1B illustrated in FIG. 3 comprises a cellulose-based substrate film 2B, a stabilization layer 5B and a conductive layer 6B in this order. The conductive layer 6B is preferably a cured product of the above-mentioned ionizing radiation curable resin composition. An optical laminate 1C illustrated in FIG. 4 comprises a cellulose-based substrate film 2C, a stabilization layer 5C, a conductive layer 6C and a functional layer 7C in this order. The conductive layer 6C is preferably a cured product of the above-mentioned ionizing radiation curable resin composition. The functional layer 7C illustrated in FIG. 4 is a conducting functional layer comprising current carrying particles 71C.

The optical laminate having the configuration in FIG. 3 or FIG. 4 is favorable in in-plane uniformity of surface resistivity, and therefore, when used for a capacitive touch panel, can impart stable operability to the touch panel, and is particularly suitably used in an image display device on which an in-cell type touch panel is mounted. As described above, a phenomenon occurs where a liquid crystal screen is clouded due to static electricity generated on a touch panel surface in an in-cell touch panel-mounted liquid crystal display device. The optical laminate of FIG. 3 or FIG. 4 can be then used for the front surface of an in-cell touch panel-mounted liquid crystal display component, thereby imparting an antistatic function to thereby allow static electricity to escape, thereby preventing the clouding.

In particular, the optical laminate 1C having the configuration in FIG. 4 preferably comprises a conducting functional layer as the functional layer 7C. The current carrying particles 71C in the conducting functional layer can make a conduction between the surface of the conducting functional layer and the conductive layer 6C, to allow static electricity reaching the conductive layer to further flow in the thickness direction, thereby imparting a desired surface resistivity to the surface (closer to an operator) of the functional layer. Furthermore, in-plane uniformity and stability over time of surface resistivity become favorable, and operability of a capacitive touch panel is stably exhibited.

While the conductive layer has the conductive property in the plane direction (X direction, Y direction) and in the thickness direction (z direction), the conducting functional layer may have the conductive property only in the thickness direction. Accordingly, the conducting functional layer differs in role in that the conductive property in the plane direction is not necessarily needed.

### (Properties of Optical Laminate)

The optical laminates (I) to (III) of the present invention (hereinafter, also simply referred to them as “the optical laminate of the present invention”) preferably have a transmittance at a wavelength of 400 nm, of 60% or more, more preferably 65% or more, in terms of visibility in application to an image display device.

The optical laminate of the present invention also preferably has the maximum transmittance at a wavelength of 380 nm in the ultraviolet light region where the wavelength is from 200 to 380 nm, and has a transmittance at a wavelength of 380 nm, of 30% or less, more preferably 25% or less. When the transmittance at a wavelength of 380 nm is 30% or less, the effect of preventing degradation due to ultraviolet light as light from outside is favorable.

The transmittance of the optical laminate can be measured by an ultraviolet and visible spectrophotometer or the like, and can be specifically measured by a method described in Examples.

### [Front Panel]

The front panel of the present invention comprises the above-mentioned optical laminate of the present invention, a polarizer and a phase difference film in this order. The front panel of the present invention, when applied to an image display device described below, is provided so as to have a configuration where the above-mentioned optical laminate of the present invention, a polarizer and a phase difference film are comprised in this order when viewed from a viewer of the image display device and the optical laminate comprises the surface protection layer, the transparent conductive layer and the substrate film in this order when viewed from the viewer.

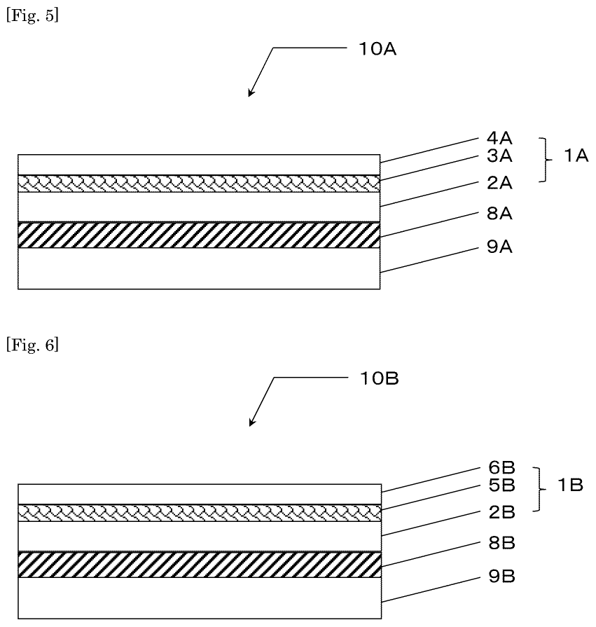

A front panel 10A illustrated in FIG. 5 which is a cross sectional view of one example of the front panel of the present invention comprises an optical laminate 1A, a polarizer 8A and a phase difference film 9A in this order. 1A corresponds to the optical laminate (I) or (II). Such a configuration can impart any function necessary as a front panel for use in an image display device and also allow for a decrease in thickness.

A front panel 10B illustrated in FIG. 6 which is a cross sectional view of one example of the front panel of the present invention comprises an optical laminate 1B, a polarizer 8B and a phase difference film 9B in this order. 1B corresponds to the optical laminate (III). Such a configuration can impart any function necessary as a front panel for use in an image display device and also allow for a decrease in thickness.

In the configuration illustrated in FIG. 5, the optical laminate 1A also functions as a surface protection film of the polarizer 8A. In the configuration illustrated in FIG. 6, the optical laminate 1B also functions as a surface protection film of the polarizer 8B. Accordingly, the optical laminate 1A or 1B can be used in the front panel to thereby remove a TAC film conventionally used as a surface protection film of a polarizer, and a pressure-sensitive adhesion layer conventionally used for bonding such a film to other layer, thereby allowing for decreases in thickness of a front panel and an image display device.

### (Polarizer)

The polarizer constituting the front panel may be any polarizer as long as it has a function of transmission of only light having a specific vibration direction, and examples include a PVA-based polarizer obtained by orienting a PVA-based film or the like and dying it by iodine, a dichromatic dye or the like, a polyene-based polarizer such as PVA dehydrated or polyvinyl chloride dehydrochlorinated, a reflective polarizer using a cholesteric liquid crystal, and a thin crystal film-based polarizer. Among them, a PVA-based polarizer is suitable which exhibits adhesiveness by means of water and which can adhere to the phase difference film and the optical laminate without any other adhesion layer provided.

Examples of the PVA-based polarizer include a polarizer obtained by allowing a dichromatic substance such as iodine or a dichromatic dye to be adsorbed by a hydrophilic polymer film such as a PVA-based film, a partially formalized polyvinyl alcohol-based film or an ethylene-vinyl acetate copolymer-based partially saponified film, and uniaxially orienting the resultant. In particular, a polarizer made of a PVA-based film and a dichromatic substance such as iodine is suitably used from the viewpoint of adhesiveness.

A PVA-based resin composing the PVA-based film is obtained by saponifying polyvinyl acetate.

The thickness of the polarizer is preferably 2 to 30 μm, more preferably 3 to 30 μm.

### (Phase Difference Film)

The phase difference film constituting the front panel is configured to comprise at least a phase difference layer. Examples of the phase difference layer include an aspect relating to an oriented film such as an oriented polycarbonate film, an oriented polyester film, or an oriented cyclic olefin film, and an aspect relating to a layer containing a refractive index anisotropic material. The latter aspect among the former and the latter aspects is preferable from the viewpoint of control of retardation and a decrease in thickness.

The layer containing a refractive index anisotropic material (hereinafter, also sometimes referred to as “anisotropic material-containing layer”) may singly form the phase difference film, or may be configured to comprise the anisotropic material-containing layer on a resin film.

Examples of the resin composing the resin film include a polyester-based resin such as polyethylene naphthalate, a polyethylene-based resin, a polyolefin-based resin, a (meth)acrylic-based resin, a polyurethane-based resin, a polyethersulfone-based resin, a polycarbonate-based resin, a polysulfone-based resin, a polyether-based resin, a polyether ketone-based resin, a (meth)acrylonitrile-based resin, a cycloolefin polymer and a cellulose-based resin, and these can be used singly or in combination of two or more kinds thereof. Among them, a cycloolefin polymer is preferable from the viewpoint of dimension stability and optical stability.

Examples of the refractive index anisotropic material include a bar-shaped compound, a disc-shaped compound and a liquid crystal molecule.

When the refractive index anisotropic material is used, various types of phase difference films can be obtained depending on the orientation direction of the refractive index anisotropic material.

Examples include a so-called positive C-plate where not only does the optical axis of the refractive index anisotropic material point to the normal direction of the anisotropic material-containing layer, but the extraordinary beam refractive index is also higher than the ordinary beam refractive index in the normal direction of the anisotropic material-containing layer.

In another aspect, the phase difference film may be a so-called positive A-plate where not only is the optical axis of the refractive index anisotropic material in parallel to the anisotropic material-containing layer, but the extraordinary beam refractive index is also higher than the ordinary beam refractive index in the in-plane direction of the anisotropic material-containing layer.

Furthermore, the phase difference film may be a so-called negative C-plate where the optical axis of a liquid crystal molecule is parallel to the anisotropic material-containing layer, to provide a cholesteric orientation exhibiting a spiral structure in the normal direction, thereby allow the extraordinary beam refractive index to be lower than the ordinary beam refractive index in the normal direction of the phase difference layer in the entire anisotropic material-containing layer.

Furthermore, the phase difference film may be a negative A-plate where the optical axis of a discotic liquid crystal having negative birefringence anisotropy is in the in-plane direction of the anisotropic material-containing layer.

Furthermore, the phase difference film may be a hybrid orientation plate where the anisotropic material-containing layer may be obliquely disposed to the phase difference layer, or such an oblique angle may be changed in a direction perpendicular to the phase difference layer.

Such various types of phase difference films can be produced by a method described in, for example, JP 2009-053371 A.

The phase difference film may be made of any one plate of the positive or negative C-plates and A-plates, or the hybrid orientation plate described above, or may be made of two or more plates where the above plates are used singly or in combinations of two or more kinds thereof. For example, when a liquid crystal component of an in-cell touch panel is a VA system, the positive A-plate and the negative C-plate are preferably used in combination, and when the liquid crystal component is an IPS system, the positive C-plate and the positive A plate or a biaxial plate are preferably used in combination. Any combination may be adopted as long as the viewing angle can be compensated, and various combinations are considered and can be appropriately selected.

When the phase difference film is made of two or more plates, an aspect where one plate is an oriented film and the anisotropic material-containing layer (other plate) is laminated on the oriented film is preferable from the viewpoint of a decrease in thickness.

The thickness of the phase difference film is preferably 25 to 60 μm, more preferably 25 to 30 μm. When the phase difference film is made of two or more plates, an aspect where one plate is an oriented film and the anisotropic material-containing layer (other plate) is laminated on the oriented film can easily allow the thickness to be in the range.

The front panel of the present invention may comprise any film and/or layer other than the above to the extent that the effect of the present invention is not inhibited, provided that the phase difference film, the polarizer and the optical laminate are preferably laminated with no other layer being interposed therebetween from the viewpoint of a decrease in thickness and transparency. “Laminated with no other layer being interposed therebetween” herein is not intended to completely exclude interposition of other layer. For example, it is not intended that even a very thin layer such as an easy adhesion layer provided on the substrate film in advance is excluded.

The thickness of the front panel of the present invention can be appropriately selected depending on the display device used and the layer configuration. When the front panel is used for an in-cell touch panel-mounted image display device, the thickness of the front panel is preferably 90 to 800 μm, more preferably 90 to 500 μm, further preferably 90 to 350 μm.

### [Method for Producing Front Panel]

The method for producing the front panel of the present invention is not particularly limited, and the front panel can be produced by bonding members constituting the front panel by a known method. The bonding system may be any of a sheet feeding system or a continuous system, and a continuous system is preferably used in terms of the production efficiency.

In particular, the method for producing the front panel of the present invention preferably comprises a step of bonding the optical laminate and the polarizer by roll-to-roll. As described above, in the case where a cycloolefin polymer is used in the substrate film in the optical laminate of the present invention, the cycloolefin polymer film is a film obliquely oriented to thereby allow for no need to obliquely cut the optical laminate of the present invention into a single sheet even in bonding of the optical laminate of the present invention to the polarizer so that the optical axes of both are aligned. Therefore, continuous production by roll-to-roll can be made and the waste due to oblique cutting into a single sheet is also lessened, and the above case is preferable in terms of the production cost.

Examples include a method where a surface of the above-mentioned optical laminate of the present invention, the surface being closer to the substrate film, and the polarizer are bonded, and thereafter the polarizer and the phase difference film are bonded by roll-to-roll; and a method where the polarizer and the phase difference film are bonded, and thereafter the polarizer and a surface of the optical laminate of the present invention, the surface being closer to the substrate film, are bonded by roll-to-roll.

### [Image Display Device]

The image display device of the present invention is one where the optical laminate or the front panel of the present invention is provided facing a viewer of a display component. The optical laminate or the front panel is preferably disposed so that the conductive layer surface of the optical laminate faces a viewer.

Examples of the display component constituting the image display device include a liquid crystal display component, a plasma display component, an inorganic EL display component and an organic EL display component. Among them, a liquid crystal display component or an organic EL display component is preferable and a liquid crystal display component is more preferable from the viewpoint that the effect of the present invention is exerted.

A specific configuration of the display component is not particularly limited. For example, in the case of a liquid crystal display component, the display component has a basic configuration comprising a lower glass substrate, a lower transparent electrode, a liquid crystal layer, an upper transparent electrode, a color filter and an upper glass substrate in this order, and in the case of an ultrahigh resolution liquid crystal display component, the lower transparent electrode and the upper transparent electrode are patterned at a high density.

The display component is more preferably an in-cell touch panel-mounted liquid crystal display component in terms of the effect of the present invention. An in-cell touch panel-mounted liquid crystal display component is a display component where a touch panel function is embedded in a liquid crystal display component obtained by sandwiching a liquid crystal between two glass substrates. Examples of the liquid crystal display system of an in-cell touch panel-mounted liquid crystal display component include an IPS system, a VA system, a multi-domain system, an OCB system, a STN system and a TSTN system.

An in-cell touch panel-mounted liquid crystal display component is described in, for example, JP 2011-76602 A and JP 2011-222009 A.

Examples of the touch panel include a capacitive touch panel, a resistance film touch panel, an optical touch panel, an ultrasonic touch panel and an electromagnetic induction touch panel. A capacitive touch panel is preferable in terms of the effect of the present invention.

A resistance film touch panel is formed by connecting a circuit to a basic configuration where a pair of upper and lower transparent substrates each comprising a conductive film are disposed with a spacer being interposed therebetween so that such conductive films are opposite to each other.

Examples of the capacitive touch panel include a surface-type capacitive touch panel and a projection-type capacitive touch panel, and the projection-type capacitive touch panel is often used. The projection-type capacitive touch panel is formed by connecting a circuit to a basic configuration where an X-axis electrode and a Y-axis electrode perpendicular to the X-axis electrode are disposed with an insulator being interposed therebetween. The basic configuration is more specifically described: (1) an aspect where an X-axis electrode and a Y-axis electrode are formed on separate surfaces of one transparent substrate, (2) an aspect where an X-axis electrode, an insulator layer and a Y-axis electrode are formed in this order on a transparent substrate, (3) an aspect where an X-axis electrode is formed on a transparent substrate, a Y-axis electrode is formed on another transparent substrate, and such electrodes are laminated with an adhesion layer or the like being interposed therebetween, and the like are exemplified. Examples include an aspect where still another transparent substrate is laminated on any basic configuration according to such basic aspects.

Other examples of an image display device on which a touch panel is mounted include one that comprises a touch panel on a display component. In this case, the optical laminate of the present invention may be provided as a constituent member of the touch panel, or may be provided on or under the touch panel.

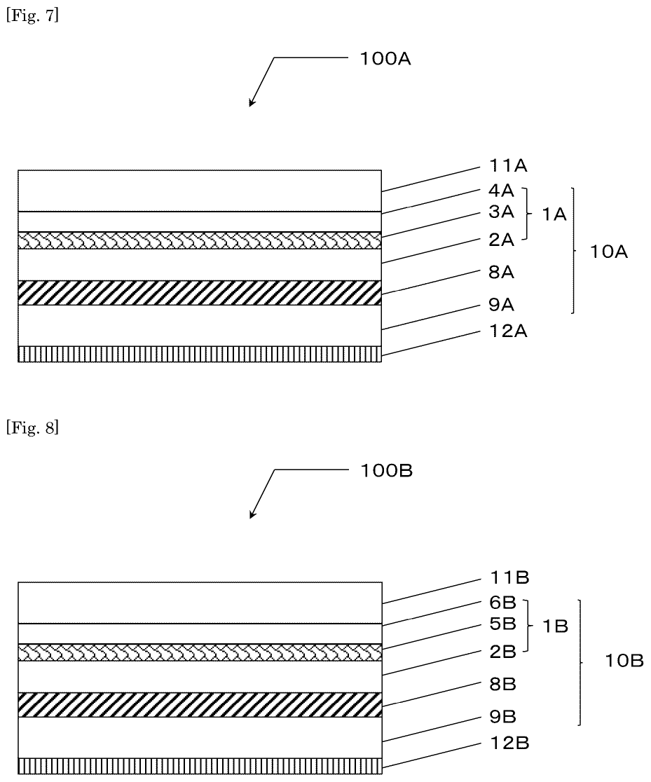

FIG. 7 and FIG. 8 are each a cross-sectional schematic view illustrating one embodiment of an in-cell touch panel-mounted image display device, which is a preferable embodiment of the image display device of the present invention. In FIG. 7, an in-cell touch panel-mounted image display device 100A comprises a surface protection member 11A, the optical laminate 1A, a polarizer 8A, a phase difference film 9A and an in-cell touch panel-mounted liquid crystal display component 12A in the listed order when viewed from a viewer. The optical laminate 1A, the polarizer 8A and the phase difference film 9A correspond to a front panel 10A. The optical laminate 1A comprises a surface protection layer 4A, a transparent conductive layer 3A and a substrate film 2A in the listed order from the surface protection member 11A facing a viewer.

In FIG. 8, an in-cell touch panel-mounted image display device 100B comprises a surface protection member 11B, the optical laminate 1B, a polarizer 8B, a phase difference film 9B and an in-cell touch panel-mounted liquid crystal display component 12B in the listed order when viewed from a viewer, and the optical laminate 1B comprises a conductive layer 6B, a stabilization layer 5B and a cellulose-based substrate film 2B in the listed order from the surface protection member 11B.

The surface protection members 11A and 11B are each provided for the purpose of protecting the surface of the in-cell touch panel-mounted image display device, and, for example, cover glass, or a surface protection film comprising a silicon-containing film can be used.

The in-cell touch panel-mounted liquid crystal display component and the front panel can be bonded with, for example, an adhesion layer being interposed therebetween. An adhesive such as a urethane-based, acrylic-based, polyester-based, epoxy-based or vinyl acetate-based adhesive, a vinyl chloride-vinyl acetate copolymer, or a cellulose-based adhesive can be used in the adhesion layer. The thickness of the adhesion layer is about 10 to 25 μm.

Such an in-cell touch panel-mounted liquid crystal display device of the present invention is extremely useful in that the liquid crystal display device comprises the optical laminate of the present invention to thereby not only exhibit a stable operability, but also be able to be decreased in the entire thickness while satisfying various functions such as prevention of the occurrence of a rainbow interference pattern in observation by polarized sunglasses, prevention of clouding of a liquid crystal display screen due to the occurrence of static electricity, and protection of the polarizer serving as a constituent member of the front panel and prevention of degradation thereof due to ultraviolet light as light from outside, as described above. A grounding treatment is preferably performed from the transparent conductive layer surface of the optical laminate in the in-cell touch panel-mounted liquid crystal display device.

### [Fourth Invention: Method for Producing Optical Laminate]

The method for producing an optical laminate of the present invention according to the fourth invention (hereinafter, also referred to as “the production method of the present invention”) is a method for producing an optical laminate comprising a substrate film, a transparent conductive layer and a surface protection layer in this order.

More specifically, the production method of the present invention comprises a step of laminating a rear surface film on a one surface of the substrate film with a pressure-sensitive adhesion layer being interposed therebetween, and then forming the transparent conductive layer and the surface protection layer in this order on other surface of the substrate film, and the following condition (1) is satisfied (aspect 4-1 of the present invention).
Condition (1): when the laminate comprising the substrate film, the pressure-sensitive adhesion layer and the rear surface film has a width of 25 mm and a length of 100 mm, and a portion of the laminate corresponding to 25 mm from one end in the length direction is horizontally secured and the remaining portion thereof corresponding to a length of 75 mm is deformed by its own weight, the vertical distance from the secured portion to other end of the laminate in the length direction is 45 mm or less.

The production method of the present invention comprises a step of laminating a rear surface film on a one surface of the substrate film with a pressure-sensitive adhesion layer being interposed therebetween, and then forming the transparent conductive layer and the surface protection layer in this order on other surface of the substrate film, the total thickness of the pressure-sensitive adhesion layer and the rear surface film is 20 to 200 μm, and the rear surface film has a tensile elastic modulus of 800 N/mm² or more and 10,000 N/mm² or less as measured at a tensile speed of 5 mm/min according to JIS K7161-1:2014 (aspect 4-2 of the present invention).

When a substrate film having no stiffness and having a low strength is used in an optical laminate comprising a substrate film, a transparent conductive layer and a surface protection layer in this order, flatness of the substrate film is difficult to ensure in direct formation of the transparent conductive layer on the substrate film, causing the variation in thickness in the transparent conductive layer formed, in some cases. If in-plane variability in surface resistivity is caused due to the variation in thickness, a problem is that operability is unstable in use of an optical laminate produced, for a capacitive touch panel-mounted image display device or the like.

In the production method of the present invention, however, a rear surface film is laminated on one surface of the substrate film with a pressure-sensitive adhesion layer being interposed therebetween to form the laminate satisfying a predetermined condition, and thereafter a transparent conductive layer and the like are formed on other surface of the substrate film (aspect 4-1 of the present invention). Alternatively, a pressure-sensitive adhesion layer and a rear surface film satisfying a predetermined condition are laminated on one surface of the substrate film, and thereafter a transparent conductive layer and the like are formed on other surface of the substrate film (aspect 4-2 of the present invention). Thus, the variation in thickness of the transparent conductive layer formed using the ionizing radiation curable resin composition can be particularly suppressed, thereby resulting in an enhancement in in-plane uniformity of surface resistivity.

In particular, when a cycloolefin polymer film is used as the substrate film, the production method of the present invention is also more effectual from the viewpoint of an enhancement in productivity. The reason is because, while a cycloolefin polymer film is suitable as the substrate film in that more excellent optical properties are obtained, the film has no stiffness and is easily broken to easily cause production loss.

The rear surface film more preferably has transparency to thereby exert the effect of examining, in the state where the rear surface film is bonded to the optical laminate, not only the presence or absence of foreign substances and/or defects, but also in-plane uniformity of surface resistivity from the variability in the thickness of the transparent conductive layer measured by an optical procedure. Such a method is useful, particularly in terms of performing an inline examination. If an inline examination can be made, a process can be easily managed in production of the optical laminate, resulting in a decrease in production loss.

Examples of the method for measuring uniformity of the thickness of the transparent conductive layer by an optical procedure include a method where monochromatic parallel light is allowed to be incident in a direction oblique to the transparent conductive layer at a low angle, and uniformity of an interference fringe observed is visually observed, a method where the total light transmittance is measured at a plurality of points by a haze meter or the like, and a method where the thickness is measured at a plurality of points by an interference microscope or the like according to an interference method.

The production method according to aspect 4-1 of the present invention satisfies the following condition (1).
Condition (1): when the laminate comprising the substrate film, the pressure-sensitive adhesion layer and the rear surface film has a width of 25 mm and a length of 100 mm, and a portion of the laminate corresponding to 25 mm from one end in the length direction is horizontally secured and the remaining portion thereof corresponding to a length of 75 mm is deformed by its own weight, the vertical distance from the secured portion to other end of the laminate in the length direction is 45 mm or less.

If the vertical distance is more than 45 mm, the laminate being a subject on which the transparent conductive layer is to be formed is large in deflection, thereby making it difficult to produce an optical laminate favorable in in-plane uniformity of surface resistivity. From such a viewpoint, the vertical distance is preferably 40 mm or less, more preferably 35 mm or less.

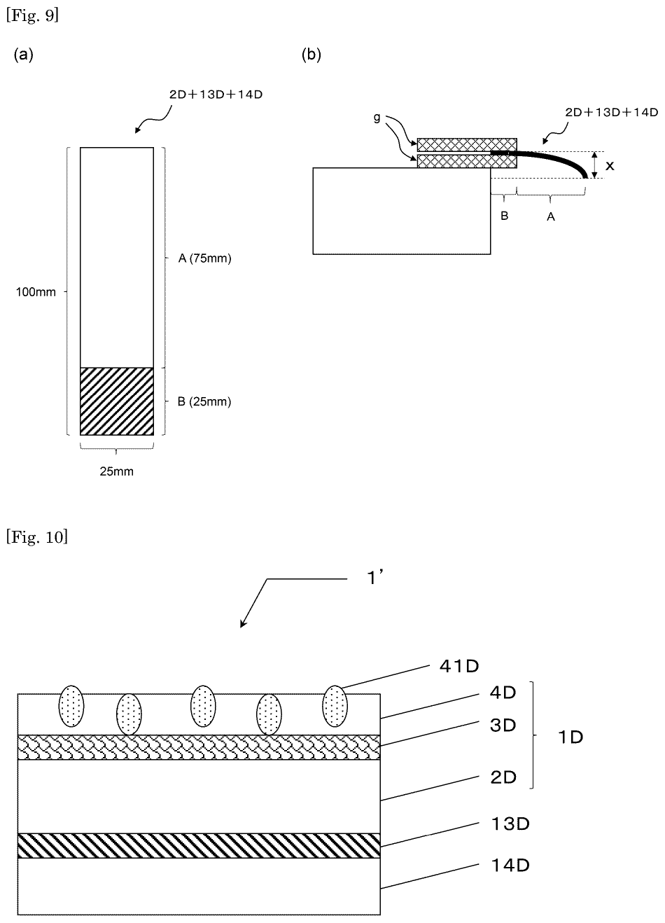

The method for measuring the vertical distance defined in condition (1) is described in more detail with reference to FIG. 9. FIG. 9 (a) illustrates a laminate comprising a substrate film 2D, a pressure-sensitive adhesion layer 13D and a rear surface film 14D, and having a width of 25 mm and a length of 100 mm. Portion B of the laminate, corresponding to 25 mm from one end in the length direction, is sandwiched between two glass plates g and horizontally secured as illustrated in FIG. 9 (b). Portion A which is the remaining portion of the laminate, corresponding to a length of 75 mm, is then deformed by the own weight, and the vertical distance x from the secured portion to other end of the laminate in the length direction is measured. The vertical distance x can be specifically measured by a method described in Examples. When there is no deflection, the vertical distance x is 0 mm.

Even when the value of the vertical distance x varies depending on the directions in which the laminate is cut (MD direction and TD direction of a film constituting the laminate), the vertical distance x may be 45 mm or less in any of MD direction and TD direction.

In the production method according to aspect 4-2 of the present invention, the total thickness of the pressure-sensitive adhesion layer and the rear surface film is 20 to 200 μm, and the laminated article comprising the pressure-sensitive adhesion layer and the rear surface film has a tensile elastic modulus of 800 N/mm² or more and 10,000 N/mm² or less as measured at a tensile speed of 5 mm/min according to JIS K7161-1:2014. If the total thickness or the tensile elastic modulus is less than the above range, flatness of the substrate film is difficult to maintain in formation of the transparent conductive layer and the surface protection layer on the film. If the total thickness or the tensile elastic modulus is more than the above range, processability of a transparent laminate is reduced. In addition, it may be difficult to examine the optical laminate by an optical procedure in the state where the rear surface film is bonded.

The total thickness of the pressure-sensitive adhesion layer and the rear surface film is preferably 25 μm or more from the viewpoint of maintaining flatness in production of the optical laminate, and is more preferably 25 to 200 μm, further preferably 30 to 100 μm from the viewpoint of maintaining flatness and processability in production of the optical laminate, and easiness of examination.

The laminated article comprising the pressure-sensitive adhesion layer and the rear surface film is preferably small in deflection from the viewpoint of maintaining flatness in production of the optical laminate. Specifically, when the laminated article has a width of 25 mm and a length of 100 mm, and a portion thereof, corresponding to 25 mm from one end in the length direction, is horizontally secured and the remaining portion thereof, corresponding a length of 75 mm, is then deformed by the own weight, the vertical distance from the secured portion to other end of the laminated article in the length direction is preferably 70 mm or less. Thus, an optical laminate favorable in in-plane uniformity of surface resistivity can be produced. The vertical distance of the laminated article is more preferably 60 mm or less, further preferably 55 mm or less.

The vertical distance can be measured as in condition (1), and can be specifically measured by a method described in Examples. When the value of the vertical distance herein varies depending on the directions in which the rear surface film is cut (MD direction, TD direction), the vertical distance may be 70 mm or less in any of MD direction and TD direction.

The deflection of the laminated article comprising the pressure-sensitive adhesion layer and the rear surface film may be larger than the deflection of the substrate film for use in the optical laminate. The reason is because the effect of the present invention can be obtained when the laminate comprising the substrate film, the pressure-sensitive adhesion layer and the rear surface film can be decreased in deflection.

The laminated article comprising the pressure-sensitive adhesion layer and the rear surface film preferably has a total light transmittance of 70% or more and a haze of 30% or less, more preferably has a total light transmittance of 85% or more and a haze of 10% or less, still more preferably has a total light transmittance of 90% or more and a haze of 5% or less, from the viewpoint of easiness of examination of the optical laminate. The total light transmittance and the haze can be specifically measured by a method described in Examples.

Hereinafter, each layer constituting an optical laminate obtained by the production method of the present invention according to the fourth invention, and each member in the step, for use in the production method of the present invention, will be described.

### (Substrate Film)

The substrate film is a member constituting the optical laminate. The substrate film for use in the fourth invention preferably has a thickness of 4 to 100 μm, and a tensile elastic modulus of 500 N/mm² or more and 5,000 N/mm² or less, as measured at a tensile speed of 5 mm/min according to JIS K7161-1:2014. The substrate film has no stiffness and has a low strength, and therefore, when a transparent conductive layer is directly formed on the film, the variation in thickness is easily caused on a transparent conductive layer formed. According to the production method of the present invention, however, an optical laminate favorable in in-plane uniformity of surface resistivity can be produced even by use of a substrate film having the above physical properties.

The thickness of the substrate film is more preferably in the range of 4 to 80 μm, further preferably 4 to 60 μm, still further preferably 4 to 50 μm from the viewpoint that the effect of the present invention is obtained and from the viewpoint of strength, processing suitability, and decreases in thicknesses of a front panel and an image display device in which the optical laminate is provided.

The tensile elastic modulus of the substrate film is more preferably 800 N/mm² or more, further preferably 1,000 N/mm² or more from the viewpoint of the strength of the optical laminate, and is more preferably 4,000 N/mm² or less, further preferably 3,000 N/mm² or less from the viewpoint of the efficacy of the effect of the present invention. The tensile elastic modulus is specifically measured by a method described in Examples.

The substrate film for use in the fourth invention may be large in deflection. Specifically, the substrate film can be used, the substrate film having a width of 25 mm and a length of 100 mm, wherein when a portion thereof corresponding to 25 mm from one end in the length direction, is horizontally secured and the remaining portion thereof corresponding to a length of 75 mm is then deformed by the own weight, the vertical distance from the secured portion to other end of the film in the length direction is more than 45 mm. While the variation in thickness is easily caused on a transparent conductive layer formed in direct formation of a transparent conductive layer on the film, the production method of the present invention can allow an optical laminate favorable in in-plane uniformity of surface resistivity to be produced even by use of a substrate film having the above physical properties. When the value of the vertical distance herein varies depending on the directions in which the substrate film is cut (MD direction, TD direction), the vertical distance may be more than 45 mm in any of MD direction and TD direction.

The vertical distance can be measured as in condition (1), and can be specifically measured by a method described in Examples.

The type of the substrate film for use in the fourth invention and a preferable aspect thereof are the same as those described with respect to the optical laminate (I). That is, the substrate film is preferably a film having light transmission property, more preferably a plastic film having a retardation value of 3000 to 30000 nm (high retardation film) or a ¼ wavelength phase difference plastic film (¼ wavelength phase difference film), further preferably a cycloolefin polymer film. The cycloolefin polymer film is excellent in transparency, low moisture absorption property, and heat resistance. In particular, the cycloolefin polymer film is preferably a ¼ wavelength phase difference film obliquely oriented. When the cycloolefin polymer film is a ¼ wavelength phase difference film, the effect of being capable of preventing a rainbow interference pattern from occurring in observation of a display screen such as a liquid crystal screen by polarized sunglasses, as described above, is highly exerted, and therefore visibility is favorable. When the cycloolefin polymer film is an obliquely oriented film, there is no need for oblique cutting of the optical laminate using the substrate film into a single sheet even in bonding of the optical laminate to the polarizer constituting the front panel so that the optical axes of both are aligned. Therefore, not only can continuous production by roll-to-roll be made, but the effect of lessening the waste by oblique cutting into a single sheet is also exerted.

The direction of the optical axis of an oriented film subjected to a common orientation treatment is a direction parallel or perpendicular to the width direction thereof. Therefore, for bonding so that the transmission axis of a linear polarizer (polarizer) and the optical axis of the ¼ wavelength phase difference film are aligned, the film is needed to be cut obliquely into a single sheet. Thus, not only is a production process complicated, but the film is also largely wasted because of being obliquely cut. In addition, production by roll-to-roll cannot be made and continuous production is difficult to be made. The obliquely oriented film, however, can be used as the substrate film, thereby solving such problems.

Examples of the cycloolefin polymer can include a norbornene-based resin, a monocyclic olefin-based resin, a cyclic conjugated diene-based resin, a vinyl alicyclic hydrocarbon-based resin, and hydrogenated products thereof. Among them, a norbornene-based resin is preferable from the viewpoint of transparency and moldability.

Examples of the norbornene-based resin can include a ring-opening polymer of a monomer having a norbornene structure or a ring-opening copolymer of a monomer having a norbornene structure with other monomer, or a hydrogenated product thereof; and an addition polymer of a monomer having a norbornene structure or an addition copolymer of a monomer having a norbornene structure with other monomer, or a hydrogenated product thereof.

The orientation angle of the obliquely oriented film with respect to the width direction of the film is preferably 20 to 70°, more preferably 30 to 60°, further preferably 40 to 50°, particularly preferably 45°. The reason is because the orientation angle of the obliquely oriented film is 45° to thereby obtain complete circular polarization. In addition, the optical laminate is not needed to be cut obliquely into a single sheet even when bonded so as to be aligned with the optical axis of a polarizer, and thus continuous production by roll-to-roll can be made.

### (Transparent Conductive Layer)

The material composing the transparent conductive layer for use in the fourth invention is not particularly limited, and the transparent conductive layer is preferably a cured product of an ionizing radiation curable resin composition comprising an ionizing radiation curable resin and conductive particles. In particular, the transparent conductive layer is more preferably a cured product of an ionizing radiation curable resin composition comprising an ionizing radiation curable resin (A) having an alicyclic structure in the molecule and conductive particles in that in-plane uniformity and stability over time of surface resistivity, and the close contact property in the case of use of the cycloolefin polymer film as the substrate film are excellent.

The ionizing radiation curable resin composition for transparent conductive layer formation may include an ionizing radiation curable resin (B) other than the ionizing radiation curable resin (A). The ionizing radiation curable resin (B) is preferably used in combination with the ionizing radiation curable resin (A) in that curability and applicability of the resin composition, as well as hardness, weather resistance and the like of a transparent conductive layer formed can be enhanced.

Each component composing the ionizing radiation curable resin composition for transparent conductive layer formation, and a preferable aspect thereof are the same as those described with respect to the transparent conductive layer of the optical laminate (I).

A transparent conductive layer obtained by using the ionizing radiation curable resin composition, even if being decreased in thickness, preferably can impart a sufficient conductive property, and is less colored, is favorable in transparency, is excellent in weather resistance and is less changed over time in conductive property.

For example, the average value of the surface resistivity in the transparent conductive layer provided on the front surface of a liquid crystal display component on which an capacitive in-cell touch panel is mounted is preferably set to 1.0×10⁷Ω/ [symbol] or more and 1.0×10¹⁰Ω/ [symbol] or less from the viewpoint that a touch panel is stably operated and from the viewpoint that clouding of a liquid crystal screen due to static electricity generated on a touch panel surface in touch with a finger is prevented. The surface resistivity can be measured by the same method as the method described with respect to the optical laminate (I).

The thickness of the transparent conductive layer is preferably 0.1 to 10 μm, more preferably 0.3 to 5 μm, further preferably 0.3 to 3 μm in terms of imparting a desired conductive property without any transparency lost. The thickness of the transparent conductive layer can be measured by the same method as the method described with respect to the optical laminate (I).

### (Surface Protection Layer)

The optical laminate produced by the fourth invention comprises a surface protection layer from the viewpoint that scratching of a front panel or an image display device in a production process is prevented.

As exemplified in an image display device (FIG. 12) described below, the surface protection layer is assumed to be positioned inward relative to the surface protection member provided on the outermost surface of the image display device. Accordingly, the surface protection layer may have hardness to such an extent that no scratching is made in a production process of a front panel or an image display device, unlike a hard coating for preventing scratching of the outermost surface of the image display device.

The surface protection layer is preferably a cured product of an ionizing radiation curable resin composition comprising an ionizing radiation curable resin from the viewpoint that hardness is imparted to the surface of the optical laminate and scratching of a front panel or an image display device in a production process is prevented.

Each component composing the ionizing radiation curable resin composition for surface protection layer formation, and a preferable aspect thereof are the same as those described with respect to the surface protection layer of the optical laminate (I).

The thickness of the surface protection layer can be appropriately selected depending on the application and required properties of the optical laminate, and is preferably 1 to 30 μm, more preferably 2 to 20 μm, further preferably 2 to 10 μm from the viewpoint of hardness, processing suitability, and a decrease in thickness of a display device using the optical laminate. The thickness of the surface protection layer can be measured by the same method as that of the thickness of the above-mentioned transparent conductive layer.

The optical laminate in the fourth invention may further comprise a functional layer at any location. Examples of the functional layer include an antireflection layer, a refractive index adjustment layer, an anti-glare layer, a fingerprint-resistant layer, an antifouling layer, a scratch-resistant layer and an antimicrobial layer. Such a functional layer, when provided on the outermost surface of the optical laminate, is preferably a cured product of a thermosetting resin composition or an ionizing radiation curable resin composition, more preferably a cured product of an ionizing radiation curable resin composition from the viewpoint that scratching of a front panel or an image display device in a production process is prevented.

### (Rear Surface Film)

In the production method of the present invention according to the fourth invention, first, a rear surface film is laminated on one surface of the substrate film with a pressure-sensitive adhesion layer being interposed therebetween. Thus, flatness can be maintained in production of the optical laminate even in the case of use of a substrate film having no stiffness and having a low strength for a constituent member of the optical laminate, and therefore in-plane uniformity of surface resistivity of the optical laminate can be kept.

Use of the rear surface film is preferable because, in particular, when a film high in surface smoothness is used as the substrate film, blocking in winding up of the optical laminate can also be prevented. The rear surface film more preferably has a high transparency, thereby enabling the presence or absence of foreign substances and/or defects of the optical laminate, uniformity of the thickness of the transparent conductive layer, and the like to be more easily examined by an optical procedure, even in the state where the film is bonded.

A polyester-based resin film of polyethylene terephthalate (PET), polyethylene naphthalate (PEN) or the like, or a polyolefin-based resin film of polypropylene (PP) or the like can be used as the rear surface film. A polyester-based resin film is preferable and a polyethylene terephthalate (PET) film is more preferable from the viewpoint that the effect of the present invention is obtained. Such films preferably have an antistatic property from the viewpoint of handleability in production of the optical laminate.

### (Pressure-Sensitive Adhesion Layer)

The rear surface film is laminated on a surface of the optical laminate, the surface being closer to the substrate film, with a pressure-sensitive adhesion layer being interposed therebetween. The pressure-sensitive adhesion layer and the rear surface film are to be eventually released from the optical laminate. Therefore, the pressure-sensitive adhesion layer is preferably not only excellent in adhesiveness to the rear surface film, but also easily released from the substrate film.

The thickness of the pressure-sensitive adhesion layer is preferably 3 to 30 μm, more preferably 10 to 25 μm from the above viewpoints. When the thickness of the pressure-sensitive adhesion layer is 3 μm or more, adhesiveness to the rear surface film is favorable, and when the thickness is 30 μm or less, releasability of the rear surface film from the substrate film is favorable.

The thickness of the pressure-sensitive adhesion layer can be measured by the same method as that with respect to the thickness of the above-mentioned transparent conductive layer.

The pressure-sensitive adhesive for forming the pressure-sensitive adhesion layer is not particularly limited, and a known pressure-sensitive adhesive such as a urethane-based pressure-sensitive adhesive, an acrylic-based pressure-sensitive adhesive or a polyester-based pressure-sensitive adhesive can be used. Among them, a pressure-sensitive adhesive high in total light transmittance and low in haze is preferable and an acrylic-based pressure-sensitive adhesive is preferable from the viewpoint that examination of the optical laminate is facilitated in the state where the rear surface film is laminated.

In the production method of the present invention, for example, one surface of the rear surface film is coated with the pressure-sensitive adhesive so that a desired thickness is achieved, thereby forming a pressure-sensitive adhesion layer by, if necessary, drying. Next, a release sheet is bonded to the pressure-sensitive adhesion layer and wound up, and thereafter the release sheet is bonded to one surface of the substrate film with being released, thereby enabling the substrate film and the rear surface film to be laminated with the pressure-sensitive adhesion layer being interposed therebetween. Alternatively, one surface of the rear surface film is coated with the pressure-sensitive adhesive so that a desired thickness is achieved, and bonded to the substrate film by, if necessary, drying, thereby enabling the substrate film and the rear surface film to be laminated with the pressure-sensitive adhesion layer being interposed therebetween.

Next, a transparent conductive layer is formed on other surface of the substrate film preferably by use of the above-mentioned ionizing radiation curable resin composition for transparent conductive layer formation, and a surface protection layer is formed thereon. First, the ionizing radiation curable resin composition for transparent conductive layer formation is prepared by the above-mentioned method, and thereafter the substrate film is coated therewith so that a desired thickness is achieved after curing. The coating method is not particularly limited, and examples include die coating, bar coating, roll coating, slit coating, slit reverse coating, reverse roll coating, and gravure coating. Furthermore, an uncured resin layer is formed on the substrate film by, if necessary, drying.

Next, the uncured resin layer is irradiated with ionizing radiation such as electron beam or ultraviolet light to cure the uncured resin layer, thereby forming the transparent conductive layer. When electron beam is used as the ionizing radiation, the acceleration voltage can be appropriately selected depending on a resin used and the thickness of the layer, and the uncured resin layer is preferably cured usually at an acceleration voltage of about 70 to 300 kV.

When ultraviolet light is used as the ionizing radiation, one including ultraviolet light at a wavelength of 190 to 380 nm is usually radiated. The ultraviolet light source is not particularly limited, and for example, a high pressure mercury lamp, a low pressure mercury lamp, a metal halide lamp, or a carbon arc lamp is used.

The surface protection layer is preferably formed using the above-mentioned ionizing radiation curable resin composition for surface protection layer formation. For example, the ionizing radiation curable resin, and an ultraviolet absorber, current carrying particles and other various additives, used if necessary, are homogeneously mixed at each predetermined proportion, thereby preparing a coating liquid made of the ionizing radiation curable resin composition. The transparent conductive layer can be coated with the coating liquid thus prepared, and the resultant can be, if necessary, dried, and thereafter cured to form a surface protection layer made of the ionizing radiation curable resin composition. The coating method and the curing method of the resin composition are the same as the forming method of the above-mentioned transparent conductive layer.

### [Transparent Laminate]

The transparent laminate according to the fourth invention comprises a pressure-sensitive adhesion layer and a rear surface film on one surface of a substrate film in the listed order from the substrate film, comprises a transparent conductive layer and a surface protection layer on other surface of the substrate film in the listed order from the substrate film, and satisfies the following condition (1):
Condition (1): when the laminate comprising the substrate film, the pressure-sensitive adhesion layer and the rear surface film has a width of 25 mm and a length of 100 mm, and a portion of the laminate corresponding to 25 mm from one end in the length direction is horizontally secured and the remaining portion thereof corresponding to a length of 75 mm is deformed by its own weight, the vertical distance from the secured portion to other end of the laminate in the length direction is 45 mm or less.

Alternatively, the transparent laminate according to the fourth invention comprises a pressure-sensitive adhesion layer and a rear surface film on one surface of a substrate film in the listed order from the substrate film, and comprises a transparent conductive layer and a surface protection layer on other surface of the substrate film in the listed order from the substrate film, wherein the total thickness of the pressure-sensitive adhesion layer and the rear surface film is 20 to 200 μm, and a laminated article comprising the pressure-sensitive adhesion layer and the rear surface film has a tensile elastic modulus of 800 N/mm² or more and 10,000 N/mm² or less as measured at a tensile speed of 5 mm/min according to JIS K7161-1:2014.

The transparent laminate according to the fourth invention is preferably produced by the above-mentioned method. The substrate film, the pressure-sensitive adhesion layer, the rear surface film, the transparent conductive layer and the surface protection layer in the transparent laminate, and the laminate, as well as preferable ranges thereof are the same as described above.

### <Layer Configuration of Optical Laminate and Transparent Laminate>

The optical laminate and the transparent laminate in the fourth invention are here described with reference to FIG. 10. FIG. 10 is a cross-sectional schematic view illustrating one example of embodiments of an optical laminate obtained by fourth invention and the transparent laminate according to the fourth invention. An optical laminate 1D illustrated in FIG. 10 comprises a substrate film 2D, a transparent conductive layer 3D and a surface protection layer 4D in this order. The transparent conductive layer 3D is preferably a cured product of the above-mentioned ionizing radiation curable resin composition. The surface protection layer 4D illustrated in FIG. 10 is a conducting surface protection layer comprising current carrying particles 41D.

A transparent laminate 1′ of the fourth invention is configured to comprise a pressure-sensitive adhesion layer 13D and a rear surface film 14D in this order on a surface of the optical laminate 1D, the surface being closer to the substrate film.

The transparent laminate of the fourth invention can have the configuration to thereby allow examination of the optical laminate by an optical procedure to be easily performed with the surface of the optical laminate, the surface being closer to the substrate film, being protected. The transparent laminate of the fourth invention preferably has a total light transmittance of 70% or more and a haze of 30% or less, more preferably has a total light transmittance of 80% or more and a haze of 10% or less, from the viewpoint of easiness of examination. The total light transmittance and the haze can be specifically measured by a method described in Examples.

The optical laminate 1D obtained by the production method of the present invention is favorable in in-plane uniformity of surface resistivity, and therefore, when used for a capacitive touch panel, can impart stable operability to the touch panel and is particularly suitably used in an image display device on which an in-cell type touch panel is mounted. As described above, a phenomenon occurs where a liquid crystal screen is clouded due to static electricity generated on a touch panel surface in an in-cell touch panel-mounted liquid crystal display device. The optical laminate can then be used for the front surface of an in-cell touch panel-mounted liquid crystal display component, thereby imparting an antistatic function to thereby allow static electricity to escape, thereby preventing the clouding.

In particular, the surface protection layer 1D of the optical laminate comprising the transparent conductive layer 3D is preferably a conducting surface protection layer. The current carrying particles 41D in the conducting surface protection layer can make a conduction between the surface of the conducting surface protection layer and the transparent conductive layer 3D, to allow static electricity reaching the transparent conductive layer to further flow in the thickness direction, thereby imparting a desired surface resistivity to the surface (closer to an operator) of the surface protection layer. Furthermore, in-plane uniformity and stability over time of surface resistivity become favorable, and operability of a capacitive touch panel is stably exhibited.

### [Method for Producing Front Panel]

The fourth invention also provides a method for producing a front panel. The front panel comprises a surface protection layer, a transparent conductive layer, a substrate film, a polarizer and a phase difference film in this order. The surface protection layer, the transparent conductive layer and the substrate film correspond to the above-mentioned respective constituent members of the optical laminate.

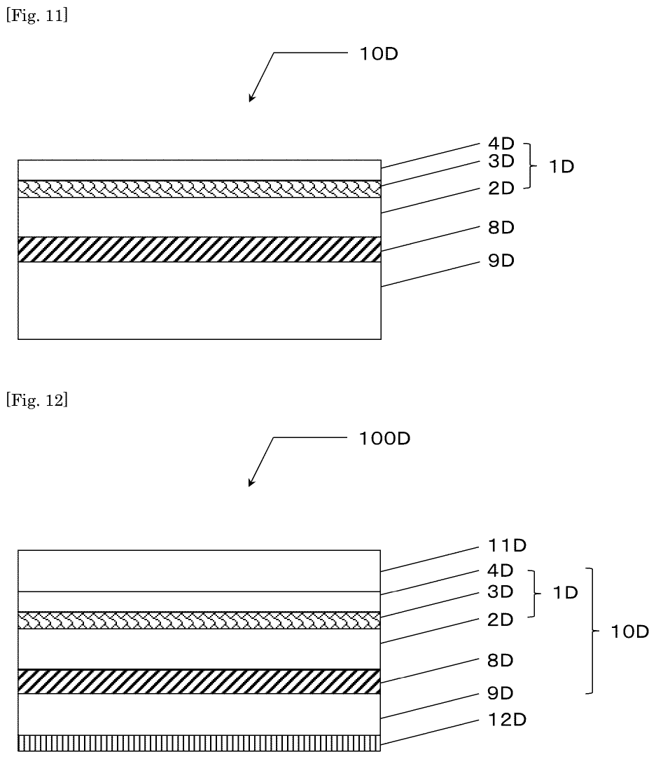

FIG. 11 is a cross-sectional view of one example of a front panel 10D in the fourth invention, and the front panel 10D comprises the optical laminate 1D comprising the surface protection layer 4D, the transparent conductive layer 3D and the substrate film 2D, a polarizer 8D, and a phase difference film 9D in this order. Such a configuration can impart any function necessary as a front panel for use in an image display device and also allow for a decrease in thickness.

The method for producing a front panel of the fourth invention comprises a step of releasing the pressure-sensitive adhesion layer and the rear surface film of the transparent laminate, and bonding a surface of the transparent laminate, the surface being closer to the substrate film, to a polarizer by roll-to-roll. That is, the production method comprises a step of releasing and removing the pressure-sensitive adhesion layer and the rear surface film of the transparent laminate, and bonding an exposed surface of the optical laminate 1D, the surface being closer to the substrate film 2D, to the polarizer 8D by roll-to-roll. As described above, in the case where a cycloolefin polymer is used as the substrate film in the optical laminate, the cycloolefin polymer film is a film obliquely oriented to thereby allow for no need to obliquely cut the optical laminate into a single sheet even in bonding of the optical laminate to the polarizer so that the optical axes of both are aligned. Therefore, continuous production by roll-to-roll can be made and the waste due to oblique cutting into a single sheet is also lessened, and the above case is preferable in terms of the production cost. In addition, tension is applied to the optical laminate during the step in production by a roll-to-roll system, and therefore the method for producing a front panel of the fourth invention is more effectual in the case of use of a substrate film easily broken like a cycloolefin polymer film.

Specific examples include a method where the pressure-sensitive adhesion layer and the rear surface film are released from the above-mentioned transparent laminate of the fourth invention, an exposed surface of the optical laminate, the surface being closer to the substrate film, and a polarizer are bonded, and thereafter the polarizer and a phase difference film are bonded by roll-to-roll; and a method where a polarizer and a phase difference film are bonded, thereafter the pressure-sensitive adhesion layer and the rear surface film are released from the transparent laminate of the fourth invention, and the polarizer and an exposed surface of the optical laminate, the surface being closer to the substrate film, are bonded by roll-to-roll.

The polarizer, the phase difference film and other layer constituting the front panel in the fourth invention, and preferable aspect thereof are the same as described above.

An optical laminate or a front panel obtained by the production method of the fourth invention can be applied to an image display device. The image display device and a preferable aspect thereof are the same as described above, and the image display device is preferably an in-cell touch panel-mounted liquid crystal display device.

FIG. 12 is a cross-sectional schematic view illustrating one embodiment of an in-cell touch panel-mounted image display device, which is a preferable embodiment of an image display device. In FIG. 12, an in-cell touch panel-mounted image display device 100D comprises a surface protection member 11D, an optical laminate 1D, a polarizer 8D, a phase difference film 9D and an in-cell touch panel-mounted liquid crystal display component 12D in the listed order when viewed from a viewer. The optical laminate 1D, the polarizer 8D and the phase difference film 9D correspond to a front panel 10D. The optical laminate 1D comprises a surface protection layer 4D, a transparent conductive layer 3D and a substrate film 2D in the listed order from the surface protection member 11D facing a viewer.

The surface protection member 11D is provided for the purpose of protecting the surface of the in-cell touch panel-mounted image display device, and, for example, cover glass, or a surface protection film comprising a silicon-containing film can be used.

The in-cell touch panel-mounted liquid crystal display component and the front panel can be bonded with, for example, an adhesion layer being interposed therebetween. An adhesive such as a urethane-based, acrylic-based, polyester-based, epoxy-based or vinyl acetate-based adhesive, a vinyl chloride-vinyl acetate copolymer, or a cellulose-based adhesive can be used in the adhesion layer. The thickness of the adhesion layer is about 10 to 25 μm.

Such an in-cell touch panel-mounted liquid crystal display device is extremely useful in that the liquid crystal display device comprises the optical laminate obtained by the production method of the fourth invention to thereby not only exhibit a stable operability, but also be able to be decreased in the entire thickness while satisfying various functions such as prevention of the occurrence of a rainbow interference pattern in observation by polarized sunglasses, prevention of clouding of a liquid crystal display screen due to the occurrence of static electricity, and protection of the polarizer serving as a constituent member of the front panel and prevention of degradation thereof due to ultraviolet light as light from outside, as described above.

### EXAMPLES

Next, the present invention is described in more detail with reference to Examples, but the present invention is not intended to be limited to these Examples at all. In the Examples, “parts” and “%” are on a mass basis, unless particularly noted.

### Examples 1-1 to 1-5 and Comparative Examples 1-1 to 1-3 (Fabrication and Evaluation of Optical Laminate (I))

Each evaluation in Examples 1-1 to 1-5 and Comparative Examples 1-1 to 1-3 was performed as follows.

### [Thickness of Each of Transparent Conductive Layer and Surface Protection Layer]

The thickness of each of the transparent conductive layer and the surface protection layer was calculated by measuring the thickness at 20 points in an image of a cross section, taken by using a scanning transmission electron microscope (STEM), and calculating the average value of the values at such 20 points.

[Close Contact Property of Transparent Conductive Layer with Surface Protection Layer]

100 cells of 1-mm square cuts were made in a grid manner on a surface of the optical laminate fabricated in each of Examples and Comparative Examples, the surface being closer to the surface protection layer, Cellotape (registered trademark) No. 405 (for industry, 24 mm) manufactured by Nichiban Co., Ltd. was bonded thereto and closely contacted therewith by rubbing with a spatula, and rapid peeling was performed in a 90-degree direction three times. The peeling operation was performed under an environment of a temperature of 25±4° C. and a humidity of 50±10%. The remaining cell(s) was/were visually confirmed, and expressed in terms of % in Tables.

### [Transmittance of Optical Laminate]

The transmittance at each of wavelengths of 400 nm and 380 nm, of the optical laminate fabricated in each of Examples and Comparative Examples, was measured using an ultraviolet and visible spectrophotometer “UVPC-2450” (manufactured by Shimadzu Corporation). The measurement was performed under an environment of a temperature of 25±4° C. and a humidity of 50±10%, and the optical incidence surface corresponded to a surface closer to the substrate film.

### [Surface Resistivity]

The surface resistivity (Ω/ [symbol] ) of the surface protection layer surface of the optical laminate immediately after production was measured according to JIS K6911:1995. Measurement of the surface resistivity (Ω/ [symbol] ) was carried out using a high resistivity meter Hiresta UP MCP-HT450 (manufactured by Mitsubishi Chemical Corporation) and a URS probe MCP-HTP14 (manufactured by Mitsubishi Chemical Corporation) as a probe under an environment of a temperature of 25±4° C. and a humidity of 50±10% at an application voltage of 500 V.

### [Average Value and Standard Deviation of Surface Resistivity]

The optical laminate was cut out to a size of 80 cm×120 cm (area: 56.8 inches), straight lines (b) for equally longitudinally and transversely dividing a region (a) located 1.5 cm inward from the outer circumference of the optical laminate, by 4, were drawn on the surface protection layer of the optical laminate, as illustrated in FIG. 1, the surface resistivity was measured at the vertexes of the region (a), the intersections of the straight lines (b), and the intersections of four sides defining the region (a) and the straight lines (b) according to JIS K6911:1995, and the average value and the standard deviation of the measurement values at 25 points in total were determined. Such a measurement was performed using a high resistivity meter Hiresta UP MCP-HT450 (manufactured by Mitsubishi Chemical Corporation) and a URS probe MCP-HTP14 (manufactured by Mitsubishi Chemical Corporation) as a probe under an environment of a temperature of 25±4° C. and a humidity of 50±10% at an application voltage of 500 V.

### [Stability Over Time of Surface Resistivity]

The surface resistivity (Ω/ [symbol] ) after retention of the optical laminate at 80° C. for 250 hours was measured at 25 points in total by the same method as described above. The ratio (Surface resistivity after retention at 80° C. for 250 hours)/(Surface resistivity before retention at 80° C. for 250 hours and immediately after production) was calculated at each measurement point, and evaluated according to the following criteria.
A: the surface resistivity ratio is in the range of 0.50 to 2.0 at every measurement point
B: the surface resistivity ratio is in the range of 0.40 to 2.5 at every measurement point, and the surface resistivity ratio is 0.40 or more and less than 0.50, or more than 2.0 and 2.5 or less, at at least one measurement point
C: the surface resistivity ratio is less than 0.40 or more than 2.5 at at least one measurement point

### [Visibility]

The optical laminate obtained in each of Examples and Comparative Examples was bonded onto a capacitive in-cell touch panel-mounted liquid crystal display component embedded in “Xperia P” manufactured by Sony Ericsson with an adhesion layer having a thickness of 20 μm (a layer to which an adhesion layer of a double-sided adhesive sheet “non-carrier FC25K3E46” manufactured by Dai Nippon Printing Co., Ltd. was transferred) being interposed therebetween. A screen was turned into white display or substantial white display, and whether or not a rainbow interference pattern (rainbow pattern) could be visually viewed from various angles through commercially available polarized sunglasses or through a polarization plate was evaluated.
A: no rainbow pattern could be viewed
B: any rainbow pattern could be viewed

### [Clouding of Liquid Crystal Screen]

The optical laminate in each of Examples and Comparative Examples was bonded onto a capacitive in-cell touch panel-mounted liquid crystal display component embedded in “Xperia P” manufactured by Sony Ericsson with an adhesion layer having a thickness of 20 μm (a layer to which an adhesion layer of a double-sided adhesive sheet “non-carrier FC25K3E46” manufactured by Dai Nippon Printing Co., Ltd. was transferred) being interposed therebetween, and thereafter a conductor fixed to the transparent conductive layer of the optical laminate was connected to a conductive member. Next, a protection film (PET film) was further bonded onto the outermost surface of the optical laminate. Next, the protection film bonded was removed and a liquid crystal display device was driven immediately thereafter, and whether or not a clouding phenomenon occurred in touch with a hand was visually evaluated.
A: no clouding could be viewed
B: slight clouding was viewed in some cases, but it was extremely microscopic
C: clouding was remarkably viewed

### [Operability]

The optical laminate in each of Examples and Comparative Examples was bonded onto the above in-cell touch panel-mounted liquid crystal display component with an adhesion layer having a thickness of 20 μm (a layer to which an adhesion layer of a double-sided adhesive sheet “non-carrier FC25K3E46” manufactured by Dai Nippon Printing Co., Ltd. was transferred) being interposed therebetween. Next, whether or not a liquid crystal-touch sensor was driven without any failures when the outermost surface of the optical laminate was touched with a hand from above was visually evaluated.
A: driven without any problem
B: driven with any operation failure being slightly observed in some cases
C: not driven

### Production Example 1 (Preparation of Ionizing Radiation Curable Resin Composition a for Transparent Conductive Layer Formation)

50 parts by mass of dicyclopentenyl acrylate (manufactured by Hitachi Chemical Co., Ltd. “FA-511AS”) as the ionizing radiation curable resin (A), 50 parts by mass of pentaerythritol triacrylate (“KAYARAD PET-30” manufactured by Nippon Kayaku Co., Ltd.) as the ionizing radiation curable resin (B), 300 parts by mass of antimony tin oxide particles (“V3560” manufactured by JGC C&C, ATO dispersion, average primary particle size of ATO: 8 nm) as the conductive particles, 5 parts by mass of 1-hydroxy-cyclohexyl-phenyl-ketone (“Irgacure (Irg) 184” manufactured by BASF SE) as the photopolymerization initiator, and 4000 parts by mass of a solvent (methyl isobutyl ketone) were added and stirred, thereby preparing ionizing radiation curable resin composition A for transparent conductive layer formation, having a solid content concentration of 10% by mass.

### Production Example 2 (Preparation of Ionizing Radiation Curable Resin Composition B for Transparent Conductive Layer Formation)

The same manner was conducted as in ionizing radiation curable resin composition A except that 50 parts by mass of dicyclopentanyl methacrylate (manufactured by Hitachi Chemical Co., Ltd. “FA-513M”) was used as the ionizing radiation curable resin (A) instead of 50 parts by mass of dicyclopentenyl acrylate, thereby preparing ionizing radiation curable resin composition B for transparent conductive layer formation.

### Production Example 3 (Preparation of Ionizing Radiation Curable Resin Composition a for Surface Protection Layer Formation)

100 parts by mass of pentaerythritol triacrylate (“PET-30” manufactured by Nippon Kayaku Co., Ltd.) being an ionizing radiation curable resin and 10 parts by mass of a triazine-based ultraviolet absorber (“Tinuvin460” manufactured by BASF SE) were added into methyl isobutyl ketone so that the solid content concentration was 40% by mass, and the resultant was stirred to obtain solution a.

Next, 7 parts by mass of a photopolymerization initiator (“Irgacure (Irg) 184” manufactured by BASF SE) and 1.5 parts by mass of a photopolymerization initiator (“Lucirin TPO” manufactured by BASF SE) were added relative to 100 parts by mass of the solid content of solution a, and the resultant was stirred and dissolved, thereby preparing solution b having a final solid content concentration of 40% by mass.

Next, a leveling agent (“MEGAFAC RS71” manufactured by DIC CORPORATION) was added at a solid content rate of 0.4 parts by mass relative to 100 parts by mass of the solid content of solution b, and the resultant was stirred. Furthermore, a dispersion of gold-plated particles as the current carrying particles (bright dispersion manufactured by DNP Fine Chemicals Co., Ltd., average primary particle size of gold-plated particles: 4.6 μm, solid content concentration: 25% by mass) was added at a solid content of 2.5 parts by mass relative to 100 parts by mass of the solid content of the solution, and stirred, thereby preparing ionizing radiation curable resin composition A for surface protection layer formation.

### Example 1-1 (Fabrication of Optical Laminate (I))

### [Formation of Transparent Conductive Layer]

A cycloolefin polymer film having a thickness of 100 μm (“ZF14” manufactured by ZEON CORPORATION, ¼ wavelength phase difference film) was used as the substrate film, and the film was coated with the above-mentioned ionizing radiation curable resin composition A for transparent conductive layer formation by a slit reverse coating method so that the thickness after drying was 1 μm, thereby forming an uncured resin layer. The resulting uncured resin layer was dried at 80° C. for 1 minute, and thereafter cured by irradiation with ultraviolet light at an ultraviolet irradiation dose of 300 mJ/cm², thereby forming a transparent conductive layer having a thickness of 1.0 μm.

### [Formation of Surface Protection Layer]

The transparent conductive layer was coated with the above-mentioned ionizing radiation curable resin composition A for surface protection layer formation by a slit reverse coating so that the thickness after drying was 4.5 μm, thereby forming an uncured resin layer. The resulting uncured resin layer was dried at 80° C. for 1 minute, and thereafter cured by irradiation with ultraviolet light at an ultraviolet irradiation dose of 300 mJ/cm², thereby forming a surface protection layer having a thickness of 4.5 μm, to obtain an optical laminate.

The resulting optical laminate was subjected to the above evaluations. The evaluation results are shown in Table 1.

### Example 1-2

An optical laminate was fabricated in the same manner as in Example 1-1 except that ionizing radiation curable resin composition A for transparent conductive layer formation was changed to the above-mentioned ionizing radiation curable resin composition B, and the above evaluations were performed. The evaluation results are shown in Table 1.

### Example 1-3

An optical laminate was fabricated in the same manner as in Example 1-1 except that the substrate film was changed to a polyethylene terephthalate (PET) film having a thickness of 100 μm (“Cosmoshine A4100” manufactured by Toyobo Co., Ltd., optical anisotropic film), and the above evaluations were performed. The evaluation results are shown in Table 1.

### Example 1-4

An optical laminate was fabricated in the same manner as in Example 1-3 except that the thickness of the transparent conductive layer was changed as shown in Table 1, and the above evaluations were performed. The evaluation results are shown in Table 1.

### Example 1-5

An optical laminate was fabricated in the same manner as in Example 1-1 except that the thickness of the transparent conductive layer was changed as shown in Table 1, and the above evaluations were performed. The evaluation results are shown in Table 1.

### Comparative Example 1-1

An optical laminate was fabricated in the same manner as in Example 1-1 except that the thickness of the surface protection layer was changed as shown in Table 1, and the above evaluations were performed. The evaluation results are shown in Table 1.

### Comparative Example 1-2

An optical laminate was fabricated in the same manner as in Comparative Example 1-1 except that the thickness of the transparent conductive layer was changed as shown in Table 1, and the above evaluations were performed. The evaluation results are shown in Table 1.

### Comparative Example 1-3

An optical laminate was fabricated in the same manner as in Example 1-1 except that the substrate film was changed to a triacetyl cellulose (TAC) film having a thickness of 80 μm (“TD80UL” manufactured by FUJIFILM Corporation), and the above evaluations were performed. The evaluation results are shown in Table 1.

TABLE 1

| | | Example | | | | | Comparative Example | | |
|---|---|---|---|---|---|---|---|---|---|
| | | 1-1 | 1-2 | 1-3 | 1-4 | 1-5 | 1-1 | 1-2 | 1-3 |
| Optical | Substrate film | COP | COP | PET | PET | COP | COP | COP | TAC |
| laminate | Ionizing radiation curable resin | A | B | A | A | A | A | A | A |
| | composition for transparent | | | | | | | | |
| | conductive layer formation | | | | | | | | |
| | Ionizing radiation curable resin | A | A | A | A | A | A | A | A |
| | composition for surface protection | | | | | | | | |
| | layer formation | | | | | | | | |
| | Thickness (μm) of transparent | 1.0 | 1.0 | 1.0 | 2.0 | 0.4 | 1.0 | 0.2 | 1.0 |
| | conductive layer | | | | | | | | |
| | Thickness (μm) of surface | 4.5 | 4.5 | 4.5 | 4.5 | 4.5 | 11.0 | 11.0 | 4.5 |
| | protection layer | | | | | | | | |
| Evaluation | Close contact property of transparent | 100 | 100 | 100 | 100 | 100 | 100 | 20 | 100 |
| results | conductive layer | | | | | | | | |
| | Transmittance of optical laminate | 74.2 | 76.3 | 89.3 | 85.8 | 79.4 | 76.6 | 81.3 | 77.3 |
| | (%/wavelength: 400 nm) | | | | | | | | |
| | Transmittance of optical laminate | 21.3 | 18.9 | 20.6 | 21.0 | 19.7 | 22.3 | 20.4 | 5.7 |
| | (%/wavelength: 380 nm) | | | | | | | | |
| | Surface resistivity, average value (Ω/□) | 4.2E+08 | 3.6E+08 | 4.2E+08 | 5.4E+07 | 8.2E+09 | 6.2E+09 | 1.6E+10 | 2.1E+09 |
| | Surface resistivity, standard | 4.0E+07 | 9.0E+07 | 1.1E+08 | 6.5E+06 | 1.3E+08 | 7.7E+08 | 3.7E+09 | 6.4E+08 |
| | deviation σ (Ω/□) | | | | | | | | |
| | Stability over time of surface resistivity | A | B | B | A | B | B | C | B |
| | Visibility | A | A | B | B | A | A | A | A |
| | Clouding of liquid crystal screen | A | A | B | A | B | C | C | C |
| | Operability | A | B | A | B | B | C | C | C |

*COP: cycloolefin polymer film,
PET: polyethylene terephthalate film,
TAC: triacetyl cellulose film

As clear from Table 1, the optical laminate (I) of the present invention, when applied to a capacitive touch panel, was favorable in operability and also excellent in stability over time and visibility.

### Examples 2-1 to 2-2 and Comparative Examples 2-1 to 2-2 (Fabrication and Evaluation of Optical Laminate (II))

Each evaluation in Examples 2-1 to 2-2 and Comparative Examples 2-1 to 2-2 was performed as follows.

Herein, the evaluation methods of the thickness of each of the transparent conductive layer and the surface protection layer, the close contact property, and the transmittance, the surface resistivity, the average value and the standard deviation of the surface resistivity of the optical laminate are the same as described above.

### [Rate of Elongation]

A simple cycloolefin polymer film, or the optical laminate fabricated in each of Examples and Comparative Examples was cut out to a size of 5 mm in width and 20 mm in length to fabricate a test piece. The rate of elongation at a temperature of 150° C., of the test piece, was measured using a dynamic viscoelasticity measuring apparatus “Rheogel-E4000” (manufactured by UBM). The measurement conditions are as described below.

### (Measurement Conditions)

Frequency: 10 Hz
Tensile load: 50 N
Vibration state: continuous vibration
Control of strain: 10 μm
Measurement temperature range: 25° C. to 200° C.
Rate of temperature increase: 2° C./min

### [Strain Value]

The laminated article of the substrate film and the transparent conductive layer, fabricated in each of Examples and Comparative Examples, was cut out to a size of 15 mm in width and 150 mm in length to fabricate a test piece. The test piece was installed to a tensile tester, and subjected to a tensile test according to JIS K7161-1:2014. The distance between reference lines was set to 50 mm, the test piece was pulled at a constant tensile speed of 0.5 mm/min at a temperature of 23±2° C., and the elongation (mm) and the load (N) were measured to calculate the strain value and the stress from the following expression. Such a measurement was performed five times to determine the average value of the strain value at the upper yield point in the stress-strain curve.

$$Strain value ( \% ) = elongation ( mm ) / 50 ( mm ) \times 100$$

$$Stress ( MPa ) = load ( N ) / cross - sectional area ( {mm}^{2} ) of laminated article$$

### Example 2-1 (Production of Optical Laminate (II))

### [Formation of Transparent Conductive Layer]

A cycloolefin polymer film having a thickness of 100 μm (“ZF14” manufactured by ZEON CORPORATION, ¼ wavelength phase difference film) was used as the substrate film, the film was coated with the above-mentioned ionizing radiation curable resin composition A for transparent conductive layer formation by a slit reverse coating method so that the thickness after drying was 1.0 μm, thereby forming an uncured resin layer. The resulting uncured resin layer was dried at 80° C. for 1 minute, and thereafter cured by irradiation with ultraviolet light at an ultraviolet irradiation dose of 300 mJ/cm², thereby forming a transparent conductive layer having a thickness of 1.0 μm.

### [Formation of Surface Protection Layer]

The transparent conductive layer was coated with the above-mentioned ionizing radiation curable resin composition A for surface protection layer formation by a slit reverse coating so that the thickness after drying was 4.5 μm, thereby forming an uncured resin layer. The resulting uncured resin layer was dried at 80° C. for 1 minute, and thereafter cured by irradiation with ultraviolet light at an ultraviolet irradiation dose of 300 mJ/cm², thereby forming a surface protection layer having a thickness of 4.5 μm, to obtain an optical laminate.

The resulting optical laminate was subjected to the above evaluations. The evaluation results are shown in Table 2.

### Example 2-2 and Comparative Examples 2-1 to 2-2

Each optical laminate was fabricated by the same method as in Example 2-1 except that the material composing the optical laminate and the configuration were changed as shown in Table 2, and the above evaluations were performed. The results are shown in Table 2.

TABLE 2

| | | | | | | Comparative | |
|---|---|---|---|---|---|---|---|
| | | | | Example | | Example | |
| | | | | 2-1 | 2-2 | 2-1 | 2-2 |
| Optical | Substrate film | | Type | COP1 | COP2 | COP3 | COP1 |
| laminate | | | Thickness (μm) | 100 | 47 | 60 | 100 |
| | Transparent | Ionizing radiation curable resin composition | | A | A | A | A |
| | conductive | Ionizing radiation curable | FA-511AS | 50 | 50 | 0 | 50 |
| | layer | resin (A) (parts by mass) | | | | | |
| | | Ionizing radiation curable | PET-30 | 50 | 50 | 100 | 50 |
| | | resin (B) (parts by mass) | | | | | |
| | | Conductive particles (parts | ATO particles | 300 | 300 | 300 | 300 |
| | | by mass) | | | | | |
| | | Photopolymerization | Irg184 | 5 | 5 | 5 | 5 |
| | | initiator (parts by mass) | | | | | |
| | | Solvent (parts by mass) | MIBK | 4000 | 4000 | 4000 | 4000 |

| | | Thickness (μm) | 1.0 | 1.0 | 1.0 | 1.0 |
|---|---|---|---|---|---|---|
| | Surface protection | Ionizing radiation curable resin composition | A | A | A | A |
| | layer | Thickness (μm) | 4.5 | 4.5 | 4.5 | 25.0 |
| | Ratio (%) of thickness of substrate film to thickness of entire | | 95 | 90 | 92 | 79 |
| | optical laminate | | | | | |
| Evaluation | Rate of elongation at 150° C. of optical laminate | | 8.0 | 10.7 | 1.4 | 4.6 |
| results | Close contact property | | 100 | 100 | 0 | 50 |
| | Transmittance (%/wavelength: 400 nm) | | 74.2 | 73.6 | 77.2 | 74.7 |
| | Transmittance (%/wavelength: 380 nm) | | 21.3 | 20.9 | 19.4 | 21.8 |
| | In-plane uniformity | Average value of surface resistivity (Ω/□) | 4.2E+08 | 3.4E+08 | 3.9E+08 | >1.0E+13 |
| | of surface resistivity | Standard deviation of surface resistivity | 4.0E+07 | 2.2E+07 | 3.8E+07 | — |
| | | (Ω/□) | | | | |

| | | | | |
|---|---|---|---|---|
| Strain value at upper yield point of substrate | 7.9 | 3.6 | 8.3 | 7.9 |
| film + transparent conductive layer | | | | |

Each component shown in Table 2 is as follows. Parts by mass shown in Table 2 means parts by mass in terms of the solid content.

### Cycloolefin Polymer Film

COP1; “ZF14” manufactured by ZEON CORPORATION, thickness: 100 μm, rate of elongation at a temperature of 150° C.: 9.9%
COP2; “ZD12” manufactured by ZEON CORPORATION, thickness: 47 μm, rate of elongation at a temperature of 150° C.: 12%
COP3; “ZD16” manufactured by ZEON CORPORATION, thickness: 60 μm, rate of elongation at a temperature of 150° C.: 3.3%

### Ionizing Radiation Curable Resin (A)

Dicyclopentenyl acrylate; “FA-511AS” manufactured by Hitachi Chemical Co., Ltd.

### Ionizing Radiation Curable Resin (B)

Pentaerythritol triacrylate; “PET-30” manufactured by Nippon Kayaku Co., Ltd., tri- to tetrafunctional polymerizable monomer, weight average molecular weight:

### Conductive Particles

Antimony tin oxide particles (“V3560” manufactured by JGC C&C, ATO dispersion, average primary particle size of ATO: 8 nm)

### Photopolymerization Initiator

1-Hydroxy-cyclohexyl-phenyl-ketone; “Irgacure (Irg) 184” manufactured by BASF SE

### Solvent

Methyl isobutyl ketone (MIBK)

### Reference Example; Measurement of Infrared Spectroscopy Spectrum

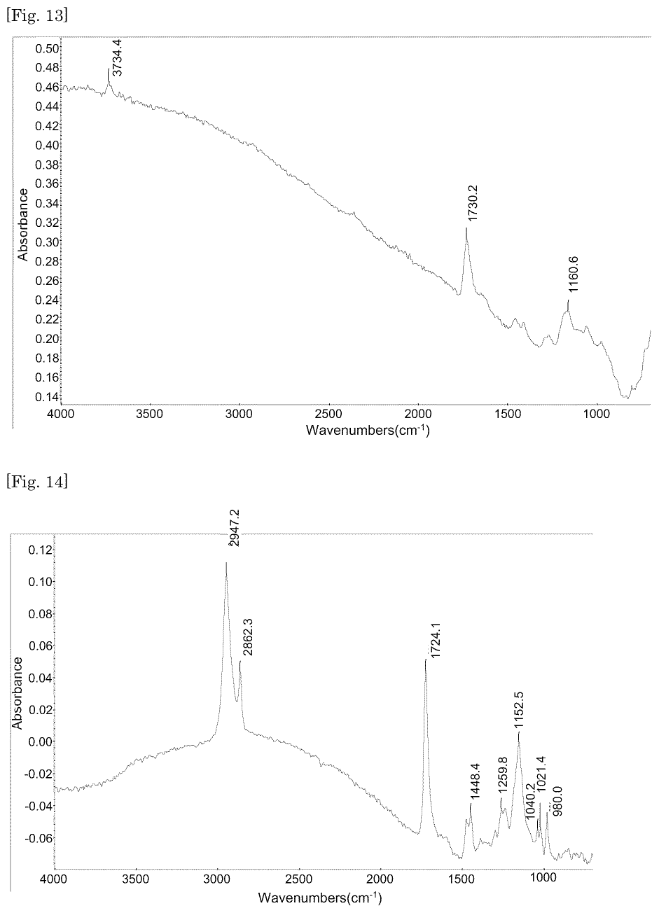

The cycloolefin polymer film and ionizing radiation curable resin composition A for transparent conductive layer formation, used in Example 2-1, were used. The cycloolefin polymer film (manufactured by ZEON CORPORATION “ZF14”) used in Example 2-1 was coated with ionizing radiation curable resin composition A for transparent conductive layer formation by a slit reverse coating method so that the thickness after drying was 1.0 μm, thereby forming an uncured resin layer. The resulting uncured resin layer was dried at 80° C. for 1 minute, and thereafter cured by irradiation with ultraviolet light at an ultraviolet irradiation dose of 300 mJ/cm². The resulting cured layer was collected by a knife, and an IR spectrum was measured by a transmission method with an infrared spectrometer (“NICOLET 6700” manufactured by Thermo Fisher Scientific Inc.) (FIG. 13).

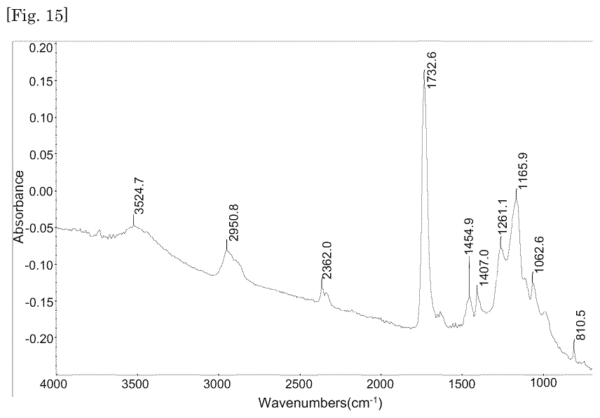

On the other hand, each of a cured product of ionizing radiation curable resin composition A1 where 5 parts by mass of “Irgacure 184” being a photopolymerization initiator was added to 100 parts by mass of ionizing radiation curable resin (A) (FA-511AS) contained in ionizing radiation resin composition A for transparent conductive layer formation, and a cured product of ionizing radiation curable resin composition B1 where 5 parts by mass of “Irgacure 184” being a photopolymerization initiator was added to 100 parts by mass of ionizing radiation curable resin (B) (PET-30) was fabricated, a cured layer was fabricated and collected by the same method, and an IR spectrum was measured by a transmission method (FIGS. 14 and 15).

As can be seen from FIGS. 13 to 15, an absorption at around 3000 cm⁻¹, derived from the alicyclic structure in ionizing radiation curable resin (A), illustrated in FIG. 14 is rarely observed in the IR spectrum (FIG. 13) obtained by measurement of the transparent conductive layer collected. It can be expected from this that ionizing radiation curable resin (A) is selectively transferred to and wetted into the cycloolefin polymer film.

### Examples 3-1 to 3-4 and Comparative Examples 3-1 to 3-2 (Fabrication and Evaluation of Optical Laminate (III))

Each evaluation in Examples 3-1 to 3-4 and Comparative Examples 3-1 to 3-2 was performed as follows.

The evaluation methods of the transmittance of the optical laminate and the operability are the same as described above.

### [Thickness of Each of Conductive Layer and Stabilization Layer]

The thickness of each of the conductive layer and the stabilization layer was calculated by measuring the thickness at 20 points in an image of a cross section, taken by using a scanning transmission electron microscope (STEM), and calculating the average value of the values at such 20 points.

[Close Contact Property of Conductive Layer with Stabilization Layer]

100 cells of 1-mm square cuts were made in a grid manner on a surface of the optical laminate fabricated in each of Examples and Comparative Examples, the surface being closer to the conductive layer, Cellotape (registered trademark) No. 405 (for industry, 24 mm) manufactured by Nichiban Co., Ltd. was bonded thereto and closely contacted therewith by rubbing with a spatula, and rapid peeling was performed in a 90-degree direction three times. The peeling operation was performed under an environment of a temperature of 25±4° C. and a humidity of 50±10%. The remaining cell(s) was/were visually confirmed, and expressed in terms of % in Table 3.

### [Surface Resistivity]

The surface resistivity (Ω/ [symbol] ) of the conductive layer surface of the optical laminate immediately after production was measured according to JIS K6911:1995. Measurement of the surface resistivity (Ω/ [symbol] ) was carried out using a high resistivity meter Hiresta UP MCP-HT450 (manufactured by Mitsubishi Chemical Corporation) and a URS probe MCP-HTP14 (manufactured by Mitsubishi Chemical Corporation) as a probe under an environment of a temperature of 25±4° C. and a humidity of 50±10% at an application voltage of 500 V.

### [Average Value and Standard Deviation of Surface Resistivity]

The optical laminate was cut out to a size of 80 cm×120 cm (area: 56.8 inches), straight lines (b) for equally longitudinally and transversely dividing a region (a) located 1.5 cm inward from the outer circumference of the optical laminate, by 4, were drawn on the conductive layer of the optical laminate, as illustrated in FIG. 1, the surface resistivity was measured at the vertexes of the region (a), the intersections of the straight lines (b), and the intersections of four sides defining the region (a) and the straight lines (b) according to JIS K6911:1995, and the average value and the standard deviation of the measurement values at 25 points in total were determined. Such a measurement was performed using a high resistivity meter Hiresta UP MCP-HT450 (manufactured by Mitsubishi Chemical Corporation) and a URS probe MCP-HTP 14 (manufactured by Mitsubishi Chemical Corporation) as a probe under an environment of a temperature of 25±4° C. and a humidity of 50±10% at an application voltage of 500 V.

### [Stability Over Time of Surface Resistivity]

The surface resistivity (Ω/ [symbol] ) after retention of the optical laminate at 80° C. for 250 hours was measured at 25 points in total by the same method as described above. The ratio (Surface resistivity after retention at 80° C. for 250 hours)/(Surface resistivity before retention at 80° C. for 250 hours and immediately after production) was calculated at each measurement point, and evaluated according to the following criteria.
A: the surface resistivity ratio is in the range of 0.50 to 2.0 at every measurement point
B: the surface resistivity ratio is in the range of 0.40 to 2.5 at every measurement point, and the surface resistivity ratio is 0.40 or more and less than 0.50, or more than 2.0 and 2.5 or less, at at least one measurement point
C: the surface resistivity ratio is less than 0.40 or more than 2.5 at at least one measurement point

### [Visibility (Presence or Absence of Interference Fringe)]

A black tape (plastic tape No. 200-38-21 manufactured by Yamato Co., Ltd., black, width: 38 mm) was bonded to a surface of the optical laminate in each of Examples and Comparative Examples, the surface being closer to the substrate film, and the presence or absence of an interference fringe pattern was visually confirmed on an opposite surface thereto (the surface being closer to the conductive layer).
A: no interference fringe pattern could be viewed
B: any interference fringe pattern with no color unevenness could be viewed
C: any interference fringe pattern with color unevenness could be viewed

### [Touch Panel Sensitivity]

The optical laminate in each of Examples and Comparative Examples was bonded onto a capacitive in-cell touch panel-mounted liquid crystal display component embedded in “Xperia P” manufactured by Sony Ericsson with an adhesion layer having a thickness of 20 μm (a layer to which an adhesion layer of a double-sided adhesive sheet “non-carrier FC25K3E46” manufactured by Dai Nippon Printing Co., Ltd. was transferred) being interposed therebetween, and thereafter a conductor fixed to the transparent conductive layer of the optical laminate was connected to a conductive member. Next, a protection film (PET film) was further bonded onto the outermost surface of the optical laminate. Next, the protection film bonded was removed and a liquid crystal display device was driven immediately thereafter, and the probability of the occurrence of an operational error in touching of the above-mentioned each measurement point of the surface resistivity with a hand wearing a glove (“smartphone glove Smart Touch” manufactured by Midori Anzen Co., Ltd.) was counted, and evaluated according to the following criteria.
A: the error probability is 0% or more and less than 20%
B: the error probability is 20% or more and less than 60%
C: the error probability is 60% or more

### Production Example 4 (Preparation of Ionizing Radiation Curable Resin Composition a for Stabilization Layer Formation)

100 parts by mass of pentaerythritol triacrylate (“PET-30” manufactured by Nippon Kayaku Co., Ltd.) being an ionizing radiation curable resin was added into methyl isobutyl ketone so that the solid content concentration was 15% by mass, and the resultant was stirred to obtain solution a.

Next, 7 parts by mass of a photopolymerization initiator (“Irgacure (Irg) 184” manufactured by BASF SE) and 1.5 parts by mass of a photopolymerization initiator (“Lucirin TPO” manufactured by BASF SE) were added relative to 100 parts by mass of the solid content of solution a, and the resultant was stirred and dissolved, thereby preparing solution b having a final solid content concentration of 15% by mass.

Next, a leveling agent (“MEGAFAC RS71” manufactured by DIC CORPORATION) was added at a solid content rate of 0.4 parts by mass relative to 100 parts by mass of the solid content of solution b, and stirred, thereby preparing ionizing radiation curable resin composition A for stabilization layer formation.

### Production Example 5 (Preparation of Ionizing Radiation Curable Resin Composition a for Conductive Layer Formation)

100 parts by mass of pentaerythritol triacrylate (“KAYARAD PET-30” manufactured by Nippon Kayaku Co., Ltd.) being an ionizing radiation curable resin, 100 parts by mass of antimony tin oxide particles (“V3560” manufactured by JGC C&C, ATO dispersion, average primary particle size of ATO: 8 nm) being conductive particles, 5 parts by mass of 1-hydroxy-cyclohexyl-phenyl-ketone (“Irgacure (Irg) 184” manufactured by BASF SE) being a photopolymerization initiator, and 1100 parts by mass of a solvent (methyl isobutyl ketone) were added and stirred, thereby preparing ionizing radiation curable resin composition A for conductive layer formation, having a solid content concentration of 15% by mass.

### Production Example 6 (Preparation of Ionizing Radiation Curable Resin Composition B for Conductive Layer Formation)

The same manner was conducted as in ionizing radiation curable resin composition A for conductive layer formation except that 50 parts by mass of pentaerythritol triacrylate (“KAYARAD PET-30” manufactured by Nippon Kayaku Co., Ltd.) was used as the ionizing radiation curable resin instead of 100 parts by mass of pentaerythritol triacrylate (“KAYARAD PET-30” manufactured by Nippon Kayaku Co., Ltd.) and 50 parts by mass of an acrylic polymer (“HRAG acrylic (25) MIBK” manufactured by DNP Fine Chemicals Co., Ltd.) was used as the thermoplastic resin, thereby preparing ionizing radiation curable resin composition B for conductive layer formation, having a solid content concentration of 15% by mass.

### Production Example 7 (Preparation of Ionizing Radiation Curable Resin Composition C for Conductive Layer Formation)

The same manner was conducted as in ionizing radiation curable resin composition A for conductive layer formation except that the amount of the antimony tin oxide particles (“V3560” manufactured by JGC C&C, ATO dispersion, average primary particle size of ATO: 8 nm) being conductive particles was changed from 100 parts by mass to 20 parts by mass, thereby preparing ionizing radiation curable resin composition C for conductive layer formation, having a solid content concentration of 15% by mass.

### Example 3-1 (Fabrication of Optical Laminate (III))

### [Formation of Stabilization Layer]

A triacetyl cellulose film having a thickness of 80 μm (“TD80UL” manufactured by FUJIFILM Corporation) was used as the substrate film, and the film was coated with the above-mentioned ionizing radiation curable resin composition A for stabilization layer formation by a slit reverse coating method, thereby forming an uncured resin layer. The resulting uncured resin layer was dried at 80° C. for 1 minute, and thereafter cured by irradiation with ultraviolet light at an ultraviolet irradiation dose of 300 mJ/cm², thereby forming a stabilization layer having a thickness of 1.0 μm.

### [Formation of Conductive Layer]

The stabilization layer was coated with the above-mentioned ionizing radiation curable resin composition A for conductive layer formation by a slit reverse coating method so that the thickness after drying was 4.0 μm, thereby forming an uncured resin layer. The resulting uncured resin layer was dried at 80° C. for 1 minute, and thereafter cured by irradiation with ultraviolet light at an ultraviolet irradiation dose of 300 mJ/cm², thereby forming a conductive layer having a thickness of 4.0 μm, to obtain an optical laminate.

The resulting optical laminate was subjected to the above evaluations. The evaluation results are shown in Table 3.

### Examples 3-2 to 3-4

Each optical laminate was fabricated in the same manner as in Example 3-1 except that the type of the ionizing radiation curable resin composition for conductive layer formation, and the thickness of each of the stabilization layer and the conductive layer were changed as shown in Table 3, and the above evaluations were performed. The evaluation results are shown in Table 3.

### Comparative Example 3-1

An optical laminate was fabricated in the same manner as in Example 3-2 except that no stabilization layer was formed, and the above evaluations were performed. The evaluation results are shown in Table 3.

### Comparative Example 3-2

An optical laminate was fabricated in the same manner as in Example 3-2 except that the type of the ionizing radiation curable resin composition for conductive layer formation was changed, and the above evaluations were performed. The evaluation results are shown in Table 3.

TABLE 3

| | | | | | | Comparative | |
|---|---|---|---|---|---|---|---|
| | | Example | | | | Example | |
| | | 3-1 | 3-2 | 3-3 | 3-4 | 3-1 | 3-2 |
| Optical | Substrate film | TAC | TAC | TAC | TAC | TAC | TAC |
| laminate | Ionizing radiation curable resin | A | A | A | A | — | A |
| | composition for stabilization layer | | | | | | |
| | formation | | | | | | |
| | Ionizing radiation curable resin | A | A | B | B | A | C |
| | composition for conductive layer | | | | | | |
| | formation | | | | | | |
| | Thickness (μm) of stabilization | 1.0 | 5.0 | 5.0 | 8.0 | — | 5.0 |
| | layer | | | | | | |
| | Thickness (μm) of conductive layer | 4.0 | 2.0 | 2.0 | 1.0 | 2.0 | 2.0 |
| Evaluation | Close contact property | 100 | 100 | 100 | 100 | 100 | 90 |
| results | Transmittance of optical laminate | 67.7 | 67.0 | 67.8 | 67.4 | 67.3 | 67.3 |
| | (%/wavelength: 400 nm) | | | | | | |
| | Transmittance of optical laminate | 3.8 | 3.8 | 3.7 | 3.6 | 3.7 | 3.7 |
| | (%/wavelength: 380 nm) | | | | | | |
| | Surface resistivity, average value | 6.3E+08 | 8.2E+09 | 4.5E+10 | 9.0E+11 | 1.6E+08 | 2.9E+10 |
| | (Ω/□) | | | | | | |
| | Surface resistivity, standard | 3.9E+07 | 4.9E+08 | 5.0E+09 | 1.2E+11 | 5.4E+07 | 6.2E+09 |
| | deviation σ (Ω/□) | | | | | | |
| | [Standard deviation σ]/[average | 0.06 | 0.06 | 0.11 | 0.13 | 0.34 | 0.21 |
| | value] | | | | | | |
| | Stability over time of surface | A | A | A | A | C | A |
| | resistivity | | | | | | |
| | Visibility | A | A | B | B | C | C |
| | Operability | A | A | A | B | C | C |
| | Touch panel sensitivity | B | B | A | A | C | C |

*TAC: triacetyl cellulose film

As clear from Table 3, the optical laminate (III) of the present invention was favorable in operability and also excellent in stability over time in application to a capacitive touch panel. On the other hand, the optical laminate comprising no stabilization layer as described in Comparative Example 3-1 was large in the variability in surface resistivity, was reduced in visibility, and was also reduced in operability in application to a capacitive touch panel. Furthermore, the stability over time of the surface resistivity was also reduced. In addition, as described in Comparative Example 3-2, even if the average value of the surface resistivity of the optical laminate was in the range of 1.0×10⁷Ω/ [symbol] or more and 1.0×10¹²Ω/ [symbol] or less, visibility and the operability in application to a capacitive touch panel were again reduced when the predetermined conditions were not satisfied.

### Examples 4-1 to 4-5 and Comparative Example 4-1 (Production of Optical Laminate and Transparent Laminate)

Each evaluation in Examples 4-1 to 4-5 and Comparative Example 4-1 was performed as follows.

### [Thickness of Each of Transparent Conductive Layer, Surface Protection Layer and Pressure-Sensitive Adhesion Layer]

The thickness of each of the transparent conductive layer, the surface protection layer and the pressure-sensitive adhesion layer was calculated by measuring the thickness at 20 points in an image of a cross section, taken by using a scanning transmission electron microscope (STEM), and calculating the average value of the values at such 20 points.

### [Vertical Distance (Deflection) Defined in Condition (1)]

A laminate comprising a substrate film, a pressure-sensitive adhesion layer, and a rear surface film was cut out to a size of 25 mm in width and 100 mm in length. A portion of this sample, corresponding to a portion from one end to 25 mm in the length direction of the sample, was sandwiched using two 100-mm square glass plates having a thickness of 2 mm, and a 1-kg weight was put thereon and secured on a horizontal table. The remaining portion of the sample, coming out from an end portion of the glass plates and corresponding to a length of 75 mm, was deformed by the own weight, and the vertical distance from the secured portion of the sample to other end of the sample in the length direction was measured.

The vertical distance (deflection) of each of a simple substrate film, and a laminated article comprising a pressure-sensitive adhesion layer and a rear surface film was measured in the same manner.

### [Tensile Elastic Modulus]

A No. 1 dumbbell test piece was fabricated from each film for measurement, according to JIS K6251:2010. The test piece was installed to a tensile tester (Tensilon RTG1310 manufactured by A&D Company, Limited), and subjected to a tensile test according to JIS K7161-1:2014. The distance between reference lines was set to 80 mm, the test piece was pulled at a constant tensile speed of 5 mm/min at a temperature of 23±2° C., and the elongation (mm) and the load (N) were measured to calculate the strain and the stress from the following expression. The tensile elastic modulus (N/mm²) was calculated from a slope of the stress-strain curve, the slope being observed immediately after the start of the tensile test.

$$Strain ( \% ) = elongation ( mm ) / 50 ( mm ) \times 100$$

$$Stress ( MPa ) = load ( N ) / cross - sectional area ( {mm}^{2} ) of test piece$$

### [Total Light Transmittance and Haze]

The total light transmittance and the haze were measured using HM-150 (manufactured by Murakami Color Research Laboratory Co., Ltd.). The total light transmittance was measured according to JIS K7361-1:1997, and the haze was measured according to JIS K7136:2000. The measurements were performed under an environment of a temperature of 25±4° C. and a humidity of 50±10%, and the optical incidence surface corresponded to a surface closer to the substrate film.

### [In-Plane Uniformity of Surface Resistivity]

The optical laminate was cut out to a size of 80 cm×120 cm (area: 56.8 inches), straight lines (b) for equally longitudinally and laterally dividing a region (a) located 1.5 cm inward from the outer circumference of the optical laminate, by 4, were drawn on the surface protection layer of the optical laminate, as illustrated in FIG. 1, the surface resistivity (Ω/ [symbol] ) was measured at the vertexes of the region (a), the intersections of the straight lines (b), and the intersections of four sides defining the region (a) and the straight lines (b) according to JIS K6911:1995, and the average value and the standard deviation of the measurement values at 25 points in total were determined. Such a measurement was performed using a high resistivity meter Hiresta UP MCP-HT450 (manufactured by Mitsubishi Chemical Corporation) and a URS probe MCP-HTP14 (manufactured by Mitsubishi Chemical Corporation) as a probe under an environment of a temperature of 25±4° C. and a humidity of 50±10% at an application voltage of 500 V.

The average values of the surface resistivities in the Examples were all at the same level, and it was thus determined that, as the standard deviation value of the surface resistivity was smaller, the in-plane uniformity was more favorable. Specifically, the in-plane uniformity of the surface resistivity was evaluated according to the following criteria.
A: the standard deviation of the surface resistivity is 2.00×10⁷Ω/ [symbol] or less
B: the standard deviation of the surface resistivity is more than 2.00×10⁷Ω/

[symbol]

### [Easiness of Examination]

The transparent laminate obtained in each Example was used to carry out a fault test of the optical laminate under a fluorescent lamp in a light room, and evaluation was made according to the following criteria.
A: any fault is easy to confirm
B: any fault is difficult to confirm
C: any fault is very difficult to confirm or unable to be confirmed

### Example 4-1 (Production of Optical Laminate and Transparent Laminate)

An acrylic pressure-sensitive adhesive (“LA2140” manufactured by Kuraray Co., Ltd.) was dissolved in a solvent [methyl ethyl ketone/toluene (solvent mixing ratio=1:1 on a mass basis)] so that the solid content was 20% (mass basis), thereby preparing a coating liquid of the pressure-sensitive adhesive. A biaxially oriented polyester film being a rear surface film and having a thickness of 38 μm was coated with the coating liquid of the pressure-sensitive adhesive by a coater so that the thickness after drying was 15 μm, and dried at 100° C. for 1 minute, thereby fabricating a laminate of the rear surface film and a pressure-sensitive adhesion layer.

The initial pressure-sensitive adhesion force between the pressure-sensitive adhesion layer and the rear surface film was 70 mN/25 mm.

Next, one surface of a cycloolefin polymer film having a thickness of 47 μm (“ZF14” manufactured by ZEON CORPORATION, a ¼ wavelength phase difference film obliquely oriented) being a substrate film and a surface of the laminate, the surface being closer to the pressure-sensitive adhesion layer were bonded, and the rear surface film was laminated on the substrate film with the pressure-sensitive adhesion layer being interposed therebetween.

Next, other surface of the substrate film was coated with the above-mentioned ionizing radiation curable resin composition A for transparent conductive layer formation by a slit reverse coating method so that the thickness after drying was 1 μm, thereby forming an uncured resin layer. The resulting uncured resin layer was dried at 80° C. for 1 minute, and thereafter cured by irradiation with ultraviolet light at an ultraviolet irradiation dose of 300 mJ/cm², thereby forming a transparent conductive layer having a thickness of 1 μm.

The transparent conductive layer was coated with the above-mentioned ionizing radiation curable resin composition A for surface protection layer formation by a slit reverse coating so that the thickness after drying was 4.5 μm, thereby forming an uncured resin layer. The resulting uncured resin layer was dried at 80° C. for 1 minute, and thereafter cured by irradiation with ultraviolet light at an ultraviolet irradiation dose of 300 mJ/cm², thereby forming a surface protection layer having a thickness of 4.5 μm, to obtain an optical laminate (transparent laminate) comprising the rear surface film and the pressure-sensitive adhesion layer.

The resulting transparent laminate was evaluated as described above. The evaluation results are shown in Table 4. The standard deviation of the surface resistivity was 1.77×10⁷Ω/ [symbol] .

### Examples 4-2 to 4-5 and Comparative Example 4-1

Each optical laminate and a transparent laminate were produced by the same method as in Example 4-1 except that the thickness of the pressure-sensitive adhesion layer and the type of the rear surface film were changed as shown in Table 4. The evaluation results are shown in Table 4. In Comparative Example 4-1, the standard deviation of the surface resistivity was 2.10×10⁷Ω/ [symbol] .

TABLE 4

| | | | | | | | | Comparative |
|---|---|---|---|---|---|---|---|---|
| | | | Example | | | | | Example |
| | | | 4-1 | 4-2 | 4-3 | 4-4 | 4-5 | 4-1 |
| Constituent | Substrate | Type | COP | COP | COP | COP | COP | COP |
| members and | film | Thickness (μm) | 47 | 25 | 47 | 47 | 47 | 47 |
| physical properties | | Deflection (vertical | 49 | 65 | 49 | 49 | 49 | 49 |
| of transparent | | distance/mm), MD | | | | | | |
| laminate | | direction | | | | | | |
| | | Deflection (vertical | 49 | 64 | 49 | 49 | 49 | 49 |
| | | distance/mm), TD | | | | | | |
| | | direction | | | | | | |
| | | Tensile elastic | 2200 | 1096 | 2200 | 2200 | 2200 | 2200 |
| | | modulus (N/mm²) | | | | | | |
| | Ionizing radiation curable resin | | A | A | A | A | A | A |
| | composition for transparent | | | | | | | |
| | conductive layer formation | | | | | | | |
| | Ionizing radiation curable resin | | A | A | A | A | A | A |
| | composition for surface protection | | | | | | | |
| | layer formation | | | | | | | |
| | Pressure- | Thickness (μm) | 15 | 15 | 22 | 5 | 3 | 1 |
| | sensitive | | | | | | | |
| | adhesion | | | | | | | |
| | Rear surface | Type | A: PET | A: PET | B: PET | B: PET | C: PP | D: PE |
| | film | Thickness (μm) | 38 | 38 | 38 | 38 | 35 | 30 |
| Physical properties | Total thickness of pressure- | | 53 | 53 | 60 | 43 | 38 | 31 |
| of pressure- | sensitive adhesion + rear surface | | | | | | | |
| sensitive adhesion + | film (μm) | | | | | | | |
| rear surface film | Tensile elastic modulus (N/mm²) | | 3683 | 3683 | 2900 | 5103 | 868 | 158 |
| | Deflection (vertical distance/mm), | | 53 | 53 | 54 | 50 | 66 | 72 |
| | TD direction | | | | | | | |
| | Total light transmittance (%) | | 90.1 | 90.1 | 92.0 | 90.4 | 90.7 | 84.5 |
| | Haze (%) | | 2.8 | 2.8 | 4.5 | 2.8 | 23.0 | 68.5 |
| Physical properties | Deflection (vertical distance in | | 17 | 26 | 17 | 19 | 30 | 55 |
| of laminate | condition (1)), MD direction | | | | | | | |
| (substrate film + | Deflection (vertical distance in | | 15 | 22 | 20 | 20 | 32 | 55 |
| pressure-sensitive | condition (1)), TD direction | | | | | | | |
| adhesion + rear | | | | | | | | |
| surface film) | | | | | | | | |
| Evaluation results | Surface | Average value | 3.27 | 3.20 | 3.14 | 3.24 | 3.25 | 3.55 |
| | resistivity | (×10⁸Ω/□) | | | | | | |
| | | In-plane uniformity | A | A | A | A | A | B |

| | | | | | | |
|---|---|---|---|---|---|---|
| Easiness of examination | A | A | A | A | B | C |

*COP: cycloolefin polymer film
*PET: polyethylene terephthalate,
PP: polypropylene,
PE: polyethylene

### INDUSTRIAL APPLICABILITY

The optical laminate according to the first invention is favorable in in-plane uniformity of surface resistivity, and therefore is suitably used particularly in a member constituting an image display device on which a capacitive touch panel is mounted. The touch panel comprising the optical laminate thus exhibits stable operability.

The optical laminate according to the second invention has an elongation property in a predetermined range, therefore is excellent in the close contact property between a cycloolefin polymer film serving as the substrate film and the transparent conductive layer and also favorable in in-plane uniformity of surface resistivity, and thus is suitably used particularly in a member constituting the front panel of an image display device on which a capacitive touch panel is mounted. The touch panel comprising the optical laminate thus exhibits stable operability. When a ¼ wavelength phase difference film obliquely oriented is used as the cycloolefin polymer film in the optical laminate, visibility through polarized sunglasses is also favorable and continuous production by a roll-to-roll method can also be made.

Furthermore, the optical laminate according to the second invention is also favorable in visible light transmission property because the ratio of the thickness of the substrate film to the total thickness is 80% or more.

The optical laminate according to the third invention is favorable in in-plane uniformity of surface resistivity even in use of a cellulose-based substrate film as the substrate film, and therefore is suitably used particularly in a member constituting an image display device on which a capacitive touch panel is mounted. The touch panel comprising the optical laminate thus exhibits stable operability.

According to the method for producing an optical laminate according to the fourth invention, an optical laminate favorable in in-plane uniformity of surface resistivity can be produced even when a substrate film having no stiffness and having a low strength is used for production of an optical laminate comprising a substrate film, a transparent conductive layer and a surface protection layer. The optical laminate is suitably used particularly in a member constituting an image display device on which a capacitive touch panel is mounted.

Reference Signs List

| | |
|---|---|
| 1, 1A, 1B, 1C, 1D | optical laminate |
| 1′ | transparent laminate |
| 2A, 2D | substrate film |
| 2B, 2C | cellulose-based substrate film |
| 3A, 3D | transparent conductive layer |
| 4A, 4D | surface protection layer |
| 41A, 41D | current carrying particle |
| 5B, 5C | stabilization layer |
| 6B, 6C | conductive layer |
| 7C | functional layer |
| 71C | current carrying particle |
| 8A, 8B, 8D | polarizer |
| 9A, 9B, 9D | phase difference film |
| 10A, 10B, 10D | front panel |
| 11A, 11B, 11D | surface protection member |
| 12A, 12B, 12D | in-cell touch panel-mounted liquid crystal display |
| | component |
| 13D | pressure-sensitive adhesion layer |
| 14D | rear surface film |
| 100A, 100B, 100D | in-cell touch panel-mounted image display device |

1. An optical laminate comprising a cellulose-based substrate film, a stabilization layer and a conductive layer in this order,
wherein an average value of a surface resistivity measured according to JIS K6911 on the conductive layer is in the range of 1.0×10⁷Ω/ [symbol] or more and 1.0×10¹²Ω/ [symbol] or less; and
a value obtained by dividing a standard deviation σ of the surface resistivity by the average value is 0.20 or less.

2. The optical laminate according to claim 1, wherein a thickness of the stabilization layer is 50 nm or more and less than 10 μm.

3. The optical laminate according to claim 1, wherein the stabilization layer is a cured product of an ionizing radiation curable resin composition.

4. The optical laminate according to claim 3, wherein the ionizing radiation curable resin composition for the stabilization layer comprises a polyfunctional (meth)acrylate monomer having a molecular weight of less than 1,000.

5. The optical laminate according to claim 1, wherein the conductive layer is a cured product of an ionizing radiation curable resin composition comprising an ionizing radiation curable resin and conductive particles, and
a content of the conductive particles is 25 to 200 parts by mass relative to 100 parts by mass of the ionizing radiation curable resin.

6. The optical laminate according to claim 5, wherein the stabilization layer is a cured product of an ionizing radiation curable resin composition, and the ionizing radiation curable resin of the ionizing radiation curable resin composition for the conductive layer is a same type of ionizing radiation curable resin as that of the ionizing radiation curable resin composition for the stabilization layer.

7. A front panel comprising the optical laminate according to claim 1, a polarizer, and a phase difference film in this order, with the substrate film being provided at a side of the polarizer.

8. An image display device comprising the optical laminate according to claim 1 on a side of a display component facing a viewer, with the surface protection film being closer to the viewer than the substrate.

9. The image display device according to claim 8, wherein the display component is an in-cell touch panel-mounted liquid crystal display component.
